(19) United States
(12) Patent Application Publication
(10) Pub. No.: US 2006/0014805 A1
(43) Pub. Date: Jan. 19, 2006

(54) Pesticidal fluoroalkene derivatives

(76) Inventors: Markus Kordes, Frankenthal (DE); Wolfgang Von Deyn, Neustadt (DE); Thomas Schmidt, Neustadt (DE); Gerd Steiner, Kirchheim (DE); David G Kuhn, newtown, PA (US); Yulin Hu, Plainsboro, NJ (US); Henry Van Tuyl Cotter, Raleigh, NC (US); Deborah L Culbertson, Fuquay- Varina, NC (US); David G Kuhn, Newtown, PA (US); Yulin Hu, Plainsboro, NJ (US); Henry Van Tuyl Cotter, Raleigh, NC (US); Deborah L Culbertson, Fuguay, NC (US)

Correspondence Address: HUTCHISON & MASON PLLC, PO BOX 31686, RALEIGH, NC, 27612, US

(21) Appl. No.: 10/523,325

(22) PCT Filed: Jul. 30, 2003
(86) PCT No.: PCT/EP03/08397

§ 371 Date: Jan. 28, 2005

Related U.S. Application Data
(60) Provisional application No. 60/399,732, filed on Aug. 1, 2002.

(51) Int. Cl. A01N 43/40; A01N 43/78; A01N 43/76; A01N 43/64; A01N 43/50

(52) U.S. Cl. 514/357; 514/365; 514/374; 514/396; 514/383

(57) ABSTRACT

Pesticidal fluoroalkene derivatives (I) wherein A is oxygen, NR^{a}; R^{a} is hydrogen; optionally halogenated alkyl, alkenyl, alkynyl; X is hydrogen, halogen; optionally halogenated alkyl or phenyl; R¹,R² are hydrogen, halogen, hydroxyl, cyano, nitro, mercapto, amino; alkyl, alkenyl, alkynyl, alkoxy, alkenyloxy, alkylthio, alkylamino, dialkylamino, alkoxycarbonyl, alkylcarbonyloxy, optionally halogenated or substituted by 1 to 3 R^{b} groups: R^{b} is cyano, nitro, halogen, hydroxy, mercapto, amino, carboxyl, aminocarbonyl, aminothiocarbonyl; optionally halogenated alkyl, haloalkyl, alkenyl, alkenyloxy, alkynyl, alkoxy, haloalkoxy, alkylthio, alkylamino, dialkylamino, formyl, alkylcarbonyl, alkylsulfonyl, alkoxysulfonyl, alkylsulfonyloxy, alkoxycarbonyl, alkylcarbonyloxy, alkylaminocarbonyl, dialkylaminocarbonyl, alkylaminothiocarbonyl, dialkylaminothiocarbonyl, alkylenedioxy or cycloalkyl; Het is a monocyclic or bicyclic 3- to 10-membered heteroaromatic ring system containing 1 to 5 heteroatoms selected from oxygen, sulfur and nitrogen, optionally halogenated or substituted by 1 to 4 R^{c} groups: R^{c} is R^{b}, alkoxyalkyl, alkylsulfinyl, alkylaminosulfonyl, di-alkylaminosulfonyl, alkylcarbonylamino, optionally substituted by halogen or 1 to 3 cyano, hydroxy, mercapto, amino, C1-C6-alkylthio, C1-C6-alkylamino, di-C1-C6-alkylamino, C1-C6-alkoxycarbonyl, C1-C6-alkylcarbonyloxy or nitro groups; cycloalkyl, cycloalkoxy, saturated or partially unsaturated heterocyclyl, heterocyclyloxy, aryl, aryloxy, arylthio, arylalkoxy, arylalkyl, hetaryl, hetaryloxy, hetarylthio, optionally substituted; m is 0-2; n is 0-3; p is 0-6, methods for the preparation of compounds I, compositions and methods comprising the compounds and compositions for the control of nematodes, insects, arachnids, harmful fungi and unwanted plants, and for treating, controlling, preventing and protecting warm-blodded animals, fish and humans against infestation and infection by helminths, arachnids and arthropod endo- and ectoparasites.

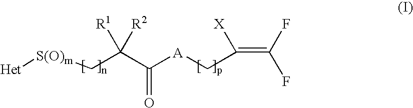

The present invention relates to pesticidal fluoroalkene derivatives of formula I 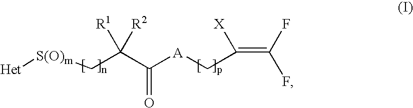
wherein the substituents and the indices have the following meanings:
A oxygen or NR^{a};
   R^{a} hydrogen; C₁-C₆-alkyl, C₂-C₆-alkenyl, C₂-C₆-alkynyl, wherein the carbon atoms may be partially or fully halogenated;
X hydrogen, halogen; C₁-C₆-alkyl or phenyl wherein the alkyl and phenyl groups may be partially or fully halogenated;
R¹,R² each independently hydrogen, halogen, hydroxyl, cyano, nitro, mercapto, amino; C₁-C₆-alkyl, C₂-C₆-alkenyl, C₂-C₆-alkynyl, C₁-C₆-alkoxy, C₂-C₆-alkenyloxy, C₁-C₆-alkylthio, C₁-C₆-alkylamino, di-C₁-C₆-alkylamino, C₁-C₆-alkoxycarbonyl, C₁-C₆-alkylcarbonyloxy, wherein the aliphatic moieties in these 10 substituents are unsubstituted, partially or fully halogenated or substituted by 1 to 3 substituents, each independently selected from R^{b}:
   R^{b} cyano, nitro, halogen, hydroxy, mercapto, amino, carboxyl, aminocarbonyl, aminothiocarbonyl, alkyl, haloalkyl, alkenyl, alkenyloxy, alkynyl, alkoxy, haloalkoxy, alkylthio, alkylamino, dialkylamino, formyl, alkylcarbonyl, alkylsulfonyl, alkoxysulfonyl, alkylsulfonyloxy, alkoxycarbonyl, alkylcarbonyloxy, alkylaminocarbonyl, dialkylaminocarbonyl, alkylaminothiocarbonyl, dialkylaminothiocarbonyl, alkylenedioxy or cycloalkyl, wherein the alkyl groups in these radicals contain 1 to 6 carbon atoms and the abovementioned alkenyl or alkynyl groups in these radicals contain 2 to 6 carbon atoms, and wherein the carbon atoms in these groups may be partially or fully halogenated;
Het a monocyclic or bicyclic 3- to 10-membered heteroaromatic ring system containing 1 to 5 heteroatoms selected from oxygen, sulfur and nitrogen, unsubstituted, partially or fully halogenated or substituted by 1 to 4 substituents, each independently selected from R^{c}.
   R^{c} R^{b}, C₁-C₆-alkoxy-C₁-C₆-alkyl, C₆-alkylsulfinyl, C₁-C₆-alkylaminosulfonyl, di-C₁-C₆-alkylaminosulfonyl, C₁-C₆-alkylcarbonylamino, wherein the last mentioned 5 carbon chains and those defined under R^{b} are unsubstituted, partially or fully halogenated or substituted by from 1 to 3 cyano, hydroxy, mercapto, amino, C₁-C₆-alkylthio, C₁-C₆-alkylamino, di-C₁-C₆-alkylamino, C₁-C₆-alkoxycarbonyl, C₁-C₆-alkylcarbonyloxy or nitro groups;
   cycloalkyl, cycloalkoxy, saturated or partially unsaturated heterocyclyl, heterocyclyloxy, wherein the cyclic systems contain 3 to 10 ring members, and the carbon atoms in the heterocycles may be substituted by 1 to 4 heteroatoms selected from nitrogen, sulfur and oxygen,
   aryl, aryloxy, arylthio, aryl-C₁-C₆-alkoxy, aryl-C₁-C₆-alkyl, wherein the mono- or bicyclic ring systems contain 5 to 10 ring members,
   hetaryl, hetaryloxy, hetarylthio, wherein the mono- or bicyclic ring systems contain 5 to 10 ring members wherein 1 to 3 carbon atoms may be substituted by heteroatoms selected from nitrogen, sulfur and oxygen,
   and wherein the cyclic, aromatic and heteroaromatic systems may be partially or fully halogenated or may be substituted by from 1 to 3 groups selected from halogen, cyano, nitro, hydroxy; C₁-C₆-alkyl, C₁-C₆-alkoxy, C₁-C₆-alkylthio, C₁-C₆-alkylamino, C₁-C₆-alkylcarbonyl, C₁-C₆-alkoxycarbonyl, di-C₁-C₆-alkylamino, C₂-C₆-alkenyl, C₂-C₆-alkenyloxy and C₂-C₆-alkynyl, wherein the carbon atoms of these substituents may be partially or fully halogenated;
m 0, 1 or 2;
n 0, 1, 2, or 3;
p 0, 1, 2, 3, 4, 5, or 6.

Furthermore, the present invention relates to processes for the preparation of compounds of formula I, compositions containing them and their use for the control of pests such as nematodes, insects, arachnids, harmful fungi and unwanted plants, and the protection of plants from those pests as well as their use for treating, controlling, preventing and protecting warm-blooded animals, fish and humans against infestation and infection by helminths, arachnids and arthropod endo- and ectoparasites.

In WO-A 86/07590, nematicidal halosubstituted alkene derivatives are disclosed, some of which are substituted by a carbonyloxy group substituted by dihydrothiazolylthiomethylene.

The compounds of formula I differ from the compounds known from WO-A 86/07590 in that they are substituted by aromatic heterocyclic substituents.

In WO 97/08130, pesticidal 4,4-difluoro-3-butenylester derivatives and 4,4-difluoro-3-halogen-3-butenylester derivatives are described some of which carry a hetarylthioalkyl substituent on the carbonyl group.

Contrary to the compounds disclosed in WO-A 97/08130, in compounds of formula I a hetaryl moiety is bonded to the carbonylalkyl backbone via a sulfur atom.

Furthermore, EP-A 1000946 teachers 2-(substituted thio)thiazolo-[4,5-b]pyridine compounds which may bear a haloalkenyl-oxycarbonyl-alkylthio radical as the substituting thio group.

However, the pesticidal activity of the compounds known from the above literature in many cases is unsatisfactory.

It is an object of the present invention to provide compounds having improved nematicidal, insecticidal and acaricidal activity. It is also an object to provide compounds for controlling harmful fungi, unwanted plants and parasites.

We have found that this object is achieved by the fluoroalkene derivatives of formula I. Furthermore, we have found processes for preparing the compounds of formula I and the use of the compounds I and compositions comprising them for use for the control of nematodes, insects, arachnids, harmful fungi and unwanted plants and the protection of plants from those pests as well as for treating, controlling, preventing and protecting warm-blooded animals, fish and humans against infestaion and infection by helminths, acarids and arthropod endo- and ectoparasites.

Fluoroalkene derivatives of formula I.1, 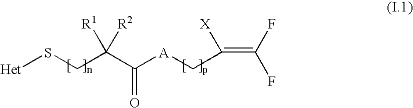
wherein A, X, R¹, R², Het, n and p are as defined for formula I above, are obtainable by, in a first step, reaction of compounds of formula II
Het-SH (II)
wherein Het is as defined for formula I, with compounds of formula III 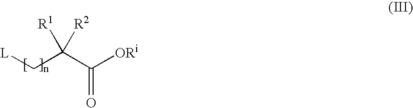
wherein R¹, R² and n are as defined for formula I and L is a nucleophilic exchangeable leaving group, preferably halogen such as bromine, and Rⁱ is hydrogen, C₁-C₆-alkyl or aryl-C₁-C₆-alkyl, such as benzyl, in the presence of a base to give sulfide compounds of formula IV.

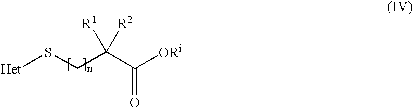

The reaction to sulfides IV is usually carried out at temperatures of from 0° C. to 150° C., preferably from 15° C. to 80° C., in an inert organic solvent in the presence of a base.

Suitable solvents are halogenated hydrocarbons, such as methylene chloride and chlorobenzene, ethers, such as dimethylether, digylme, dioxane and tetrahydrofuran, nitriles, such as acetonitrile, ketones, such as acetone, and also dimethyl sulfoxide, dimethyl formamide and dimethyl acetamide. Preferred solvents are acetone and dimethyl formamide. It is also possible to use mixtures of the solvents mentioned.

Suitable bases are, inorganic compounds, such as alkali metal and alkaline earth metal carbonates, such as lithium carbonate, potassium carbonate and calcium carbonate, alkali metal bicarbonates, such as sodium bicarbonate, and also organic bases, such as tertiary amines, such as trimethyl amine, triethyl amine, tri-isopropyl ethyl amine und N-methyl-piperidine, and pyridine. Particular preference is given to alkaline earth metal carbonates, especially potassium carbonate.

In general, the base is employed in equimolar amounts or in excess.

The starting materials are generally reacted with one another in equimolar amounts. In terms of yield, it may be advantageous to use an excess of compounds of formula III based on compounds Het-SH.

Heterocyclic thiols of formula II are known, or are commercially 10 available, or they can be prepared by known methods [see e.g. Synthesis 3, 358-360 (2001)].

Compounds of formula IV are known from the literature or are commercially available [see e.g. J. Org. Chem. 62, 9173-9176 (1997)].

Compounds of formula IV wherein Rⁱ is C₁-C₆-alkyl or aryl-C₁-C₆-alkyl are hydrolized to compounds IV wherein Rⁱ is H, for example in the presence of an aqueous acid or base, and reacted with fluoroalkenyl compounds of formula V, 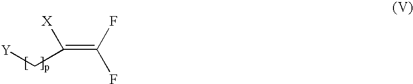
wherein X and p are as defined for formula I and Y is (a) a nucleophilically exchangeable group, such as halogen or hydroxy, to yield compounds I wherein A is oxygen, or (b) an amino group NHR^{a}, wherein R^{a} is as defined for formula I, preferably hydrogen, to yield compounds I wherein A is NR^{a}.

The reaction is carried out by common coupling methods such as in the presence of a base, optionally under activating conditions, such as by converting carboxylic acids of formula V into their corresponding carboxylic acid halides or by means of dehydrating agents such as carbodiimides, to give compounds of formula Ia [lit.: J. March, Advanced Organic Chemistry: reactions, mechanisms and structure, 4th ed. 1992, Wiley & Sons, New York].

The reaction is usually carried out at temperatures of from 0° C. to 150° C., preferably from 20° C. to 60° C., in an inert organic solvent in the presence of a base.

Suitable solvents are nitriles, such as acetonitrile and propionitrile, and also dimethyl sulfoxide, dimethyl formamide and dimethyl acetamide. Preferred solvents are dimethylether and acetonitrile. It is also possible to use mixtures of the solvents mentioned.

The starting materials are generally reacted with one another in equimolar amounts. In terms of yield, it may be advantageous to use an excess of compounds V, based on acids IV.

Compounds of formula V are known from the literature or are commercially available [see e.g. WO 86/07590 and WO 95/24403].

Sulfinyl and sulfonyl compounds of formula I wherein m is 1 or 2 may be prepared by oxidizing compounds of formula Ia. The oxidation is usually carried out at temperatures of from −10° C. to 150° C., preferably from 0° C. to 60° C., in an inert organic solvent or water. Suitable oxidizing agents are, for example m-chloroperbenzoic acid, peracetic acid, H₂O₂×BF₃, K₂S₂O₇/H₂SO₄, peroxytrifluoroacetic acid, or hydrogen peroxide, optionally in combination with catalytic amounts of sodium tungsten dihydrate.

Suitable solvents are halogenated hydrocarbons, such as methylene chloride and chloroform alcohols, such as methanol and tert.-butanol, carboxylic acids such as acetic acid and trifluoroacetic acid, and also dimethyl sulfoxide, dimethyl formamide and dimethyl acetamide. Preferred solvents are methylene chloride and acetic acid. It is also possible to use mixtures of the solvents mentioned.

The reaction mixtures are worked up in a customary manner, for example by mixing with water, phase separation and, if appropriate, chromatographic purification of the crude products. In some cases, the intermediates and end products are obtained in the form of colorless or pale brown viscous oils, which are purified or freed from volatile components under reduced pressure and at moderately elevated temperature. If the intermediates and end products are obtained as solids, they can also be purified by recrystallization or digestion.

If individual compounds I are not obtainable by the routes described above, they can be prepared by derivatization of other compounds I.

In the definitions of the symbols given in the above formulae, collective terms were used which generally represent the following substituents:

Halogen: fluorine, chlorine, bromine and iodine;

Alkyl: saturated, straight-chain or branched hydrocarbon radicals having 1 to 4 or 6 carbon atoms, such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl;

Haloalkyl: straight-chain or branched alkyl groups having 1 to 4 or 6 carbon atoms (as mentioned above), where some or all of the hydrogen atoms in these groups may be replaced by halogen atoms as mentioned above, for example C₁-C₂-haloalkyl, such as chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl and pentafluoroethyl;

Alkenyl: unsaturated, straight-chain or branched hydrocarbon radicals having 2 to 6 carbon atoms and a double bond in any position, such as ethenyl, 1-propenyl, 2-propenyl, 1-methyl-ethenyl, 1-butenyl, 2-butenyl, 3-butenyl, 1-methyl-1-propenyl, 2-methyl-1-propenyl, 1-methyl-2-propenyl, 2-methyl-2-propenyl; 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl;

Haloalkenyl: unsaturated, straight-chain or branched hydrocarbon radicals having 2 to 6 carbon atoms and a double bond in any position (as mentioned above), where some or all of the hydrogen atoms in these groups may be replaced by halogen atoms as mentioned above, in particular by fluorine, chlorine and bromine;

Alkynyl: straight-chain or branched hydrocarbon groups having 2 to 6 carbon atoms and a triple bond in any position, such as ethynyl, 1-propynyl, 2-propynyl, 1-butynyl, 2-butynyl, 3-butynyl, 1-methyl-2-propynyl, 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl and 1-ethyl-1-methyl-2-propynyl;

Haloalkynyl: straight-chain or branched hydrocarbon groups having 2 to 6 carbon atoms and a triple bond in any position (as mentioned above), where some or all of the hydrogen atoms in these groups may be replaced by halogen atoms as mentioned above, in particular by fluorine, chlorine and bromine;

Alkoxycarbonyl: straight-chain or branched alkoxy groups having 1 to 6 carbon atoms (as mentioned above) which are attached to the skeleton via a carbonyl group (—CO—); Alkylaminocarbonyl: straight-chain or branched alkylamino groups having 1 to 6 carbon atoms (as mentioned above) which are attached to the skeleton via a carbonyl group (—CO—);

Alkylcarbonyloxy: straight-chain or branched alkyl groups having 1 to 6 carbon atoms (as mentioned above) which are attached to the skeleton via a carbonyloxy group (—C(═O)O—);

Cycloalkyl: monocyclic or bicyclic saturated hydrocarbon groups having 3 to 6, 8 or 10 carbon ring atoms, e.g. C₃-C₈-cycloalkyl such as cyclopropyl, cyclobutyl, cyclopentyl, cyclohexyl, cycloheptyl, cyclooctyl and dihydronaphthalin;

Heterocyclyl: 5- to 10-membered saturated or partially unsaturated rings which besides carbon ring atoms contain from 1 to 3 or 4 heteroatoms selected from nitrogen, oxygen and sulfur, e.g. from 1 to 3 nitrogen atoms and/or 1 oxygen or sulfur atom and/or 1 or 2 oxygen and/or sulfur atoms;

Aryl: mono- or bicyclic aromatic ringsystems containing 5 to 10 carbon ring atoms, e.g. phenyl or naphthyl;

Arylmethylene: mono- or bicyclic aromatic ringsystems containing 5 to 14 carbon ring atoms (as mentioned above) which are attached to the skeleton via a methylene (—CH₂—) group.

Hetaryl: a monocyclic or bicyclic 3- to 10-membered heteroaromatic ring system containing 1 to 5 heteroatoms selected from oxygen, sulfur and nitrogen,

e.g. 5-membered hetaryl containing beside carbon atoms 1 to 3 nitrogen atoms and/or 1 sulfur- or oxygen atom, wherein the ring system may be bonded to the backbone via carbon or nitrogen, such as furyl, thienyl, pyrrolyl, isoxazolyl, isothiazolyl, pyrazolyl, oxazolyl, thiazolyl, imidazolyl, 1,2,4-oxadiazolyl, 1,2,4-thiadiazolyl, 1,2,4-triazolyl, 1,3,4-oxadiazolyl, 1,3,4-thiadiazolyl and 1,3,4-triazolyl; or e.g. 5-membered hetaryl containing beside carbon atoms 1 to 3 nitrogen atoms and/or 1 sulfur- or oxygen atom, wherein the ring system may be bonded to the backbone via carbon or nitrogen, wherein 2 adjacent ring members are bridged by a buta-1,3-dien-1,4-diyl group, wherein 1 or 2 carbon atoms may be substituted by nitrogen atoms, such as benzofuranyl, isobenzofuranyl, benzothienyl, isobenzothienyl, indolyl, isoindolyl, indazolyl, indoleninyl, isobenzazolyl, pyranopyrrolyl, isoindazolyl, indoxazinyl, benzoxazolyl, benzothiazolyl, benzimidazolyl, pyridoxazolyl, pyridothiazolyl, pyrazinoxazolyl, pyrazinthiazolyl, pyridazinoxazolyl, pyridazinthiazolyl, pyrimidinoxazolyl, pyrimidinthiazolyl, pyrimidinazolyl, benzopyranyl, purinyl;

Alkylsulfinyl: straight-chain or branched alkyl groups having 1 to 6 carbon atoms (as mentioned above) which are attached to the skeleton via a sulfinyl group (—SO—);

Alkylsulfonyl: straight-chain or branched alkyl groups having 1 to 6 carbon atoms (as mentioned above) which are attached to the skeleton via a sulfonyl group (—SO₂—);

Alkylsulfonyloxy: straight-chain or branched alkylsulfonyl groups having 1 to 6 carbon atoms (as mentioned above) which are attached to the skeleton via an oxygen atom;

Alkoxysulfonyl: straight-chain or branched alkoxy groups having 1 to 6 carbon atoms (as mentioned above) which are attached to the skeleton via a sulfonyl group (—SO₂—);

Alkylaminosulfonyl: straight-chain or branched alkylamino groups having 1 to 6 carbon atoms (as mentioned above) which are attached to the skeleton via a sulfonyl group (—SO₂—);

With respect to the intended use of the fluoroalkene derivatives of formula I, particular preference is given to the following meanings of the substituents, in each case on their own or in combination:

Preference is given to compounds of formula I wherein A is oxygen or NH.

Particular preference is given to compounds of formula I wherein A is oxygen.

Preference is given to compounds of the formula I in which R^{a} is hydrogen or C₁-C₆-alkyl, hydrogen being preferred most.

Furthermore, preference is given to compounds of formula I wherein X is hydrogen, halogen, C₁-C₄-alkyl, C₁-C₄-haloalkyl, or phenyl.

Particular preference is given to compounds of formula I wherein X is hydrogen or halogen, especially fluorine.

Especially preferred are compounds of formula I wherein X is fluorine.

Preference is given to compounds of formula I wherein R¹ and R² are each independently hydrogen, halogen, C₁-C₆-alkyl, or phenyl wherein the alkyl and phenyl group are unsubstituted, partially or fully halogenated.

Particular preference is given to compounds of formula I wherein R¹ and R² are each independently hydrogen, halogen, C₁-C₄-alkyl, or phenyl.

Especially preferred are compounds of formula I wherein R¹ and R² are each independently hydrogen or C₁-C₄-alkyl.

Particular preference is given to compounds of formula I wherein one of R¹ and R² is not hydrogen.

Particular preference is given to compounds of the formula I wherein R^{b} is halogen, hydroxy, C₁-C₆-alkyl, C₁-C₆-haloalkyl, C₁-C₆-alkoxy or C₁-C₆-haloalkoxy.

Especially preferred are compounds of the formula I wherein R¹ and R² are substituted by hydrogen or C₁-C₆-alkyl, hydrogen being preferred most.

Preference is given to compounds of the formula I wherein Het is bonded via carbon.

Particular preference is given to compounds of the formula I wherein Het is oxazolyl, thiazolyl, imidazolyl, pyrimidinyl, pyridyl, purinyl, pyridazinonyl, benzoxazolyl, pyridoxazolyl, benzothiazolyl, pyridothiazolyl, benzimidazolyl, pyrimidinazolyl, 1,3,4-oxadiazol-2-yl, or 1,3,4-thiadiazol-2-yl, each ring system being unsubstituted, partially or fully halogenated or substituted by from 1 to 3 or 4 groups selected from R^{c} as defined for formula I above.

Particular preference is given to compounds of the formula I wherein Het is 2-oxazolyl, 2-thiazolyl, 2-imidazolyl, 2-pyrimidinyl, 2-pyridyl, 2-purinyl, 5-pyridazinonyl, 2-benzoxazolyl, 2-pyridoxazolyl, 2-benzothiazolyl, 2-benzimidazolyl, 2-pyrimidinazolyl, 1,3,4-oxadiazol-2-yl, or 1,3,4-thiadiazol-2-yl, each ring system being unsubstituted, partially or fully halogenated or substituted by from 1 to 3 or 4 groups selected from R^{c} as defined for formula I above.

Especially preferred are compounds of formula I wherein Het is 2-oxazolyl, 2-thiazolyl, 2-benzoxazolyl, 2-pyridoxazolyl, 2-benzothiazolyl, 1,3,4-oxadiazol-2-yl, or 1,3,4-thiadiazol-2-yl, each ring system being unsubstituted, partially or fully halogenated or substituted by from 1 to 2 or 3 groups selected from R^{c} as defined for formula I above.

Preference is given to compounds of the formula I wherein R^{c} is cyano, nitro, halogen, hydroxy, mercapto, amino, carboxyl, aminocarbonyl, alkyl, haloalkyl, alkoxyalky, alkenyl, alkenyloxy, alkynyl, alkoxy, haloalkoxy, alkylthio, alkylamino, dialkylamino, formyl, alkylcarbonyl, alkylsulfonyl, alkoxycarbonyl, alkylcarbonyloxy, alkylaminocarbonyl, or dialkylaminocarbonyl, wherein the alkyl groups in these radicals contain 1 to 6 carbon atoms and the abovementioned alkenyl or alkynyl groups in these radicals contain 2 to 6 carbon atoms, and wherein the carbon atoms in these groups may be partially or fully halogenated, or 5- to 10-membered mono- or bicyclic aryl, or 5- to 10-membered mono-or bicyclic hetaryl, wherein 1 to 3 carbon atoms may be substituted by heteroatoms selected from nitrogen, sulfur and oxygen, wherein the aryl or hetaryl ring systems may be partially or fully halogenated or may be substituted by from 1 to 3 groups selected from halogen, cyano, nitro, hydroxy, C₁-C₆-alkyl, C₁-C₆-haloalkyl, C₁-C₆-alkoxy, or C₁-C₆-haloalkoxy.

Particular preference is given to compounds of the formula I wherein R^{c} is hydroxy, halogen, C₁-C₆-alkyl, C₁-C₆-haloalkyl, C₁-C₆-alkoxy, C₁-C₆-haloalkoxy and phenyl, unsubstituted, partially or fully halogenated or substituted by from 1 to 3 nitro, hydroxy, cyano, C₁-C₆-alkyl, C₁-C₆-haloalkyl, C₁-C₆-alkoxy, C₁-C₆-haloalkoxy, C₁-C₆-alkylamino, or di-C₁-C₆-alkylamino.

Particular preference is given to compounds of the formula I in which m is 0 or 2.

Particular preference is given to compounds of the formula I in which m is zero.

Preference is given to compounds of the formula I in which n is 0 or 1.

Particular preference is given to compounds of the formula I in which n is zero.

Preference is given to compounds of the formula I in which p is 2 or 4.

Preference is given to compounds of the formula I in which p is 2.

Moreover, fluoroalkene derivatives of formula I are preferred wherein the substituents and the indices have the following meanings:
A oxygen or NH;
X hydrogen or halogen;
R¹,R² each independently hydrogen, C₁-C₆-alkyl, or phenyl which is unsubstituted or substituted by one to three halogen atoms;
Het oxazolyl, thiazolyl, imidazolyl, pyrimidinyl, pyridyl, purinyl, pyridazinonyl, benzoxazolyl, pyridoxazolyl, benzothiazolyl, pyridothiazolyl, benzimidazolyl, pyrimidazolyl, oxadiazolyl, or thiadiazolyl, each ring being unsubstituted, partially or fully halogenated or substituted by from one to three groups selected from R^{c}.
   R^{c} is hydroxy, halogen, C₁-C₆-alkyl, C₁-C₆-haloalkyl, C₁-C₆-alkoxy, C₁-C₆-haloalkoxy and phenyl, unsubstituted, partially or fully halogenated or substituted by from 1 to 3 nitro, hydroxy, cyano, C₁-C₆-alkyl, C₁-C₆-haloalkyl, C₁-C₆-alkoxy, C₁-C₆-haloalkoxy, C₁-C₆-alkylamino, or di-C₁-C₆-alkylamino.
m,n 0, 1 or 2;
p 2 or 4;

Likewise, particular preference is given to compounds of the formula I wherein substituents and the indices have the following meanings:
A oxygen;
X hydrogen or fluorine;
R¹, R² each independently hydrogen, C₁-C₄-alkyl; Het 2-oxazolyl, 2-thiazolyl, 2-benzoxazolyl, 2-pyridoxazolyl, 2-benzothiazolyl, 2-pyridothiazolyl, 1,3,4-oxadiazol-2-yl, or 1,3,4-thiadiazol-2-yl, each ring being unsubstituted, partially or fully halogenated or substituted by from one to three groups selected from hydroxy, C₁-C₆-alkyl, C₁-C₆-haloalkyl, C₁-C₆-alkoxy, C₁-C₆-haloalkoxy, or phenyl, unsubstituted, partially or fully halogenated or substituted by from 1 to 3 nitro, cyano, C₁-C₆-alkyl, C₁-C₆-haloalkyl, C₁-C₆-alkoxy or C₁-C₆-haloalkoxy groups.
m,n zero;
p 2 or 4.

Particular preference is given to compounds of formula I wherein A is oxygen, X is hydrogen or fluorine, R¹ and R² are each independently hydrogen, C₁-C₄-alkyl, or phenyl, Het is 2-benzoxazolyl, 2-benzothiazolyl, 4-pyridothiazol-2-yl, 4-pyridoxazol-2-yl, 5-pyridothiazol-2-yl, 5-pyridoxazol-2-yl, 6-pyridothiazol-2yl, 6-pyridoxazol-2-yl, 7-pyridothiazol-2-yl, 7-pyridoxazol-2-yl, 2-pyrazinthiazolyl, 2-pyrazinoxazolyl, each ring being unsubstituted or substituted by 1 group selected from halogen, C₁-C₄-alkyl, C₁-C₄-haloalkyl, C₁-C₄-haloalkoxy, C₁-C₄-alkoxy, nitro, amino, and methylcarbonylamino, m is zero, n is 1, and p is 2 or 4.

Particular preference is given to compounds of formula I wherein A is oxygen, X is hydrogen or fluorine, R¹ and R² are each independently hydrogen, C₁-C₄-alkyl, or phenyl, Het is 2-oxazolyl, 2-thiazolyl, 2-imidazolyl, each ring being unsubstituted or substituted by 1 or 2 groups selected from halogen, C₁-C₄-alkyl, C₁-C₄-alkoxymethylene, C₁-C₄-alkylcarbonyloxy, and phenyl which may be substutited by from 1 to 3 substituents selected from halogen, C₁-C₄-alkyl and hydroxy, m is zero, n is 1, and p is 2 or 4.

Particular preference is given to compounds of formula I wherein A is oxygen, X is hydrogen or fluorine, R¹ and R² are each independently hydrogen, C₁-C₄-alkyl, or phenyl, Het is thiadiazolyl or oxadiazolyl, each ring being unsubstituted or substituted by one group selected from halogen, C₁-C₄-alkyl, C₁-C₄-haloalkyl, C₁-C₄-haloalkoxy, C₁-C₄-alkoxy, nitro, amino, and methylcarbonylamino, m and n are integers of 0, and p is an integer of 2 or 4.

Furthermore, compounds of the following formulae are especially preferred:

Compounds of formula I.2 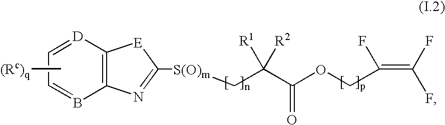
wherein B is nitrogen or CH, in particular CH, D is nitrogen or CH, in particular CH, E is oxygen or sulfur, R¹ and R² are each independently hydrogen, C₁-C₄-alkyl or phenyl, q is 0 or 1, R^{c} is halogen, methyl, methoxy, ethoxy, trifluoromethyl, trifluoromethoxy, m is 0, 1 or 2, n is 0 or 1 and p is 2 or 4, with the proviso that B is CH when E is sulfur.

Compounds of formula I.3 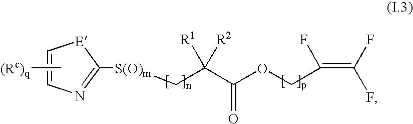
wherein E′ is oxygen, sulfur or NH, R¹ and R² are each independently hydrogen or C₁-C₄-alkyl, q is 0, 1 , or 2, R^{c} is phenyl which may be substituted by one or two halogen, m is 0, 1 or 2, n is 0 or 1, p is 2 or 4.

Compounds of formula I.4 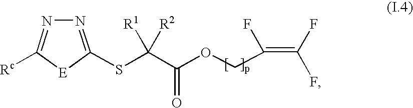
wherein E is oxygen or sulfur, R¹ and R² are each independently hydrogen or C₁-C₄-alkyl, R^{c} is C₁-C₄-alkyl or phenyl which may be substituted by halogen or methyl, and p is 2.

With respect to their use, particular preference is given to the compounds I.5, I.6 and I.7 compiled in the Tables below. Moreover, the groups mentioned for a substituent in the Tables are on their own, independently of the combination in which they are mentioned, a particularly preferred embodiment of the substituent in question.

Further preference is given to the compounds of the tables 1 to 440 wherein A is NH.

Table 1

Compounds of the formula I.5 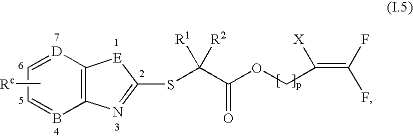
wherein X is hydrogen, p is 2, R¹ and R² are hydrogen and the combination of B, D, E and R^{c} for a compound corresponds in each case to a row of Table A.

Table 2

Compounds of the formula I.5 wherein X is hydrogen, p is 2, R¹ is hydrogen and R² is methyl and the combination of B, D, E and R^{c} for a compound corresponds in each case to a row of Table A.

Table 3

Compounds of the formula I.5 wherein X is hydrogen, p is 2, R¹ is hydrogen and R² is ethyl and the combination of B, D, E and R^{c} for a compound corresponds in each case to a row of Table A.

Table 4

Compounds of the formula I.5 wherein X is hydrogen, p is 2, R¹ is hydrogen and R² is i-propyl and the combination of B, D, E and R^{c} for a compound corresponds in each case to a row of Table A.

Table 5

Compounds of the formula I.5 wherein X is hydrogen, p is 2, R¹ is hydrogen and R² is n-propyl and the combination of B, D, E and R^{c} for a compound corresponds in each case to a row of Table A.

Table 6

Compounds of the formula I.5 wherein X is hydrogen, p is 2, R¹ is hydrogen and R² is cyclo-propyl and the combination of B, D, E and R^{c} for a compound corresponds in each case to a row of Table A.

Table 7

Compounds of the formula I.5 wherein X is hydrogen, p is 2, R¹ is hydrogen and R² is n-butyl and the combination of B, D, E and R^{c} for a compound corresponds in each case to a row of Table A.

Table 8

Compounds of the formula I.5 wherein X is hydrogen, p is 2, R¹ is hydrogen and R² is i-butyl and the combination of B, D, E and R^{c} for a compound corresponds in each case to a row of Table A.

Table 9

Compounds of the formula I.5 wherein X is hydrogen, p is 2, R¹ is hydrogen and R² is tert-butyl and the combination of B, D, E and R^{b} for a compound corresponds in each case to a row of Table A.

Table 10

Compounds of the formula I.5 wherein X is hydrogen, p is 2, R¹ is hydrogen and R² is phenyl and the combination of B, D, E and R^{c} for a compound corresponds in each case to a row of Table A.

Table 11

Compounds of the formula I.5 wherein X is hydrogen, p is 4, R¹ and R² are hydrogen and the combination of B, D, E and R^{c} for a compound corresponds in each case to a row of Table A.

Table 12

Compounds of the formula I.5 wherein X is hydrogen, p is 4, R¹ is hydrogen and R² is methyl and the combination of B, D, E and R^{c} for a compound corresponds in each case to a row of Table A.

Table 13

Compounds of the formula I.5 wherein X is hydrogen, p is 4, R¹ is hydrogen and R² is ethyl and the combination of B, D, E and R^{c} for a compound corresponds in each case to a row of Table A.

Table 14

Compounds of the formula I.5 wherein X is hydrogen, p is 4, R¹ is hydrogen and R² is i-propyl and the combination of B, D, E and R^{c} for a compound corresponds in each case to a row of Table A.

Table 15

Compounds of the formula I.5 wherein X is hydrogen, p is 4, R¹ is hydrogen and R² is n-propyl and the combination of B, D, E and R^{c} for a compound corresponds in each case to a row of Table A.

Table 16

Compounds of the formula I.5 wherein X is hydrogen, p is 4, R¹ is hydrogen and R² is cyclo-propyl and the combination of B, D, E and R^{c} for a compound corresponds in each case to a row of Table A.

Table 17

Compounds of the formula I.5 wherein X is hydrogen, p is 4, R¹ is hydrogen and R² is n-butyl and the combination of B, D, E and R^{c} for a compound corresponds in each case to a row of Table A.

Table 18

Compounds of the formula I.5 wherein X is hydrogen, p is 4, R¹ is hydrogen and R² is i-butyl and the combination of B, D, E and R^{c} for a compound corresponds in each case to a row of Table A.

Table 19

Compounds of the formula I.5 wherein X is hydrogen, p is 4, R¹ is hydrogen and R² is tert-butyl and the combination of B, D, E and R^{c} for a compound corresponds in each case to a row of Table A.

Table 20

Compounds of the formula I.5 wherein X is hydrogen, p is 4, R¹ is hydrogen and R² is phenyl and the combination of B, D, E and R^{c} for a compound corresponds in each case to a row of Table A.

Table 21

Compounds of the formula I.5 wherein X is fluorine, p is 2, R¹ and R² are hydrogen and the combination of B, D, E and R^{c} for a compound corresponds in each case to a row of Table A.

Table 22

Compounds of the formula I.5 wherein X is fluorine, p is 2, R¹ is hydrogen and R² is methyl and the combination of B, D, E and R^{c} for a compound corresponds in each case to a row of Table A.

Table 23

Compounds of the formula I.5 wherein X is fluorine, p is 2, R¹ is hydrogen and R² is ethyl and the combination of B, D, E and R^{c} for a compound corresponds in each case to a row of Table A.

Table 24

Compounds of the formula I.5 wherein X is fluorine, p is 2, R¹ is hydrogen and R² is i-propyl and the combination of B, D, E and R^{c} for a compound corresponds in each case to a row of Table A.

Table 25

Compounds of the formula I.5 wherein X is fluorine, p is 2, R¹ is hydrogen and R² is n-propyl and the combination of B, D, E and R^{c} for a compound corresponds in each case to a row of Table A.

Table 26

Compounds of the formula I.5 wherein X is fluorine, p is 2, R¹ is hydrogen and R² is cyclo-propyl and the combination of B, D, E and R^{c} for a compound corresponds in each case to a row of Table A.

Table 27

Compounds of the formula I.5 wherein X is fluorine, p is 2, R¹ is hydrogen and R² is n-butyl and the combination of B, D, E and R^{c} for a compound corresponds in each case to a row of Table A.

Table 28

Compounds of the formula I.5 wherein X is fluorine, p is 2, R¹ is hydrogen and R² is i-butyl and the combination of B, D, E and R^{c} for a compound corresponds in each case to a row of Table A.

Table 29

Compounds of the formula I.5 wherein X is fluorine, p is 2, R¹ is hydrogen and R² is tert-butyl and the combination of B, D, E and R^{c} for a compound corresponds in each case to a row of Table A.

Table 30

Compounds of the formula I.5 wherein X is fluorine, p is 2, R¹ is hydrogen and R² is phenyl and the combination of B, D, E and R^{c} for a compound corresponds in each case to a row of Table A.

Table 31

Compounds of the formula I.5 wherein X is fluorine, p is 4, R¹ and R² are hydrogen and the combination of B, D, E and R^{c} for a compound corresponds in each case to a row of Table A.

Table 32

Compounds of the formula I.5 wherein X is fluorine, p is 4, R¹ is hydrogen and R² is methyl and the combination of B, D, E and R^{c} for a compound corresponds in each case to a row of Table A.

Table 33

Compounds of the formula I.5 wherein X is fluorine, p is 4, R¹ is hydrogen and R² is ethyl and the combination of B, D, E and R^{c} for a compound corresponds in each case to a row of Table A.

Table 34

Compounds of the formula I.5 wherein X is fluorine, p is 4, R¹ is hydrogen and R² is i-propyl and the combination of B, D, E and R^{c} for a compound corresponds in each case to a row of Table A.

Table 35

Compounds of the formula I.5 wherein X is fluorine, p is 4, R¹ is hydrogen and R² is n-propyl and the combination of B, D, E and R^{c} for a compound corresponds in each case to a row of Table A.

Table 36

Compounds of the formula I.5 wherein X is fluorine, p is 4, R¹ is hydrogen and R² is cyclo-propyl and the combination of B, D, E and R^{c} for a compound corresponds in each case to a row of Table A.

Table 37

Compounds of the formula I.5 wherein X is fluorine, p is 4, R¹ is hydrogen and R² is n-butyl and the combination of B, D, E and R^{c} for a compound corresponds in each case to a row of Table A.

Table 38

Compounds of the formula I.5 wherein X is fluorine, p is 4, R¹ is hydrogen and R² is i-butyl and the combination of B, D, E and R^{c} for a compound corresponds in each case to a row of Table A.

Table 39

Compounds of the formula I.5 wherein X is fluorine, p is 4, R¹ is hydrogen and R² is tert-butyl and the combination of B, D, E and R^{c} for a compound corresponds in each case to a row of Table A.

Table 40

Compounds of the formula I.5 wherein X is fluorine, p is 4, R¹ is hydrogen and R² is phenyl and the combination of B, D, E and R^{c} for a compound corresponds in each case to a row of Table A.

TABLE A

| | |
|---|---|
| | (I.5) |
| 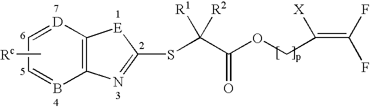 | |

| Nr. | B | D | E | R^{c} |
|---|---|---|---|---|
| A-1 | CH | CH | O | — |
| A-2 | CH | CH | O | 4-CH₃ |
| A-3 | CH | CH | O | 4-CH₂CH₃ |
| A-4 | CH | CH | O | 4-CH₂CH₂CH₃ |
| A-5 | CH | CH | O | 4-CH(CH₃)₂ |
| A-6 | CH | CH | O | 4-CH₂CH₂CH₂CH₃ |
| A-7 | CH | CH | O | 4-CH₂CH(CH₃)₂ |
| A-8 | CH | CH | O | 4-CH(CH₃)₃ |
| A-9 | CH | CH | O | 4-F |
| A-10 | CH | CH | O | 4-Cl |
| A-11 | CH | CH | O | 4-Br |
| A-12 | CH | CH | O | 4-I |
| A-13 | CH | CH | O | 4-CF₃ |
| A-14 | CH | CH | O | 4-OCF₃ |
| A-15 | CH | CH | O | 4-OCH₃ |
| A-16 | CH | CH | O | 4-OCH₂CH₃ |
| A-17 | CH | CH | O | 4-OCH₂CH₂CH₃ |
| A-15 | CH | CH | O | 4-OCH(CH₃)₂ |
| A-19 | CH | CH | O | 4-NO₂ |
| A-20 | CH | CH | O | 4-NH₂ |
| A-21 | CH | CH | O | 4-NH(C}O)CH₃ |
| A-22 | CH | CH | O | 5-CH₃ |
| A-23 | CH | CH | O | 5-CH₂CH₃ |
| A-24 | CH | CH | O | 5-CH₂CH₂CH₃ |
| A-25 | CH | CH | O | 5-CH(CH₃)₂ |
| A-26 | CH | CH | O | 5-CH₂CH₂CH₂CH₃ |
| A-27 | CH | CH | O | 5-CH₂CH(CH₃)₂ |
| A-28 | CH | CH | O | 5-CH(CH₃)₃ |
| A-29 | CH | CH | O | 5-F |
| A-30 | CH | CH | O | 5-Cl |
| A-31 | CH | CH | O | 5-Br |
| A-32 | CH | CH | O | 5-I |
| A-33 | CH | CH | O | 5-CF₃ |
| A-34 | CH | CH | O | 5-OCF₃ |
| A-35 | CH | CH | O | 5-OCH₃ |
| A-36 | CH | CH | O | 5-OCH₂CH₃ |
| A-37 | CH | CH | O | 5-OCH₂CH₂CH₃ |
| A-38 | CH | CH | O | 5-OCH(CH₃)₂ |
| A-39 | CH | CH | O | 5-NO₂ |
| A-40 | CH | CH | O | 5-NH₂ |
| A-41 | CH | CH | O | 5-NH(C}O)CH₃ |
| A-42 | CH | CH | O | 6-CH₃ |
| A-43 | CH | CH | O | 6-CH₂CH₃ |
| A-44 | CH | CH | O | 6-CH₂CH₂CH₃ |
| A-45 | CH | CH | O | 6-CH(CH₃)₂ |
| A-46 | CH | CH | O | 6-CH₂CH₂CH₂CH₃ |
| A-47 | CH | CH | O | 6-CH₂CH(CH₃)₂ |
| A-48 | CH | CH | O | 6-CH(CH₃)₃ |
| A-49 | CH | CH | O | 6-F |
| A-50 | CH | CH | O | 6-Cl |
| A-51 | CH | CH | O | 6-Br |
| A-52 | CH | CH | O | 6-I |
| A-53 | CH | CH | O | 6-CF₃ |
| A-54 | CH | CH | O | 6-OCF₃ |
| A-55 | CH | CH | O | 6-OCH₃ |
| A-56 | CH | CH | O | 6-OCH₂CH₃ |
| A-57 | CH | CH | O | 6-OCH₂CH₂CH₃ |
| A-58 | CH | CH | O | 6-OCH(CH₃)₂ |
| A-59 | CH | CH | O | 6-NO₂ |
| A-60 | CH | CH | O | 6-NH₂ |
| A-61 | CH | CH | O | 6-NH(C}O)CH₃ |
| A-62 | CH | CH | O | 7-CH₃ |
| A-63 | CH | CH | O | 7-CH₂CH₃ |
| A-64 | CH | CH | O | 7-CH₂CH₂CH₃ |
| A-65 | CH | CH | O | 7-CH(CH₃)₂ |
| A-66 | CH | CH | O | 7-CH₂CH₂CH₂CH₃ |
| A-67 | CH | CH | O | 7-CH₂CH(CH₃)₂ |
| A-68 | CH | CH | O | 7-CH(CH₃)₃ |
| A-69 | CH | CH | O | 7-F |
| A-70 | CH | CH | O | 7-Cl |
| A-71 | CH | CH | O | 7-Br |
| A-72 | CH | CH | O | 7-I |
| A-73 | CH | CH | O | 7-CF₃ |
| A-74 | CH | CH | O | 7-OCF₃ |
| A-75 | CH | CH | O | 7-OCH₃ |
| A-76 | CH | CH | O | 7-OCH₂CH₃ |
| A-77 | CH | CH | O | 7-OCH₂CH₂CH₃ |
| A-78 | CH | CH | O | 7-OCH(CH₃)₂ |
| A-79 | CH | CH | O | 7-NO₂ |
| A-80 | CH | CH | O | 7-NH₂ |
| A-81 | CH | CH | O | 7-NH(C}O)CH₃ |
| A-82 | CH | CH | S | — |
| A-83 | CH | CH | S | 4-CH₃ |
| A-84 | CH | CH | S | 4-CH₂CH₃ |
| A-85 | CH | CH | S | 4-CH₂CH₂CH₃ |
| A-86 | CH | CH | S | 4-CH(CH₃)₂ |
| A-87 | CH | CH | S | 4-CH₂CH₂CH₂CH₃ |
| A-88 | CH | CH | S | 4-CH₂CH(CH₃)₂ |
| A-89 | CH | CH | S | 4-CH(CH₃)₃ |
| A-90 | CH | CH | S | 4-F |
| A-91 | CH | CH | S | 4-Cl |
| A-92 | CH | CH | S | 4-Br |
| A-93 | CH | CH | S | 4-I |
| A-94 | CH | CH | S | 4-CF₃ |
| A-95 | CH | CH | S | 4-OCF₃ |
| A-96 | CH | CH | S | 4-OCH₃ |
| A-97 | CH | CH | S | 4-OCH₂CH₃ |
| A-98 | CH | CH | S | 4-OCH₂CH₂CH₃ |
| A-99 | CH | CH | S | 4-OCH(CH₃)₂ |
| A-100 | CH | CH | S | 4-NO₂ |
| A-101 | CH | CH | S | 4-NH₂ |
| A-102 | CH | CH | S | 4-NH(C}O)CH₃ |
| A-103 | CH | CH | S | 5-CH₃ |
| A-104 | CH | CH | S | 5-CH₂CH₃ |
| A-105 | CH | CH | S | 5-CH₂CH₂CH₃ |
| A-106 | CH | CH | S | 5-CH(CH₃)₂ |
| A-107 | CH | CH | S | 5-CH₂CH₂CH₂CH₃ |
| A-108 | CH | CH | S | 5-CH₂CH(CH₃)₂ |
| A-109 | CH | CH | S | 5-CH(CH₃₎₃ |
| A-110 | CH | CH | S | 5-F |
| A-111 | CH | CH | S | 5-Cl |
| A-112 | CH | CH | S | 5-Br |
| A-113 | CH | CH | S | 5-I |
| A-114 | CH | CH | S | 5-CF₃ |
| A-115 | CH | CH | S | 5-OCF₃ |
| A-116 | CH | CH | S | 5-OCH₃ |
| A-117 | CH | CH | S | 5-OCH₂CH₃ |
| A-118 | CH | CH | S | 5-OCH₂CH₂CH₃ |
| A-119 | CH | CH | S | 5-OCH(CH₃)₂ |
| A-120 | CH | CH | S | 5-NO₂ |
| A-121 | CH | CH | S | 5-NH₂ |
| A-122 | CH | CH | S | 5-NH(C}O)CH₃ |
| A-123 | CH | CH | S | 6-CH₃ |
| A-124 | CH | CH | S | 6-CH₂CH₃ |
| A-125 | CH | CH | S | 6-CH₂CH₂CH₃ |
| A-126 | CH | CH | S | 6-CH(CH₃)₂ |
| A-127 | CH | CH | S | 6-CH₂CH₂CH₂CH₃ |
| A-128 | CH | CH | S | 6-CH₂CH(CH₃)₂ |
| A-129 | CH | CH | S | 6-CH(CH₃)₃ |
| A-130 | CH | CH | S | 6-F |
| A-131 | CH | CH | S | 6-Cl |
| A-132 | CH | CH | S | 6-Br |
| A-133 | CH | CH | S | 6-I |
| A-134 | CH | CH | S | 6-CF₃ |
| A-135 | CH | CH | S | 6-OCF₃ |
| A-136 | CH | CH | S | 6-OCH₃ |
| A-137 | CH | CH | S | 6-OCH₂CH₃ |
| A-138 | CH | CH | S | 6-OCH₂CH₂CH₃ |
| A-139 | CH | CH | 5,, | 6-OCH(CH₃)₂ |
| A-140 | CH | CH | S | 6-NO₂ |
| A-141 | CH | CH | S | 6-NH₂ |
| A-142 | CH | CH | S | 6-NH(C}O)CH₃ |
| A-143 | CH | CH | S | 7-CH₃ |
| A-144 | CH | CH | S | 7-CH₂CH₃ |
| A-145 | CH | CH | S | 7-CH₂CH₂CH₃ |
| A-146 | CH | CH | S | 7-CH(CH₃)₂ |
| A-147 | CH | CH | S | 7-CH₂CH₂CH₂CH₃ |
| A-148 | CH | CH | S | 7-CH₂CH(CH₃)₂ |
| A-149 | CH | CH | S | 7-CH(CH₃)₃ |
| A-150 | CH | CH | S | 7-F |
| A-151 | CH | CH | S | 7-Cl |
| A-152 | CH | CH | S | 7-Br |
| A-153 | CH | 0H | S | 7-I |
| A-154 | CH | CH | S | 7-CF₃ |
| A-155 | CH | CH | S | 7-OCF₃ |
| A-156 | CH | CH | S | 7-OCH₃ |
| A-157 | CH | CH | S | 7-OCH₂CH₃ |
| A-158 | CH | CH | S | 7-OCH₂CH₂CH₃ |
| A-159 | CH | CH | S | 7-OCH(CH₃)₂ |
| A-160 | CH | CH | S | 7-NO₂ |
| A-161 | CH | CH | S | 7-NH₂ |
| A-162 | CH | CH | S | 7-NH(C}O)CH₃ |
| A-163 | CH | N | O | — |
| A-164 | CH | N | O | 4-CH₃ |
| A-165 | CH | N | O | 4-CH₂CH₃ |
| A-166 | CH | N | O | 4-CH₂CH₂CH₃ |
| A-167 | CH | N | O | 4-CH(CH₃)₂ |
| A-168 | CH | N | O | 4-CH₂CH₂CH₂CH₃ |
| A-169 | CH | N | O | 4-CH₂CH(CH₃)₂ |
| A-170 | CH | N | O | 4-CH(CH₃)₃ |
| A-171 | CH | N | O | 4-F |
| A-172 | CH | N | O | 4-Cl |
| A-173 | CH | N | O | 4-Br |
| A-174 | CH | N | O | 4-I |
| A-175 | CH | N | O | 4-CF₃ |
| A-176 | CH | N | O | 4-OCF₃ |
| A-177 | CH | N | O | 4-OCH₃ |
| A-178 | CH | N | O | 4-OCH₂CH₃ |
| A-179 | CH | N | O | 4-OCH₂CH₂CH₃ |
| A-180 | CH | N | O | 4-OCH(CH₃)₂ |
| A-181 | CH | N | O | 4-NO₂ |
| A-182 | CH | N | O | 4-NH₂ |
| A-183 | CH | N | O | 4-NH(C}O)CH₃ |
| A-184 | CH | N | O | 5-CH₃ |
| A-185 | CH | N | O | 5-CH₂CH₃ |
| A-186 | CH | N | O | 5-CH₂CH₂CH₃ |
| A-187 | CH | N | O | 5-CH(CH₃)₂ |
| A-188 | CH | N | O | 5-CH₂CH₂CH₂CH₃ |
| A-189 | CH | N | O | 5-CH₂CH(CH₃)₂ |
| A-190 | CH | N | O | 5-CH(CH₃)₃ |
| A-191 | CH | N | O | 5-F |
| A-192 | CH | N | O | 5-Cl |
| A-193 | CH | N | O | 5-Br |
| A-194 | CH | N | O | 5-I |
| A-195 | CH | N | O | 5-CF₃ |
| A-196 | CH | N | O | 5-OCF₃ |
| A-197 | CH | N | O | 5-OCH₃ |
| A-198 | CH | N | O | 5-OCH₂CH₃ |
| A-199 | CH | N | O | 5-OCH₂CH₂CH₃ |
| A-200 | CH | N | O | 5-OCH(CH₃)₂ |
| A-201 | CH | N | O | 5-NO₂ |
| A-202 | CH | N | O | 5-NH₂ |
| A-203 | CH | N | O | 5-NH(C}O)CH₃ |
| A-204 | CH | N | O | 6-CH₃ |
| A-205 | CH | N | O | 6-CH₂CH₃ |
| A-206 | CH | N | O | 6-CH₂CH₂CH₃ |
| A-207 | CH | N | O | 6-CH(CH₃)₂ |
| A-208 | CH | N | O | 6-CH₂CH₂CH₂CH₃ |
| A-209 | CH | N | O | 6-CH₂CH(CH₃)₂ |
| A-210 | CH | N | O | 6-CH(CH₃₎₃ |
| A-211 | CH | N | O | 6-F |
| A-212 | CH | N | O | 6-Cl |
| A-213 | CH | N | O | 6-Br |
| A-214 | CH | N | O | 6-I |
| A-215 | CH | N | O | 6-CF₃ |
| A-216 | CH | N | O | 6-OCF₃ |
| A-217 | CH | N | O | 6-OCH₃ |
| A-218 | CH | N | O | 6-OCH₂CH₃ |
| A-219 | CH | N | O | 6-OCH₂CH₂CH₃ |
| A-220 | CH | N | O | 6-OCH(CH₃)₂ |
| A-221 | CH | N | O | 6-NO₂ |
| A-222 | CH | N | O | 6-NH₂ |
| A-223 | CH | N | O | 6-NH(C}O)CH₃ |
| A-224 | CH | N | S | — |
| A-225 | CH | N | S | 4-CH₃ |
| A-226 | CH | N | S | 4-CH₂CH₃ |
| A-227 | CH | N | S | 4-CH₂CH₂CH₃ |
| A-228 | CH | N | S | 4-CH(CH₃)₂ |
| A-229 | CH | N | S | 4-CH₂CH₂CH₂CH₃ |
| A-230 | CH | N | S | 4-CH₂CH(CH₃)₂ |
| A-231 | CH | N | S | 4-CH(CH₃)₃ |
| A-232 | CH | N | S | 4-F |
| A-233 | CH | N | S | 4-Cl |
| A-234 | CH | N | S | 4-Br |
| A-235 | CH | N | S | 4-I |
| A-236 | CH | N | S | 4-CF₃ |
| A-237 | CH | N | S | 4-OCF₃ |
| A-238 | CH | N | S | 4-OCH₃ |
| A-239 | CH | N | S | 4-OCH₂CH₃ |
| A-240 | CH | N | S | 4-OCH₂CH₂CH₃ |
| A-241 | CH | N | S | 4-OCH(CH₃)₂ |
| A-242 | CH | N | S | 4-NO₂ |
| A-243 | CH | N | S | 4-NH₂ |
| A-244 | CH | N | S | 4-NH(C}O)CH₃ |
| A-245 | CH | N | S | 5-CH₃ |
| A-246 | CH | N | S | 5-CH₂CH₃ |
| A-247 | CH | N | S | 5-CH₂CH₂CH₃ |
| A-248 | CH | N | S | 5-CH(CH₃)₂ |
| A-249 | CH | N | S | 5-CH₂CH₂CH₂CH₃ |
| A-250 | CH | N | S | 5-CH₂CH(CH₃)₂ |
| A-251 | CH | N | S | 5-CH(CH₃)₃ |
| A-252 | CH | N | S | 5-F |
| A-253 | CH | N | S | 5-Cl |
| A-254 | CH | N | S | 5-Br |
| A-255 | CH | N | S | 5-I |
| A-256 | CH | N | S | 5-CF₃ |
| A-257 | CH | N | S | 5-OCF₃ |
| A-258 | CH | N | S | 5-OCH₃ |
| A-259 | CH | N | S | 5-OCH₂CH₃ |
| A-260 | CH | N | S | 5-OCH₂CH₂CH₃ |
| A-261 | CH | N | S | 5-OCH(CH₃)₂ |
| A-262 | CH | N | S | 5-NO₂ |
| A-263 | CH | N | S | 5-NH₂ |
| A-264 | CH | N | S | 5-NH(C}O)CH₃ |
| A-265 | CH | N | S | 6-CH₃ |
| A-266 | CH | N | S | 6-CH₂CH₃ |
| A-267 | CH | N | S | 6-CH₂CH₂CH₃ |
| A-268 | CH | N | S | 6-CH(CH₃)₂ |
| A-269 | CH | N | S | 6-CH₂CH₂CH₂CH₃ |
| A-270 | CH | N | S | 6-CH₂CH(CH₃)₂ |
| A-271 | CH | N | S | 6-CH(CH₃)₃ |
| A-272 | CH | N | S | 6-F |
| A-273 | CH | N | S | 6-Cl |
| A-274 | CH | N | S | 6-Br |
| A-275 | CH | N | S | 6-I |
| A-276 | CH | N | S | 6-CF₃ |
| A-277 | CH | N | S | 6-OCF₃ |
| A-278 | CH | N | S | 6-OCH₃ |
| A-279 | CH | N | S | 6-OCH₂CH₃ |
| A-280 | CH | N | S | 6-OCH₂CH₂CH₃ |
| A-281 | CH | N | S | 6-OCH(CH₃)₂ |
| A-282 | CH | N | S | 6-NO₂ |
| A-283 | CH | N | S | 6-NH₂ |
| A-284 | CH | N | S | 6-NH(C}O)CH₃ |
| A-285 | N | CH | O | — |
| A-286 | N | CH | O | 5-CH₃ |
| A-287 | N | CH | O | 5-CH₂CH₃ |
| A-288 | N | CH | O | 5-CH₂CH₂CH₃ |
| A-289 | N | CH | O | 5-CH(CH₃)₂ |
| A-290 | N | CH | O | 5-CH₂CH₂CH₂CH₃ |
| A-291 | N | CH | O | 5-CH₂CH(CH₃)₂ |
| A-292 | N | CH | O | 5-CH(CH₃)₃ |
| A-293 | N | CH | O | 5-F |
| A-294 | N | CH | O | 5-Cl |
| A-295 | N | CH | O | 5-Br |
| A-296 | N | CH | O | 5-I |
| A-297 | N | CH | O | 5-CF₃ |
| A-298 | N | CH | O | 5-OCF₃ |
| A-299 | N | CH | O | 5-OCH₃ |
| A-300 | N | CH | O | 5-OCH₂CH₃ |
| A-301 | N | CH | O | 5-OCH₂CH₂CH₃ |
| A-302 | N | CH | O | 5-OCH(CH₃)₂ |
| A-303 | N | CH | O | 5-NO₂ |
| A-304 | N | CH | O | 5-NH₂ |
| A-305 | N | CH | O | 5-NH(C}O)CH₃ |
| A-306 | N | CH | O | 6-CH₃ |
| A-307 | N | CH | O | 6-CH₂CH₃ |
| A-308 | N | CH | O | 6-CH₂CH₂CH₃ |
| A-309 | N | CH | O | 6-CH(CH₃)₂ |
| A-310 | N | CH | O | 6-CH₂CH₂CH₂CH₃ |
| A-311 | N | CH | O | 6-CH₂CH(CH₃)₂ |
| A-312 | N | CH | O | 6-CH(CH₃)₃ |
| A-313 | N | CH | O | 6-F |
| A-314 | N | CH | O | 6-Cl |
| A-315 | N | CH | O | 6-Br |
| A-316 | N | CH | O | 6-I |
| A-317 | N | CH | O | 6-CF₃ |
| A-318 | N | CH | O | 6-OCF₃ |
| A-319 | N | CH | O | 6-OCH₃ |
| A-320 | N | CH | O | 6-OCH₂CH₃ |
| A-321 | N | CH | O | 6-OCH₂CH₂CH₃ |
| A-322 | N | CH | O | 6-OCH(CH₃)₂ |
| A-323 | N | CH | O | 6-NO₂ |
| A-324 | N | CH | O | 6-NH₂ |
| A-325 | N | CH | O | 6-NH(C}O)CH₃ |
| A-326 | N | CH | O | 7-CH₃ |
| A-327 | N | CH | O | 7-CH₂CH₃ |
| A-328 | N | CH | O | 7-CH₂CH₂CH₃ |
| A-329 | N | CH | O | 7-CH(CH₃)₂ |
| A-330 | N | CH | O | 7-CH₂CH₂CH₂CH₃ |
| A-331 | N | CH | O | 7-CH₂CH(CH₃)₂ |
| A-332 | N | CH | O | 7-CH(CH₃)₃ |
| A-333 | N | CH | O | 7-F |
| A-334 | N | CH | O | 7-Cl |
| A-335 | N | CH | O | 7-Br |
| A-336 | N | CH | O | 7-I |
| A-337 | N | CH | O | 7-CF₃ |
| A-338 | N | CH | O | 7-OCF₃ |
| A-339 | N | CH | O | 7-OCH₃ |
| A-340 | N | CH | O | 7-OCH₂CH₃ |
| A-341 | N | CH | O | 7-OCH₂CH₂CH₃ |
| A-342 | N | CH | O | 7-OCH(CH₃)₂ |
| A-343 | N | CH | O | 7-NO₂ |
| A-344 | N | CH | O | 7-NH₂ |
| A-345 | N | CH | O | 7-NH(C}O)CH₃ |

Table 41

Compounds of the formula I.6 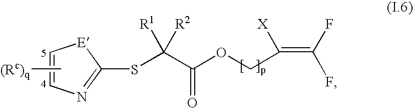
wherein X is hydrogen, p is 2, R¹ and R² are hydrogen, E′ is oxygen and (R^{c})_{q} is in the 4-position and corresponds in each case to a row of Table B.

Table 42

Compounds of the formula I.6 wherein X is hydrogen, p is 2, R¹ is hydrogen and R² is methyl, E′ is oxygen and (R^{c})_{q} is in the 4-position and corresponds in each case to a row of Table B.

Table 43

Compounds of the formula I.6 wherein X is hydrogen, p is 2, R¹ is hydrogen and R² is ethyl, Et is oxygen and (R^{c})_{q} is in the 4-position and corresponds in each case to a row of Table B.

Table 44

Compounds of the formula I.6 wherein X is hydrogen, p is 2, R¹ is hydrogen and R² is i-propyl, E′ is oxygen and (R^{c})_{q} is in the 4-position and corresponds in each case to a row of Table B.

Table 45

Compounds of the formula I.6 wherein X is hydrogen, p is 2, R¹ is hydrogen and R² is n-propyl, E′ is oxygen and (R^{c})_{q} is in the 4-position and corresponds in each case to a row of Table B.

Table 46

Compounds of the formula I.6 wherein X is hydrogen, p is 2, R¹ is hydrogen and R² is cyclo-propyl, E′ is oxygen and (R^{c})_{q} is in the 4-position and corresponds in each case to a row of Table B.

Table 47

Compounds of the formula I.6 wherein X is hydrogen, p is 2, R¹ is hydrogen and R² is n-butyl, E′ is oxygen and (R^{c})_{q} is in the 4-position and corresponds in each case to a row of Table B.

Table 48

Compounds of the formula I.6 wherein X is hydrogen, p is 2, R¹ is hydrogen and R² is i-butyl, E′ is oxygen and (R^{c})_{q} is in the 4-position and corresponds in each case to a row of Table B.

Table 49

Compounds of the formula I.6 wherein X is hydrogen, p is 2, R¹ is hydrogen and R² is tert-butyl, E′ is oxygen and (R^{c})_{q} is in the 4-position and corresponds in each case to a row of Table B.

Table 50

Compounds of the formula I.6 wherein X is hydrogen, p is 2, R¹ is hydrogen and R² is phenyl, E′ is oxygen and (R^{c})_{q} is in the 4-position and corresponds in each case to a row of Table B.

Table 51

Compounds of the formula I.6 wherein X is hydrogen, p is 4, R¹ and R² are hydrogen, E′ is oxygen and (R^{c})_{q} is in the 4-position and corresponds in each case to a row of Table B.

Table 52

Compounds of the formula I.6 wherein X is hydrogen, p is 4, R¹ is hydrogen and R² is methyl, E′ is oxygen and (R^{c})q is in the 4-position and corresponds in each case to a row of Table B.

Table 53

Compounds of the formula I.6 wherein X is hydrogen, p is 4, R¹ is hydrogen and R² is ethyl, E′ is oxygen and (R^{c})_{q} is in the 4-position and corresponds in each case to a row of Table B.

Table 54

Compounds of the formula I.6 wherein X is hydrogen, p is 4, R¹ is hydrogen and R² is i-propyl, E′ is oxygen and (R^{c})_{q} is in the 4-position and corresponds in each case to a row of Table B.

Table 55

Compounds of the formula I.6 wherein X is hydrogen, p is 4, R¹ is hydrogen and R² is n-propyl, E′ is oxygen and (R^{c})_{q} is in the 4-position and corresponds in each case to a row of Table B.

Table 56

Compounds of the formula I.6 wherein X is hydrogen, p is 4, R¹ is hydrogen and R² is cyclo-propyl, E′ is oxygen and (R^{c})_{q} is in the 4-position and corresponds in each case to a row of Table B.

Table 57

Compounds of the formula I.6 wherein X is hydrogen, p is 4, R¹ is hydrogen and R² is n-butyl, E′ is oxygen and (R^{c})_{q} is in the 4-position and corresponds in each case to a row of Table B.

Table 58

Compounds of the formula I.6 wherein X is hydrogen, p is 4, R¹ is hydrogen and R² is i-butyl, E′ is oxygen and (R^{c})_{q} is in the 4-position and corresponds in each case to a row of Table B.

Table 59

Compounds of the formula I.6 wherein X is hydrogen, p is 4, R¹ is hydrogen and R² is tert-butyl, E′ is oxygen and (R^{c})_{q} is in the 4-position and corresponds in each case to a row of Table B.

Table 60

Compounds of the formula I.6 wherein X is hydrogen, p is 4, R¹ is hydrogen and R² is phenyl, E′ is oxygen and (R^{c})_{q} is in the 4-position and corresponds in each case to a row of Table B.

Table 61

Compounds of the formula I.6 wherein X is fluorine, p is 2, R¹ and R² are hydrogen, E′ is oxygen and (R^{c})_{q} is in the 4-position and corresponds in each case to a row of Table B.

Table 62

Compounds of the formula I.6 wherein X is fluorine, p is 2, R¹ is hydrogen and R² is methyl, E′ is oxygen and (R^{c})_{q} is in the 4-position and corresponds in each case to a row of Table B.

Table 63

Compounds of the formula I.6 wherein X is fluorine, p is 2, R¹ is hydrogen and R² is ethyl, E′ is oxygen and (R^{c})_{q} is in the 4-position and corresponds in each case to a row of Table B.

Table 64

Compounds of the formula I.6 wherein X is fluorine, p is 2, R¹ is hydrogen and R² is i-propyl, E′ is oxygen and (R^{c})_{q} is in the 4-position and corresponds in each case to a row of Table B.

Table 65

Compounds of the formula I.6 wherein X is fluorine, p is 2, R¹ is hydrogen and R² is n-propyl, E′ is oxygen and (R^{c})_{q} is in the 4-position and corresponds in each case to a row of Table B.

Table 66

Compounds of the formula I.6 wherein X is fluorine, p is 2, R¹ is hydrogen and R² is cyclo-propyl, E′ is oxygen and (R^{c})_{q} is in the 4-position and corresponds in each case to a row of Table B.

Table 67

Compounds of the formula I.6 wherein X is fluorine, p is 2, R¹ is hydrogen and R² is n-butyl, E′ is oxygen and (R^{c})_{q} is in the 4-position and corresponds in each case to a row of Table B.

Table 68

Compounds of the formula I.6 wherein X is fluorine, p is 2, R¹ is hydrogen and R² is i-butyl, E′ is oxygen and (R^{c})q is in the 4-position and corresponds in each case to a row of Table B.

Table 69

Compounds of the formula I.6 wherein X is fluorine, p is 2, R¹ is hydrogen and R² is tert-butyl, E′ is oxygen and (R^{c})_{q} is in the 4-position and corresponds in each case to a row of Table B.

Table 70

Compounds of the formula I.6 wherein X is fluorine, p is 2, R¹ is hydrogen and R² is phenyl, E′ is oxygen and (R^{c})_{q} is in the 4-position and corresponds in each case to a row of Table B.

Table 71

Compounds of the formula I.6 wherein X is fluorine, p is 4, R¹ and R² are hydrogen, E′ is oxygen and (R^{c})_{q} is in the 4-position and corresponds in each case to a row of Table B.

Table 72

Compounds of the formula I.6 wherein X is fluorine, p is 4, R¹ is hydrogen and R² is methyl, E′ is oxygen and (R^{c})_{q} is in the 4-position and corresponds in each case to a row of Table B.

Table 73

Compounds of the formula I.6 wherein X is fluorine, p is 4, R¹ is hydrogen and R² is ethyl, E′ is oxygen and (R^{c})_{q} is in the 4-position and corresponds in each case to a row of Table B.

Table 74

Compounds of the formula I.6 wherein X is fluorine, p is 4, R¹ is hydrogen and R² is i-propyl, E′ is oxygen and (R^{c})_{q} is in the 4-position and corresponds in each case to a row of Table B.

Table 75

Compounds of the formula I.6 wherein X is fluorine, p is 4, R¹ is hydrogen and R² is n-propyl, E′ is oxygen and (R^{c})_{q} is in the 4-position and corresponds in each case to a row of Table B.

Table 76

Compounds of the formula I.6 wherein X is fluorine, p is 4, R¹ is hydrogen and R² is cyclo-propyl, E′ is oxygen and (R^{c})_{q} is in the 4-position and corresponds in each case to a row of Table B.

Table 77

Compounds of the formula I.6 wherein X is fluorine, p is 4, R¹ is hydrogen and R² is n-butyl, E′ is oxygen and (R^{c})_{q} is in the 4-position and corresponds in each case to a row of Table B.

Table 78

Compounds of the formula I.6 wherein X is fluorine, p is 4, R¹ is hydrogen and R² is i-butyl, E′ is oxygen and (R^{c})_{q} is in the 4-position and corresponds in each case to a row of Table B.

Table 79

Compounds of the formula I.6 wherein X is fluorine, p is 4, R¹ is hydrogen and R² is tert-butyl, E′ is oxygen and (R^{c})_{q} is in the 4-position and corresponds in each case to a row of Table B.

Table 80

Compounds of the formula I.6 wherein X is fluorine, p is 4, R¹ is hydrogen and R² is phenyl, E′ is oxygen and (R^{c})_{q} is in the 4-position and corresponds in each case to a row of Table B.

Table 81

Compounds of the formula I.6 wherein X is hydrogen, p is 2, R¹ and R² are hydrogen, E′ is oxygen and (R^{c})_{q} is in the 5-position and corresponds in each case to a row of Table B.

Table 82

Compounds of the formula I.6 wherein X is hydrogen, p is 2, R¹ is hydrogen and R² is methyl, E′ is oxygen and (R^{c})_{q} is in the 5-position and corresponds in each case to a row of Table B.

Table 83

Compounds of the formula I.6 wherein X is hydrogen, p is 2, R¹ is hydrogen and R² is ethyl, E′ is oxygen and (R^{c})_{q} is in the 5-position and corresponds in each case to a row of Table B.

Table 84

Compounds of the formula I.6 wherein X is hydrogen, p is 2, R¹ is hydrogen and R² is i-propyl, E′ is oxygen and (R^{c})_{q} is in the 5-position and corresponds in each case to a row of Table B.

Table 85

Compounds of the formula I.6 wherein X is hydrogen, p is 2, R¹ is hydrogen and R² is n-propyl, E′ is oxygen and (R^{c})_{q} is in the 5-position and corresponds in each case to a row of Table B.

Table 86

Compounds of the formula I.6 wherein X is hydrogen, p is 2, R¹ is hydrogen and R² is cyclo-propyl, E′ is oxygen and (R^{c})_{q} is in the 5-position and corresponds in each case to a row of Table B.

Table 87

Compounds of the formula I.6 wherein X is hydrogen, p is 2, R¹ is hydrogen and R² is n-butyl, E′ is oxygen and (R^{c})_{q} is in the 5-position and corresponds in each case to a row of Table B.

Table 88

Compounds of the formula I.6 wherein X is hydrogen, p is 2, R¹ is hydrogen and R² is i-butyl, E′ is oxygen and (R^{c})_{q} is in the 5-position and corresponds in each case to a row of Table B.

Table 89

Compounds of the formula I.6 wherein X is hydrogen, p is 2, R¹ is hydrogen and R² is tert-butyl, E′ is oxygen and (R^{c})_{q} is in the 5-position and corresponds in each case to a row of Table B.

Table 90

Compounds of the formula I.6 wherein X is hydrogen, p is 2, R¹ is hydrogen and R² is phenyl, E′ is oxygen and (R^{c})_{q} is in the 5-position and corresponds in each case to a row of Table B.

Table 91

Compounds of the formula I.6 wherein X is hydrogen, p is 4, R¹ and R² are hydrogen, E′ is oxygen and (R^{c})_{q} is in the 5-position and corresponds in each case to a row of Table B.

Table 92

Compounds of the formula I.6 wherein X is hydrogen, p is 4, R¹ is hydrogen and R² is methyl, E′ is oxygen and (R^{c})_{q} is in the 5-position and corresponds in each case to a row of Table B.

Table 93

Compounds of the formula I.6 wherein X is hydrogen, p is 4, R¹ is hydrogen and R² is ethyl, E′ is oxygen and (R^{c})_{q} is in the 5-position and corresponds in each case to a row of Table B.

Table 94

Compounds of the formula I.6 wherein X is hydrogen, p is 4, R¹ is hydrogen and R² is i-propyl, E′ is oxygen and (R^{c})_{q} is in the 5-position and corresponds in each case to a row of Table B.

Table 95

Compounds of the formula I.6 wherein X is hydrogen, p is 4, R¹ is hydrogen and R² is n-propyl, E′ is oxygen and (R^{c})_{q} is in the 5-position and corresponds in each case to a row of Table B.

Table 96

Compounds of the formula I.6 wherein X is hydrogen, p is 4, R¹ is hydrogen and R² is cyclo-propyl, E′ is oxygen and (R^{c})_{q} is in the 5-position and corresponds in each case to a row of Table B.

Table 97

Compounds of the formula I.6 wherein X is hydrogen, p is 4, R¹ is hydrogen and R² is n-butyl, E′ is oxygen and (R^{c})_{q} is in the 5-position and corresponds in each case to a row of Table B.

Table 98

Compounds of the formula I.6 wherein X is hydrogen, p is 4, R¹ is hydrogen and R² is i-butyl, E′ is oxygen and (R^{c})_{q} is in the 5-position and corresponds in each case to a row of Table B.

Table 99

Compounds of the formula I.6 wherein X is hydrogen, p is 4, R¹ is hydrogen and R² is tert-butyl, E′ is oxygen and (R^{c})_{q} is in the 5-position and corresponds in each case to a row of Table B.

Table 100

Compounds of the formula I.6 wherein X is hydrogen, p is 4, R¹ is hydrogen and R² is phenyl, E′ is oxygen and (R^{c})_{q} is in the 5-position and corresponds in each case to a row of Table B.

Table 101

Compounds of the formula I.6 wherein X is fluorine, p is 2, R¹ and R² are hydrogen, E′ is oxygen and (R^{c})_{q} is in the 5-position and corresponds in each case to a row of Table B.

Table 102

Compounds of the formula I.6 wherein X is fluorine, p is 2, R¹ is hydrogen and R² is methyl, E′ is oxygen and (R^{c})_{q} is in the 5-position and corresponds in each case to a row of Table B.

Table 103

Compounds of the formula I.6 wherein X is fluorine, p is 2, R¹ is hydrogen and R² is ethyl, E′ is oxygen and (R^{c})_{q} is in the 5-position and corresponds in each case to a row of Table B.

Table 104

Compounds of the formula I.6 wherein X is fluorine, p is 2, R¹ is hydrogen and R² is i-propyl, E′ is oxygen and (R^{c})_{q} is in the 5-position and corresponds in each case to a row of Table B.

Table 105

Compounds of the formula I.6 wherein X is fluorine, p is 2, R¹ is hydrogen and R² is n-propyl, E′ is oxygen and (R^{c})_{q} is in the 5-position and corresponds in each case to a row of Table B.

Table 106

Compounds of the formula I.6 wherein X is fluorine, p is 2, R¹ is hydrogen and R² is cyclo-propyl, E′ is oxygen and (R^{c})_{q} is in the 5-position and corresponds in each case to a row of Table B.

Table 107

Compounds of the formula I.6 wherein X is fluorine, p is 2, R¹ is hydrogen and R² is n-butyl, E′ is oxygen and (R^{c})_{q} is in the 5-position and corresponds in each case to a row of Table B.

Table 108

Compounds of the formula I.6 wherein X is fluorine, p is 2, R¹ is hydrogen and R² is i-butyl, E′ is oxygen and (R^{c})_{q} is in the 5-position and corresponds in each case to a row of Table B.

Table 109

Compounds of the formula I.6 wherein X is fluorine, p is 2, R¹ is hydrogen and R² is tert-butyl, E′ is oxygen and (R^{c})_{q} is in the 5-position and corresponds in each case to a row of Table B.

Table 110

Compounds of the formula I.6 wherein X is fluorine, p is 2, R¹ is hydrogen and R² is phenyl, E′ is oxygen and (R^{c})_{q} is in the 5-position and corresponds in each case to a row of Table B.

Table 111

Compounds of the formula I.6 wherein X is fluorine, p is 4, R¹ and R² are hydrogen, E′ is oxygen and (R^{c})_{q} is in the 5-position and corresponds in each case to a row of Table B.

Table 112

Compounds of the formula I.6 wherein X is fluorine, p is 4, R¹ is hydrogen and R² is methyl, E′ is oxygen and (R^{c})_{q} is in the 5-position and corresponds in each case to a row of Table B.

Table 113

Compounds of the formula I.6 wherein X is fluorine, p is 4, R¹ is hydrogen and R² is ethyl, E′ is oxygen and (R^{c})_{q} is in the 5-position and corresponds in each case to a row of Table B.

Table 114

Compounds of the formula I.6 wherein X is fluorine, p is 4, R¹ is hydrogen and R² is i-propyl, E′ is oxygen and (R^{c})_{q} is in the 5-position and corresponds in each case to a row of Table B.

Table 115

Compounds of the formula I.6 wherein X is fluorine, p is 4, R¹ is hydrogen and R² is n-propyl, E′ is oxygen and (R^{c})_{q} is in the 5-position and corresponds in each case to a row of Table B.

Table 116

Compounds of the formula I.6 wherein X is fluorine, p is 4, R¹ is hydrogen and R² is cyclo-propyl, E′ is oxygen and (R^{c})_{q} is in the 5-position and corresponds in each case to a row of Table B.

Table 117

Compounds of the formula I.6 wherein X is fluorine, p is 4, R¹ is hydrogen and R² is n-butyl, E′ is oxygen and (R^{c})_{q} is in the 5-position and corresponds in each case to a row of Table B.

Table 118

Compounds of the formula I.6 wherein X is fluorine, p is 4, R¹ is hydrogen and R² is i-butyl, E′ is oxygen and (R^{c})_{q} is in the 5-position and corresponds in each case to a row of Table B.

Table 119

Compounds of the formula I.6 wherein X is fluorine, p is 4, R¹ is hydrogen and R² is tert-butyl, E′ is oxygen and (R^{c})_{q} is in the 5-position and corresponds in each case to a row of Table B.

Table 120

Compounds of the formula I.6 wherein X is fluorine, p is 4, R¹ is hydrogen and R² is phenyl, E′ is oxygen and (R^{c})_{q} is in the 5-position and corresponds in each case to a row of Table B.

Table 121

Compounds of the formula I.6 wherein X is hydrogen, p is 2, R¹ and R² are hydrogen, E′ is sulfur and (R^{c})_{q} is in the 4-position and corresponds in each case to a row of Table B.

Table 122

Compounds of the formula I.6 wherein X is hydrogen, p is 2, R¹ is hydrogen and R² is methyl, E′ is sulfur and (R^{c})_{q} is in the 4-position and corresponds in each case to a row of Table B.

Table 123

Compounds of the formula I.6 wherein X is hydrogen, p is 2, R¹ is hydrogen and R² is ethyl, E′ is sulfur and (R^{c})_{q} is in the 4-position and corresponds in each case to a row of Table B.

Table 124

Compounds of the formula I.6 wherein X is hydrogen, p is 2, R¹ is hydrogen and R² is i-propyl, E′ is sulfur and (R^{c})_{q} is in the 4-position and corresponds in each case to a row of Table B.

Table 125

Compounds of the formula I.6 wherein X is hydrogen, p is 2, R¹ is hydrogen and R² is n-propyl, E′ is sulfur and (R^{c})_{q} is in the 4-position and corresponds in each case to a row of Table B.

Table 126

Compounds of the formula I.6 wherein X is hydrogen, p is 2, R¹ is hydrogen and R² is cyclo-propyl, E′ is sulfur and (R^{c})_{q} is in the 4-position and corresponds in each case to a row of Table B.

Table 127

Compounds of the formula I.6 wherein X is hydrogen, p is 2, R¹ is hydrogen and R² is n-butyl, E′ is sulfur and (R^{c})_{q} is in the 4-position and corresponds in each case to a row of Table B.

Table 128

Compounds of the formula I.6 wherein X is hydrogen, p is 2, R¹ is hydrogen and R² is i-butyl, E′ is sulfur and (R^{c})_{q} is in the 4-position and corresponds in each case to a row of Table B.

Table 129

Compounds of the formula I.6 wherein X is hydrogen, p is 2, R¹ is hydrogen and R² is tert-butyl, E′ is sulfur and (R^{c})_{q} is in the 4-position and corresponds in each case to a row of Table B.

Table 130

Compounds of the formula I.6 wherein X is hydrogen, p is 2, R¹ is hydrogen and R² is phenyl, E′ is sulfur and (R^{c})_{q} is in the 4-position and corresponds in each case to a row of Table B.

Table 131

Compounds of the formula I.6 wherein X is hydrogen, p is 4, R¹ and R² are hydrogen, E′ is sulfur and (R^{c})_{q} is in the 4-position and corresponds in each case to a row of Table B.

Table 132

Compounds of the formula I.6 wherein X is hydrogen, p is 4, R¹ is hydrogen and R² is methyl, E′ is sulfur and (R^{c})_{q} is in the 4-position and corresponds in each case to a row of Table B.

Table 133

Compounds of the formula I.6 wherein X is hydrogen, P is 4, R¹ is hydrogen and R² is ethyl, E′ is sulfur and (R^{c})_{q} is in the 4-position and corresponds in each case to a row of Table B.

Table 134

Compounds of the formula I.6 wherein X is hydrogen, p is 4, R¹ is hydrogen and R² is i-propyl, E′ is sulfur and (R^{c})_{q} is in the 4-position and corresponds in each case to a row of Table B.

Table 135

Compounds of the formula I.6 wherein X is hydrogen, p is 4, R¹ is hydrogen and R² is n-propyl, E′ is sulfur and (R^{c})_{q} is in the 4-position and corresponds in each case to a row of Table B.

Table 136

Compounds of the formula I.6 wherein X is hydrogen, p is 4, R¹ is hydrogen and R² is cyclo-propyl, E′ is sulfur and (R^{c})_{q} is in the 4-position and corresponds in each case to a row of Table B.

Table 137

Compounds of the formula I.6 wherein X is hydrogen, p is 4, R¹ is hydrogen and R² is n-butyl, E′ is sulfur and (R^{c})_{q} is in the 4-position and corresponds in each case to a row of Table B.

Table 138

Compounds of the formula I.6 wherein X is hydrogen, p is 4, R¹ is hydrogen and R² is i-butyl, E′ is sulfur and (R^{c})_{q} is in the 4-position and corresponds in each case to a row of Table B.

Table 139

Compounds of the formula I.6 wherein X is hydrogen, p is 4, R¹ is hydrogen and R² is tert-butyl, E′ is sulfur and (R^{c})_{q} is in the 4-position and corresponds in each case to a row of Table B.

Table 140

Compounds of the formula I.6 wherein X is hydrogen, p is 4, R¹ is hydrogen and R² is phenyl, E′ is sulfur and (R^{c})_{q} is in the 4-position and corresponds in each case to a row of Table B.

Table 141

Compounds of the formula I.6 wherein X is fluorine, p is 2, R¹ and R² are hydrogen, E′ is sulfur and (R^{c})_{q} is in the 4-position and corresponds in each case to a row of Table B.

Table 142

Compounds of the formula I.6 wherein X is fluorine, p is 2, R¹ is hydrogen and R² is methyl, E′ is sulfur and (R^{c})_{q} is in the 4-position and corresponds in each case to a row of Table B.

Table 143

Compounds of the formula I.6 wherein X is fluorine, p is 2, R¹ is hydrogen and R² is ethyl, E′ is sulfur and (R^{c})_{q} is in the 4-position and corresponds in each case to a row of Table B.

Table 144

Compounds of the formula I.6 wherein X is fluorine, p is 2, R¹ is hydrogen and R² is i-propyl, E′ is sulfur and (R^{c})_{q} is in the 4-position and corresponds in each case to a row of Table B.

Table 145

Compounds of the formula I.6 wherein X is fluorine, p is 2, R¹ is hydrogen and R² is n-propyl, E′ is sulfur and (R^{c})_{q} is in the 4-position and corresponds in each case to a row of Table B.

Table 146

Compounds of the formula I.6 wherein X is fluorine, p is 2, R¹ is hydrogen and R² is cyclo-propyl, E′ is sulfur and (R^{c})_{q} is in the 4-position and corresponds in each case to a row of Table B.

Table 147

Compounds of the formula I.6 wherein X is fluorine, p is 2, R¹ is hydrogen and R² is n-butyl, E′ is sulfur and (R^{c})_{q} is in the 4-position and corresponds in each case to a row of Table B.

Table 148

Compounds of the formula I.6 wherein X is fluorine, p is 2, R¹ is hydrogen and R² is i-butyl, E′ is sulfur and (R^{c})_{q} is in the 4-position and corresponds in each case to a row of Table B.

Table 149

Compounds of the formula I.6 wherein X is fluorine, p is 2, R¹ is hydrogen and R² is tert-butyl, E′ is sulfur and (R^{c})_{q} is in the 4-position and corresponds in each case to a row of Table B.

Table 150

Compounds of the formula I.6 wherein X is fluorine, p is 2, R¹ is hydrogen and R² is phenyl, E′ is sulfur and (R^{c})_{q} is in the 4-position and corresponds in each case to a row of Table B.

Table 151

Compounds of the formula I.6 wherein X is fluorine, p is 4, R¹ and R² are hydrogen, E′ is sulfur and (R^{c})_{q} is in the 4-position and corresponds in each case to a row of Table B.

Table 152

Compounds of the formula I.6 wherein X is fluorine, p is 4, R¹ is hydrogen and R² is methyl, E′ is sulfur and (R^{c})_{q} is in the 4-position and corresponds in each case to a row of Table B.

Table 153

Compounds of the formula I.6 wherein X is fluorine, p is 4, R¹ is hydrogen and R² is ethyl, E′ is sulfur and (R^{c})_{q} is in the 4-position and corresponds in each case to a row of Table B.

Table 154

Compounds of the formula I.6 wherein X is fluorine, p is 4, R¹ is hydrogen and R² is i-propyl, E′ is sulfur and (R^{c})_{q} is in the 4-position and corresponds in each case to a row of Table B.

Table 155

Compounds of the formula I.6 wherein X is fluorine, p is 4, R¹ is hydrogen and R² is n-propyl, E′ is sulfur and (R^{c})_{q} is in the 4-position and corresponds in each case to a row of Table B.

Table 156

Compounds of the formula I.6 wherein X is fluorine, p is 4, R¹ is hydrogen and R² is cyclo-propyl, E′ is sulfur and (R^{c})_{q} is in the 4-position and corresponds in each case to a row of Table B.

Table 157

Compounds of the formula I.6 wherein X is fluorine, p is 4, R¹ is hydrogen and R² is n-butyl, E′ is sulfur and (R^{c})_{q} is in the 4-position and corresponds in each case to a row of Table B.

Table 158

Compounds of the formula I.6 wherein X is fluorine, p is 4, R¹ is hydrogen and R² is i-butyl, E′ is sulfur and (R^{c})_{q} is in the 4-position and corresponds in each case to a row of Table B.

Table 159

Compounds of the formula I.6 wherein X is fluorine, p is 4, R¹ is hydrogen and R² is tert-butyl, E′ is sulfur and (R^{c})_{q} is in the 4-position and corresponds in each case to a row of Table B.

Table 160

Compounds of the formula I.6 wherein X is fluorine, p is 4, R¹ is hydrogen and R² is phenyl, E′ is sulfur and (R^{c})_{q} is in the 4-position and corresponds in each case to a row of Table B.

Table 161

Compounds of the formula I.6 wherein X is hydrogen, p is 2, R¹ and R² are hydrogen, E′ is sulfur and (R^{c})_{q} is in the 5-position and corresponds in each case to a row of Table B.

Table 162

Compounds of the formula I.6 wherein X is hydrogen, p is 2, R¹ is hydrogen and R² is methyl, E′ is sulfur and (R^{c})_{q} is in the 5-position and corresponds in each case to a row of Table B.

Table 163

Compounds of the formula I.6 wherein X is hydrogen, p is 2, R¹ is hydrogen and R² is ethyl, E′ is sulfur and (R^{c})_{q} is in the 5-position and corresponds in each case to a row of Table B.

Table 164

Compounds of the formula I.6 wherein X is hydrogen, p is 2, R¹ is hydrogen and R² is i-propyl, E′ is sulfur and (R^{c})_{q} is in the 5-position and corresponds in each case to a row of Table B.

Table 165

Compounds of the formula I.6 wherein X is hydrogen, p is 2, R¹ is hydrogen and R² is n-propyl, E′ is sulfur and (R^{c})_{q} is in the 5-position and corresponds in each case to a row of Table B.

Table 166

Compounds of the formula I.6 wherein X is hydrogen, p is 2, R¹ is hydrogen and R² is cyclo-propyl, E′ is sulfur and (R^{c})_{q} is in the 5-position and corresponds in each case to a row of Table B.

Table 167

Compounds of the formula I.6 wherein X is hydrogen, p is 2, R¹ is hydrogen and R² is n-butyl, E′ is sulfur and (R^{c})_{q} is in the 5-position and corresponds in each case to a row of Table B.

Table 168

Compounds of the formula I.6 wherein X is hydrogen, p is 2, R¹ is hydrogen and R² is i-butyl, E′ is sulfur and (R^{c})_{q} is in the 5-position and corresponds in each case to a row of Table B.

Table 169

Compounds of the formula I.6 wherein X is hydrogen, p is 2, R¹ is hydrogen and R² is tert-butyl, E′ is sulfur and (R^{c})_{q} is in the 5-position and corresponds in each case to a row of Table B.

Table 170

Compounds of the formula I.6 wherein X is hydrogen, p is 2, R¹ is hydrogen and R² is phenyl, E′ is sulfur and (R^{c})_{q} is in the 5-position and corresponds in each case to a row of Table B.

Table 171

Compounds of the formula I.6 wherein X is hydrogen, p is 4, R¹ and R² are hydrogen, E′ is sulfur and (R^{c})_{q} is in the 5-position and corresponds in each case to a row of Table B.

Table 172

Compounds of the formula I.6 wherein X is hydrogen, p is 4, R¹ is hydrogen and R² is methyl, E′ is sulfur and (R^{c})_{q} is in the 5-position and corresponds in each case to a row of Table B.

Table 173

Compounds of the formula I.6 wherein X is hydrogen, p is 4, R¹ is hydrogen and R² is ethyl, E′ is sulfur and (R^{c})_{q} is in the 5-position and corresponds in each case to a row of Table B.

Table 174

Compounds of the formula I.6 wherein X is hydrogen, p is 4, R¹ is hydrogen and R² is i-propyl, E′ is sulfur and (R^{c})_{q} is in the 5-position and corresponds in each case to a row of Table B.

Table 175

Compounds of the formula I.6 wherein X is hydrogen, p is 4, R¹ is hydrogen and R² is n-propyl, E′ is sulfur and (R^{c})_{q} is in the 5-position and corresponds in each case to a row of Table B.

Table 176

Compounds of the formula I.6 wherein X is hydrogen, p is 4, R¹ is hydrogen and R² is cyclo-propyl, E′ is sulfur and (R^{c})_{q} is in the 5-position and corresponds in each case to a row of Table B.

Table 177

Compounds of the formula I.6 wherein X is hydrogen, p is 4, R¹ is hydrogen and R² is n-butyl, E′ is sulfur and (R^{c})_{q} is in the 5-position and corresponds in each case to a row of Table B.

Table 178

Compounds of the formula I.6 wherein X is hydrogen, p is 4, R¹ is hydrogen and R² is i-butyl, E′ is sulfur and (R^{c})_{q} is in the 5-position and corresponds in each case to a row of Table B.

Table 179

Compounds of the formula I.6 wherein X is hydrogen, p is 4, R¹ is hydrogen and R² is tert-butyl, E′ is sulfur and (R^{c})_{q} is in the 5-position and corresponds in each case to a row of Table B.

Table 180

Compounds of the formula I.6 wherein X is hydrogen, p is 4, R¹ is hydrogen and R² is phenyl, E′ is sulfur and (R^{c})_{q} is in the 5-position and corresponds in each case to a row of Table B.

Table 181

Compounds of the formula I.6 wherein X is fluorine, p is 2, R¹ and R² are hydrogen, E′ is sulfur and (R^{c})_{q} is in the 5-position and corresponds in each case to a row of Table B.

Table 182

Compounds of the formula I.6 wherein X is fluorine, p is 2, R¹ is hydrogen and R² is methyl, E′ is sulfur and (R^{c})_{q} is in the 5-position and corresponds in each case to a row of Table B.

Table 183

Compounds of the formula I.6 wherein X is fluorine, p is 2, R¹ is hydrogen and R² is ethyl, E′ is sulfur and R^{c} is in the 5-position and corresponds in each case to a row of Table B.

Table 184

Compounds of the formula I.6 wherein X is fluorine, p is 2, R¹ is hydrogen and R² is i-propyl, E′ is sulfur and (R^{c})_{q} is in the 5-position and corresponds in each case to a row of Table B.

Table 185

Compounds of the formula I.6 wherein X is fluorine, p is 2, R¹ is hydrogen and R² is n-propyl, E′ is sulfur and (R^{c})_{q} is in the 5-position and corresponds in each case to a row of Table B.

Table 186

Compounds of the formula I.6 wherein X is fluorine, p is 2, R¹ is hydrogen and R² is cyclo-propyl, E′ is sulfur and (R^{c})_{q} is in the 5-position and corresponds in each case to a row of Table B.

Table 187

Compounds of the formula I.6 wherein X is fluorine, p is 2, R¹ is hydrogen and R² is n-butyl, E′ is sulfur and (R^{c})_{q} is in the 5-position and corresponds in each case to a row of Table B.

Table 188

Compounds of the formula I.6 wherein X is fluorine, p is 2, R¹ is hydrogen and R² is i-butyl, E′ is sulfur and (R^{c})_{q} is in the 5-position and corresponds in each case to a row of Table B.

Table 189

Compounds of the formula I.6 wherein X is fluorine, p is 2, R¹ is hydrogen and R² is tert-butyl, E′ is sulfur and (R^{c})_{q} is in the 5-position and corresponds in each case to a row of Table B.

Table 190

Compounds of the formula I.6 wherein X is fluorine, p is 2, R¹ is hydrogen and R² is phenyl, E′ is sulfur and (R^{c})_{q} is in the 5-position and corresponds in each case to a row of Table B.

Table 191

Compounds of the formula I.6 wherein X is fluorine, p is 4, R¹ and R² are hydrogen, E′ is sulfur and (R^{c})_{q} is in the 5-position and corresponds in each case to a row of Table B.

Table 192

Compounds of the formula I.6 wherein X is fluorine, p is 4, R¹ is hydrogen and R² is methyl, E′ is sulfur and (R^{c})_{q} is in the 5-position and corresponds in each case to a row of Table B.

Table 193

Compounds of the formula I.6 wherein X is fluorine, p is 4, R¹ is hydrogen and R² is ethyl, E′ is sulfur and (R^{c})_{q} is in the 5-position and corresponds in each case to a row of Table B.

Table 194

Compounds of the formula I.6 wherein X is fluorine, p is 4, R¹ is hydrogen and R² is i-propyl, E′ is sulfur and (R^{c})_{q} is in the 5-position and corresponds in each case to a row of Table B.

Table 195

Compounds of the formula I.6 wherein X is fluorine, p is 4, R¹ is hydrogen and R² is n-propyl, E′ is sulfur and (R^{c})_{q} is in the 5-position and corresponds in each case to a row of Table B.

Table 196

Compounds of the formula I.6 wherein X is fluorine, p is 4, R¹ is hydrogen and R² is cyclo-propyl, E′ is sulfur and (R^{c})_{q} is in the 5-position and corresponds in each case to a row of Table B.

Table 197

Compounds of the formula I.6 wherein X is fluorine, p is 4, R¹ is hydrogen and R² is n-butyl, E′ is sulfur and (R^{c})_{q} is in the 5-position and corresponds in each case to a row of Table B.

Table 198

Compounds of the formula I.6 wherein X is fluorine, p is 4, R¹ is hydrogen and R² is i-butyl, E′ is sulfur and (R^{c})_{q} is in the 5-position and corresponds in each case to a row of Table B.

Table 199

Compounds of the formula I.6 wherein X is fluorine, p is 4, R¹ is hydrogen and R² is tert-butyl, E′ is sulfur and (R^{c})_{q} is in the 5-position and corresponds in each case to a row of Table B.

Table 200

Compounds of the formula I.6 wherein X is fluorine, p is 4, R¹ is hydrogen and R² is phenyl, E′ is sulfur and (R^{c})_{q} is in the 5-position and corresponds in each case to a row of Table B.

Table 201

Compounds of the formula I.6 wherein X is hydrogen, p is 2, R¹ and R² are hydrogen, E′ is NH and (R^{c})_{q} is in the 4-position and corresponds in each case to a row of Table B.

Table 202

Compounds of the formula I.6 wherein X is hydrogen, p is 2, R¹ is hydrogen and R² is methyl, E′ is NH and (R^{c})_{q} is in the 4-position and corresponds in each case to a row of Table B.

Table 203

Compounds of the formula I.6 wherein X is hydrogen, p is 2, R¹ is hydrogen and R² is ethyl, E′ is NH and (R^{c})_{q} is in the 4-position and corresponds in each case to a row of Table B.

Table 204

Compounds of the formula I.6 wherein X is hydrogen, p is 2, R¹ is hydrogen and R² is i-propyl, E′ is NH and (R^{c})_{q} is in the 4-position and corresponds in each case to a row of Table B.

Table 205

Compounds of the formula I.6 wherein X is hydrogen, p is 2, R¹ is hydrogen and R² is n-propyl, E′ is NH and (R^{c})_{q} is in the 4-position and corresponds in each case to a row of Table B.

Table 206

Compounds of the formula I.6 wherein X is hydrogen, p is 2, R¹ is hydrogen and R² is cyclo-propyl, E′ is NH and (R^{c})_{q} is in the 4-position and corresponds in each case to a row of Table B.

Table 207

Compounds of the formula I.6 wherein X is hydrogen, p is 2, R¹ is hydrogen and R² is n-butyl, E′ is NH and (R^{c})_{q} is in the 4-position and corresponds in each case to a row of Table B.

Table 208

Compounds of the formula I.6 wherein X is hydrogen, p is 2, R¹ is hydrogen and R² is i-butyl, E′ is NH and (R^{c})_{q} is in the 4-position and corresponds in each case to a row of Table B.

Table 209

Compounds of the formula I.6 wherein X is hydrogen, p is 2, R¹ is hydrogen and R² is tert-butyl, E′ is NH and (R^{c})_{q} is in the 4-position and corresponds in each case to a row of Table B.

Table 210

Compounds of the formula I.6 wherein X is hydrogen, p is 2, R¹ is hydrogen and R² is phenyl, E′ is NH and (R^{c})_{q} is in the 4-position and corresponds in each case to a row of Table B.

Table 211

Compounds of the formula I.6 wherein X is hydrogen, p is 4, R¹ and R² are hydrogen, E′ is NH and (R^{c})_{q} is in the 4-position and corresponds in each case to a row of Table B.

Table 212

Compounds of the formula I.6 wherein X is hydrogen, p is 4, R¹ is hydrogen and R² is methyl, E′ is NH and (R^{c})_{q} is in the 4-position and corresponds in each case to a row of Table B.

Table 213

Compounds of the formula I.6 wherein X is hydrogen, p is 4, R¹ is hydrogen and R² is ethyl, E′ is NH and (R^{c})_{q} is in the 4-position and corresponds in each case to a row of Table B.

Table 214

Compounds of the formula I.6 wherein X is hydrogen, p is 4, R¹ is hydrogen and R² is i-propyl, E′ is NH and (R^{c})_{q} is in the 4-position and corresponds in each case to a row of Table B.

Table 215

Compounds of the formula I.6 wherein X is hydrogen, p is 4, R¹ is hydrogen and R² is n-propyl, E′ is NH and (R^{c})_{q} is in the 4-position and corresponds in each case to a row of Table B.

Table 216

Compounds of the formula I.6 wherein X is hydrogen, p is 4, R¹ is hydrogen and R² is cyclo-propyl, E′ is NH and (R^{c})_{q} is in the 4-position and corresponds in each case to a row of Table B.

Table 217

Compounds of the formula I.6 wherein X is hydrogen, p is 4, R¹ is hydrogen and R² is n-butyl, E′ is NH and (R^{c})_{q} is in the 4-position and corresponds in each case to a row of Table B.

Table 218

Compounds of the formula I.6 wherein X is hydrogen, p is 4, R¹ is hydrogen and R² is i-butyl, E′ is NH and (R^{c})_{q} is in the 4-position and corresponds in each case to a row of Table B.

Table 219

Compounds of the formula I.6 wherein X is hydrogen, p is 4, R¹ is hydrogen and R² is tert-butyl, E′ is NH and (R^{c})_{q} is in the 4-position and corresponds in each case to a row of Table B.

Table 220

Compounds of the formula I.6 wherein X is hydrogen, p is 4, R¹ is hydrogen and R² is phenyl, E′ is NH and (R^{c})_{q} is in the 4-position and corresponds in each case to a row of Table B.

Table 221

Compounds of the formula I.6 wherein X is fluorine, p is 2, R¹ and R² are hydrogen, E′ is NH and (R^{c})_{q} is in the 4-position and corresponds in each case to a row of Table B.

Table 222

Compounds of the formula I.6 wherein X is fluorine, p is 2, R¹ is hydrogen and R² is methyl, E′ is NH and (R^{c})_{q} is in the 4-position and corresponds in each case to a row of Table B.

Table 223

Compounds of the formula I.6 wherein X is fluorine, p is 2, R¹ is hydrogen and R² is ethyl, E′ is NH and (R^{c})_{q} is in the 4-position and corresponds in each case to a row of Table B.

Table 224

Compounds of the formula I.6 wherein X is fluorine, p is 2, R¹ is hydrogen and R² is i-propyl, E′ is NH and (R^{c})_{q} is in the 4-position and corresponds in each case to a row of Table B.

Table 225

Compounds of the formula I.6 wherein X is fluorine, p is 2, R¹ is hydrogen and R² is n-propyl, E′ is NH and (R^{c})_{q} is in the 4-position and corresponds in each case to a row of Table B.

Table 226

Compounds of the formula I.6 wherein X is fluorine, p is 2, R¹ is hydrogen and R² is cyclo-propyl, E′ is NH and (R^{c})_{q} is in the 4-position and corresponds in each case to a row of Table B.

Table 227

Compounds of the formula I.6 wherein X is fluorine, p is 2, R¹ is hydrogen and R² is n-butyl, E′ is NH and (R^{c})_{q} is in the 4-position and corresponds in each case to a row of Table B.

Table 228

Compounds of the formula I.6 wherein X is fluorine, p is 2, R¹ is hydrogen and R² is i-butyl, E′ is NH and (R^{c})_{q} is in the 4-position and corresponds in each case to a row of Table B.

Table 229

Compounds of the formula I.6 wherein X is fluorine, p is 2, R¹ is hydrogen and R² is tert-butyl, E′ is NH and (R^{c})_{q} is in the 4-position and corresponds in each case to a row of Table B.

Table 230

Compounds of the formula I.6 wherein X is fluorine, p is 2, R¹ is hydrogen and R² is phenyl, E′ is NH and (R^{c})_{q} is in the 4-position and corresponds in each case to a row of Table B.

Table 231

Compounds of the formula I.6 wherein X is fluorine, p is 4, R¹ and R² are hydrogen, E′ is NH and (R^{c})_{q} is in the 4-position and corresponds in each case to a row of Table B.

Table 232

Compounds of the formula I.6 wherein X is fluorine, p is 4, R¹ is hydrogen and R² is methyl, E′ is NH and (R^{c})_{q} is in the 4-position and corresponds in each case to a row of Table B.

Table 233

Compounds of the formula I.6 wherein X is fluorine, p is 4, R¹ is hydrogen and R² is ethyl, E′ is NH and (R^{c})_{q} is in the 4-position and corresponds in each case to a row of Table B.

Table 234

Compounds of the formula I.6 wherein X is fluorine, p is 4, R¹ is hydrogen and R² is i-propyl, E′ is NH and (R^{c})_{q} is in the 4-position and corresponds in each case to a row of Table B.

Table 235

Compounds of the formula I.6 wherein X is fluorine, p is 4, R¹ is hydrogen and R² is n-propyl, E′ is NH and (R^{c})_{q} is in the 4-position and corresponds in each case to a row of Table B.

Table 236

Compounds of the formula I.6 wherein X is fluorine, p is 4, R¹ is hydrogen and R² is cyclo-propyl, E′ is NH and (R^{c})_{q} is in the 4-position and corresponds in each case to a row of Table B.

Table 237

Compounds of the formula I.6 wherein X is fluorine, p is 4, R¹ is hydrogen and R² is n-butyl, E′ is NH and (R^{c})_{q} is in the 4-position and corresponds in each case to a row of Table B.

Table 238

Compounds of the formula I.6 wherein X is fluorine, p is 4, R¹ is hydrogen and R² is i-butyl, E′ is NH and (R^{c})_{q} is in the 4-position and corresponds in each case to a row of Table B.

Table 239

Compounds of the formula I.6 wherein X is fluorine, p is 4, R¹ is hydrogen and R² is tert-butyl, E′ is NH and (R^{c})_{q} is in the 4-position and corresponds in each case to a row of Table B.

Table 240

Compounds of the formula I.6 wherein X is fluorine, p is 4, R¹ is hydrogen and R² is phenyl, E′ is NH and (R^{c})_{q} is in the 4-position and corresponds in each case to a row of Table B.

Table 241

Compounds of the formula I.6 wherein X is hydrogen, p is 2, R¹ and R² are hydrogen, E′ is NH and (R^{c})_{q} is in the 5-position and corresponds in each case to a row of Table B.

Table 242

Compounds of the formula I.6 wherein X is hydrogen, p is 2, R¹ is hydrogen and R² is methyl, E′ is NH and (R^{c})_{q} is in the 5-position and corresponds in each case to a row of Table B.

Table 243

Compounds of the formula I.6 wherein X is hydrogen, p is 2, R¹ is hydrogen and R² is ethyl, E′ is NH and (R^{c})_{q} is in the 5-position and corresponds in each case to a row of Table B.

Table 244

Compounds of the formula I.6 wherein X is hydrogen, p is 2, R¹ is hydrogen and R² is i-propyl, E′ is NH and (R^{c})_{q} is in the 5-position and corresponds in each case to a row of Table B.

Table 245

Compounds of the formula I.6 wherein X is hydrogen, p is 2, R¹ is hydrogen and R² is n-propyl, E′ is NH and (R^{c})_{q} is in the 5-position and corresponds in each case to a row of Table B.

Table 246

Compounds of the formula I.6 wherein X is hydrogen, p is 2, R¹ is hydrogen and R² is cyclo-propyl, E′ is NH and (R^{c})_{q} is in the 5-position and corresponds in each case to a row of Table B.

Table 247

Compounds of the formula I.6 wherein X is hydrogen, p is 2, R¹ is hydrogen and R² is n-butyl, E′ is NH and (R^{c})_{q} is in the 5-position and corresponds in each case to a row of Table B.

Table 248

Compounds of the formula I.6 wherein X is hydrogen, p is 2, R¹ is hydrogen and R² is i-butyl, E′ is NH and (R^{c})_{q} is in the 5-position and corresponds in each case to a row of Table B.

Table 249

Compounds of the formula I.6 wherein X is hydrogen, p is 2, R¹ is hydrogen and R² is tert-butyl, E′ is NH and (R^{c})_{q} is in the 5-position and corresponds in each case to a row of Table B.

Table 250

Compounds of the formula I.6 wherein X is hydrogen, p is 2, R¹ is hydrogen and R² is phenyl, E′ is NH and (R^{c})_{q} is in the 5-position and corresponds in each case to a row of Table B.

Table 251

Compounds of the formula I.6 wherein X is hydrogen, p is 4, R¹ and R² are hydrogen, E′ is NH and (R^{c})_{q} is in the 5-position and corresponds in each case to a row of Table B.

Table 252

Compounds of the formula I.6 wherein X is hydrogen, p is 4, R¹ is hydrogen and R² is methyl, E′ is NH and (R^{c})_{q} is in the 5-position and corresponds in each case to a row of Table B.

Table 253

Compounds of the formula I.6 wherein X is hydrogen, p is 4, R¹ is hydrogen and R² is ethyl, E′ is NH and (R^{c})_{q} is in the 5-position and corresponds in each case to a row of Table B.

Table 254

Compounds of the formula I.6 wherein X is hydrogen, p is 4, R¹ is hydrogen and R² is i-propyl, E′ is NH and (R^{c})_{q} is in the 5-position and corresponds in each case to a row of Table B.

Table 255

Compounds of the formula I.6 wherein X is hydrogen, p is 4, R¹ is hydrogen and R² is n-propyl, E′ is NH and (R^{c})_{q} is in the 5-position and corresponds in each case to a row of Table B.

Table 256

Compounds of the formula I.6 wherein X is hydrogen, p is 4, R¹ is hydrogen and R² is cyclo-propyl, E′ is NH and (R^{c})_{q} is in the 5-position and corresponds in each case to a row of Table B.

Table 257

Compounds of the formula I.6 wherein X is hydrogen, p is 4, R¹ is hydrogen and R² is n-butyl, E′ is NH and (R^{c})_{q} is in the 5-position and corresponds in each case to a row of Table B.

Table 258

Compounds of the formula I.6 wherein X is hydrogen, p is 4, R¹ is hydrogen and R² is i-butyl, E′ is NH and (R^{c})_{q} is in the 5-position and corresponds in each case to a row of Table B.

Table 259

Compounds of the formula I.6 wherein X is hydrogen, p is 4, R¹ is hydrogen and R² is tert-butyl, E′ is NH and (R^{c})_{q} is in the 5-position and corresponds in each case to a row of Table B.

Table 260

Compounds of the formula I.6 wherein X is hydrogen, p is 4, R¹ is hydrogen and R² is phenyl, E′ is NH and (R^{c})_{q} is in the 5-position and corresponds in each case to a row of Table B.

Table 261

Compounds of the formula I.6 wherein X is fluorine, p is 2, R¹ and R² are hydrogen, E′ is NH and (R^{c})_{q} is in the 5-position and corresponds in each case to a row of Table B.

Table 262

Compounds of the formula I.6 wherein X is fluorine, p is 2, R¹ is hydrogen and R² is methyl, E′ is NH and (R^{c})_{q} is in the 5-position and corresponds in each case to a row of Table B.

Table 263

Compounds of the formula I.6 wherein X is fluorine, p is 2, R¹ is hydrogen and R² is ethyl, E′ is NH and (R^{c})_{q} is in the 5-position and corresponds in each case to a row of Table B.

Table 264

Compounds of the formula I.6 wherein X is fluorine, p is 2, R¹ is hydrogen and R² is i-propyl, E′ is NH and (R^{c})_{q} is in the 5-position and corresponds in each case to a row of Table B.

Table 265

Compounds of the formula I.6 wherein X is fluorine, p is 2, R¹ is hydrogen and R² is n-propyl, E′ is NH and (R^{c})_{q} is in the 5-position and corresponds in each case to a row of Table B.

Table 266

Compounds of the formula I.6 wherein X is fluorine, p is 2, R¹ is hydrogen and R² is cyclo-propyl, E′ is NH and (R^{c})_{q} is in the 5-position and corresponds in each case to a row of Table B.

Table 267

Compounds of the formula I.6 wherein X is fluorine, p is 2, R¹ is hydrogen and R² is n-butyl, E′ is NH and (R^{c})_{q} is in the 5-position and corresponds in each case to a row of Table B.

Table 268

Compounds of the formula I.6 wherein X is fluorine, p is 2, R¹ is hydrogen and R² is i-butyl, E′ is NH and (R^{c})_{q} is in the 5-position and corresponds in each case to a row of Table B.

Table 269

Compounds of the formula I.6 wherein X is fluorine, p is 2, R¹ is hydrogen and R² is tert-butyl, E′ is NH and (R^{c})_{q} is in the 5-position and corresponds in each case to a row of Table B.

Table 270

Compounds of the formula I.6 wherein X is fluorine, p is 2, R¹ is hydrogen and R² is phenyl, E′ is NH and (R^{c})_{q} is in the 5-position and corresponds in each case to a row of Table B.

Table 271

Compounds of the formula I.6 wherein X is fluorine, p is 4, R¹ and R² are hydrogen, E′ is NH and (R^{c})_{q} is in the 5-position and corresponds in each case to a row of Table B.

Table 272

Compounds of the formula I.6 wherein X is fluorine, p is 4, R¹ is hydrogen and R² is methyl, E′ is NH and (R^{c})_{q} is in the 5-position and corresponds in each case to a row of Table B.

Table 273

Compounds of the formula I.6 wherein X is fluorine, p is 4, R¹ is hydrogen and R² is ethyl, E′ is NH and (R^{c})_{q} is in the 5-position and corresponds in each case to a row of Table B.

Table 274

Compounds of the formula I.6 wherein X is fluorine, p is 4, R¹ is hydrogen and R² is i-propyl, E′ is NH and (R^{c})_{q} is in the 5-position and corresponds in each case to a row of Table B.

Table 275

Compounds of the formula I.6 wherein X is fluorine, p is 4, R¹ is hydrogen and R² is n-propyl, E′ is NH and (R^{c})_{q} is in the 5-position and corresponds in each case to a row of Table B.

Table 276

Compounds of the formula I.6 wherein X is fluorine, p is 4, R¹ is hydrogen and R² is cyclo-propyl, E′ is NH and (R^{c})_{q} is in the 5-position and corresponds in each case to a row of Table B.

Table 277

Compounds of the formula I.6 wherein X is fluorine, p is 4, R¹ is hydrogen and R² is n-butyl, E′ is NH and R^{c} is in the 5-position and corresponds in each case to a row of Table B.

Table 278

Compounds of the formula I.6 wherein X is fluorine, p is 4, R¹ is hydrogen and R² is i-butyl, E′ is NH and (R^{c})_{q} is in the 5-position and corresponds in each case to a row of Table B.

Table 279

Compounds of the formula I.6 wherein X is fluorine, p is 4, R¹ is hydrogen and R² is tert-butyl, E′ is NH and (R^{c})_{q} is in the 5-position and corresponds in each case to a row of Table B.

Table 280

Compounds of the formula I.6 wherein X is fluorine, p is 4, R¹ is hydrogen and R² is phenyl, E′ is NH and (R^{c})_{q} is in the 5-position and corresponds in each case to a row of Table B.

TABLE B

| | |
|---|---|
| | (1.6) |
| 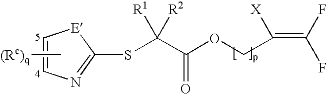 | |

| Nr. | (R^{c})_{q} |
|---|---|
| B-1 | — |
| B-2 | CH₃ |
| B-3 | CH₂CH₃ |
| B-4 | CH₂CH₂CH₃ |
| B-5 | CH (CH₃)₂ |
| B-6 | C (CH₃)₃ |
| B-7 | Cl |
| B-8 | Br |
| B-9 | CH₂OCH₃ |
| B-10 | COOCH₃ |
| B-11 | C₆H₅ |
| B-12 | 2-F-C₆H₄ |
| B-13 | 3-F-C₆H₄ |
| B-14 | 4-F-C₆H₄ |
| B-15 | 2-Cl-C₆H₄ |
| B-16 | 3-Cl-C₆H₄ |
| B-17 | 4-C₆H₄ |
| B-18 | 2-CH₃-C₆H₄ |
| B-19 | 3 -CH₃-C₆H₄ |
| B-20 | 4-CH₃-C₆H₄ |
| B-21 | 2,3-(CH₃)₂-C₆H₃ |
| B-22 | 2,4-(CH₃)₂-C₆H₃ |
| B-23 | 2,5-(CH₃)₂-C₆H₃ |
| B-24 | 3,4-(CH₃)₂-C₆H₃ |
| B-25 | 3,5-(CH₃)₂-C₆H₃ |
| B-26 | 2,3-Cl₂-C₆H₃ |
| B-27 | 2,4-Cl₂-C₆H₃ |
| B-28 | 2,5-Cl₂-C₆H₃ |
| B-29 | 3,4-Cl₂-C₆H₃ |
| B-30 | 3,5-Cl₂-C₆H₃ |
| B-31 | 2,3-F₂-C₆H₃ |
| B-32 | 2,4-F₂-C₆H₃ |
| B-33 | 2,5-F₂-C₆H₃ |
| B-34 | 3,4-F₂-C₆H₃ |
| B-35 | 3,5-F₂-C₆H₃ |
| B-36 | 2-F-3-Cl-C₆H₃ |
| B-37 | 2-F-4-Cl-C₆H₃ |
| B-38 | 2-F-5-Cl-C₆H₃ |
| B-39 | 3-F-4-Cl-C₆H₃ |
| B-40 | 3-F-5-Cl-C₆H₃ |
| B-41 | 2-Cl-3-F-C₆H₃ |
| B-42 | 2-Cl-4-F-C₆H₃ |
| B-43 | 2-Cl-5-F-C₆H₃ |
| B-44 | 3-Cl-4-F-C₆H₃ |
| B-45 | 3-Cl-5-F-C₆H₃ |
| B-46 | 2-F-3-CH₃-C₆H₃ |
| B-47 | 2-F-4-CH₃-C₆H₃ |
| B-48 | 2-F-5-CH₃-C₆H₃ |
| B-49 | 3-F-4-CH₃-C₆H₃ |
| B-50 | 3-F-5-CH₃-C₆H₃ |
| B-51 | 2-CH₃-3-F-C₆H₃ |
| B-52 | 2-CH₃-4-F-C₆H₃ |
| B-53 | 2-CH₃-5-F-C₆H₃ |
| B-54 | 3-CH₃-4-F-C₆H₃ |
| B-55 | 3-CH₃-5-F-C₆H₃ |
| B-56 | 2 -Cl-3-CH₃-C₆H₃ |
| B-57 | 2-Cl-4-CH₃-C₆H₃ |
| B-58 | 2-Cl-5-CH₃-C₆H₃ |
| B-59 | 3-Cl-4-CH₃-C₆H₃ |
| B-60 | 3-Cl-S -CH_{3-C}₆H₃ |
| B-61 | 2-CH₃-3-Cl-C₆H₃ |
| B-62 | 2-CH₃-4-Cl-C₆H₃ |
| B-63 | 2-CH₃-5-Cl-C₆H₃ |
| B-64 | 3 -CH₃-4-Cl-C₆H₃ |
| B-65 | 3-CH₃-5-Cl-C₆H₃ |
| B-66 | 2,3,4-(CH₃)₃-C₆H₂ |
| B-67 | 2,3,5-(CH₃)₃-C₆H₂ |
| B-68 | 2,3,6-(CH₃)₃-C₆H₂ |
| B-69 | 2,4,5-(CH₃)₃-C₆H₂ |
| B-70 | 2,4,6-(CH₃)₃-C₆H₂ |
| B-71 | 3,4,5-(CH₃)₃-C₆H₂ |
| B-72 | 3,4,6-(CH₃)₃-C₆H₂ |
| B-73 | 2,3,4-F₃-C6H₂ |
| B-74 | 2,3,5-F₃-C₆H₂ |
| B-75 | 2,3,6-F₃-C₆H₂ |
| B-76 | 2,4,5-F₃-C₆H₂ |
| B-77 | 2,4,6-F₃-C₆H₂ |
| B-78 | 3,4,5-F₃-C₆H₂ |
| B-79 | 3,4,6-F₃-C₆H₂ |
| B-80 | 2,3,4-Cl₃-C₆H₂ |
| B-81 | 2,3,5-Cl₃-C₆H₂ |
| B-82 | 2,3,6-Cl₃-C₆H₂ |
| B-83 | 2,4,5-Cl₃-C₆H₂ |
| B-84 | 2,4,6-Cl₃-C₆H₂ |
| B-85 | 3,4,5-Cl₃-C₆H₂ |
| B-86 | 3,4,6-Cl₃-C₆H₂ |
| B-87 | 2-Cl-3,4-(CH₃)₂-C₆H₂ |
| B-88 | 3-Cl-2,4-(CH₃)₂-C₆H₂ |
| B-89 | 4-Cl-2,3-(CH₃)₂-C₆H₂ |
| B-90 | 2-Cl-3,5-(CH₃)₂-C₆H₂ |
| B-91 | 3-Cl-2,5-(CH₃)₂-C₆H₂ |
| B-92 | 5-Cl-2,3-(CH₃)₂-C₆H₂ |
| B-93 | 2-Cl-3,6-(CH₃)₂-C₆H₂ |
| B-94 | 3-Cl-2,6-(CH₃)₂-C₆H₂ |
| B-95 | 6-Cl-2,3-(CH₃)₂-C₆H₂ |
| B-96 | 2-Cl-4,5-(CH₃)₂-C₆H₂ |
| B-97 | 4-Cl-2,5-(CH₃)₂-C₆H₂ |
| B-98 | 5-Cl-2,4-(CH₃)₂-C₆H₂ |
| B-99 | 2-Cl-4,6-(CH₃)₂-C₆H₂ |
| B-100 | 4-Cl-2,6-(CH₃)₂-C₆H₂ |
| B-101 | 6-Cl-2,4-(CH₃)₂-C₆H₂ |
| B-102 | 3-Cl-4,5-(CH₃)₂-C₆H₂ |
| B-103 | 4-Cl-3,5-(CH₃)₂-C₆H₂ |
| B-104 | 5-Cl-3,4-(CH₃)₂-C₆H₂ |
| B-105 | 3-Cl-4,6-(CH₃)₂-C₆H₂ |
| B-106 | 4-Cl-3,6-(CH₃)₂-C₆H₂ |
| B-107 | 6-Cl-3,4-(CH₃)₂-C₆H₂ |
| B-108 | 3-Cl-5,6-(CH₃)₂-C₆H₂ |
| B-109 | 5-Cl-3,6-(CH₃)₂-C₆H₂ |
| B-110 | 6-Cl-3,5-(CH₃)₂-C₆H₂ |
| B-111 | 2-F-3,4-(CH₃)₂-C₆H₂ |
| B-112 | 3-F-2,4-(CH₃)₂-C₆H₂ |
| B-113 | 4-F-2,3-(CH₃)₂-C₆H₂ |
| B-114 | 2-F-3,5-(CH₃)₂-C₆H₂ |
| B-115 | 3-F-2,5-(CH₃)₂-C₆H₂ |
| B-116 | 5-F-2,3-(CH₃)₂-C₆H₂ |
| B-117 | 2-F-3,6-(CH₃)₂-C₆H₂ |
| B-118 | 3-F-2,6-(CH₃)₂-C₆H₂ |
| B-119 | 6-F-2,3-(CH₃)₂-C₆H₂ |
| B-120 | 2-F-4,5-(CH₃)₂-C₆H₂ |
| B-121 | 4-F-2,5-(CH₃)₂-C₆H₂ |
| B-122 | 5-F-2,4-(CH₃)₂-C₆H₂ |
| B-123 | 2-F-4,6-(CH₃)₂-C₆H₂ |
| B-124 | 4-F-2,6-(CH₃)₂-C₆H₂ |
| B-125 | 6-F-2,4-(CH₃)₂-C₆H₂ |
| B-126 | 3-F-4,5-(CH₃)₂-C₆H₂ |
| B-127 | 4-F-3,5-(CH₃)₂-C₆H₂ |
| B-128 | 5-F-3,4-(CH₃)₂-C₆H₂ |
| B-129 | 3-F-4,6-(CH₃)₂-C₆H₂ |
| B-130 | 4-F-3,6-(CH₃)₂-C₆H₂ |
| B-131 | 6-F-3,4-(CH₃)₂-C₆H₂ |
| B-132 | 3-F-5,6-(CH₃)₂-C₆H₂ |
| B-133 | 5-F-3,6-(CH₃)₂-C₆H₂ |
| B-134 | 6-F-3,5-(CH₃)₂-C₆H₂ |
| B-135 | 2-Cl-3,4-F₂-C₆H₂ |
| B-136 | 3-Cl-2,4-F₂-C₆H₂ |
| B-137 | 4-Cl-2,3-F₂-C₆H₂ |
| B-138 | 2-Cl-3,5-F₂-C₆H₂ |
| B-139 | 3-Cl-2,5-F₂-C₆H₂ |
| B-140 | 5-Cl-2,3-F₂-C₆H₂ |
| B-141 | 2-Cl-3,6-F₂-C₆H₂ |
| B-142 | 3-Cl-2,6-F₂-C₆H₂ |
| B-143 | 6-Cl-2,3-F₂-C₆H₂ |
| B-144 | 2-Cl-4,5-F₂-C₆H₂ |
| B-145 | 4-Cl-2,5-F₂-C₆H₂ |
| B-146 | 5-Cl-2,4-F₂-C₆H₂ |
| B-147 | 2-Cl-4,6-F₂-C₆H₂ |
| B-148 | 4-Cl-2,6-F₂-C₆H₂ |
| B-149 | 6-Cl-2,4-F₂-C₆H₂ |
| B-150 | 3-Cl-4,5-F₂-C₆H₂ |
| B-151 | 4-Cl-3,5-F₂-C₆H₂ |
| B-152 | 5-Cl-3,4-F₂-C₆H₂ |
| B-153 | 3-Cl-4,6-F₂-C₆H₂ |
| B-154 | 4-Cl-3,6-F₂-C₆H₂ |
| B-155 | 6-Cl-3,4-F₂-C₆H₂ |
| B-156 | 3-Cl-5,6-F₂-C₆H₂ |
| B-157 | 5-Cl-3,6-F₂-C₆H₂ |
| B-158 | 6-Cl-3,5-F₂-C₆H₂ |
| B-159 | 2-F-3,4-Cl₂-C₆H₂ |
| B-160 | 3-F-2,4-Cl₂-C₆H₂ |
| B-161 | 4-F-2,3-Cl₂-C₆H₂ |
| B-162 | 2-F-3,5-Cl₂-C₆H₂ |
| B-163 | 3-F-2,5-Cl₂-C₆H₂ |
| B-164 | 5-F-2,3-Cl₂-C₆H₂ |
| B-165 | 2-F-3,6-Cl₂-C₆H₂ |
| B-166 | 3-F-2,6-Cl₂-C₆H₂ |
| B-167 | 6-F-2,3-Cl₂-C₆H₂ |
| B-168 | 2-F-4,5-Cl₂-C₆H₂ |
| B-169 | 4-F-2,5-Cl₂-C₆H₂ |
| B-170 | 5-F-2,4-Cl₂-C₆H₂ |
| B-171 | 2-F-4,6-Cl₂-C₆H₂ |
| B-172 | 4-F-2,6-Cl₂-C₆H₂ |
| B-173 | 6-F-2,4-Cl₂-C₆H₂ |
| B-174 | 3-F-4,5-Cl₂-C₆H₂ |
| B-175 | 4-F-3,5-Cl₂-C₆H₂ |
| B-176 | 5-F-3,4-Cl₂-C₆H₂ |
| B-177 | 3-F-4,6-Cl₂-C₆H₂ |
| B-178 | 4-F-3,6-Cl₂-C₆H₂ |
| B-179 | 6-F-3,4-Cl₂-C₆H₂ |
| B-180 | 3-F-5,6-Cl₂-C₆H₂ |
| B-181 | 5-F-3,6-Cl₂-C₆H₂ |
| B-182 | 6-F-3,5-Cl₂-C₆H₂ |
| B-183 | 2-CH₃-3,4-F₂-C₆H₂ |
| B-184 | 3-CH₃-2,4-F₂-C₆H₂ |
| B-185 | 4-CH₃-2,3-F₂-C₆H₂ |
| B-186 | 2-CH₃-3,5-F₂-C₆H₂ |
| B-187 | 3-CH₃-2,5-F₂-C₆H₂ |
| B-188 | 5-CH₃-2,3-F₂-C₆H₂ |
| B-189 | 2-CH₃-3,6-F₂-C₆H₂ |
| B-190 | 3-CH₃-2,6-F₂-C₆H₂ |
| B-191 | 6-CH₃-2,3-F₂-C₆H₂ |
| B-192 | 2-CH₃-4,5-F₂-C₆H₂ |
| B-193 | 4-CH₃-2,5-F₂-C₆H₂ |
| B-194 | 5-CH₃-2,4-F₂-C₆H₂ |
| B-195 | 2-CH₃-4,6-F₂-C₆H₂ |
| B-196 | 4-CH₃-2,6-F₂-C₆H₂ |
| B-197 | 6-CH₃-2,4-F₂-C₆H₂ |
| B-198 | 3-CH₃-4,5-F₂-C₆H₂ |
| B-199 | 4-CH₃-3,5-F₂-C₆H₂ |
| B-200 | 5-CH₃-3,4-F₂-C₆H₂ |
| B-201 | 3-CH₃-4,6-F₂-C₆H₂ |
| B-202 | 4-CH₃-3,6-F₂-C₆H₂ |
| B-203 | 6-CH₃-3,4-F₂-C₆H₂ |
| B-204 | 3-CH₃-5,6-F₂-C₆H₂ |
| B-205 | 5-CH₃-3,6-F₂-C₆H₂ |
| B-206 | 6-CH₃-3,5-F₂-C₆H₂ |
| B-207 | 2-CH₃-3,4-CH₂-C₆H₂ |
| B-208 | 3-CH₃-2,4-Cl₂-C₆H₂ |
| B-209 | 4-CH₃-2,3-Cl₂-C₆H₂ |
| B-210 | 2-CH₃-3,5-Cl₂-C₆H₂ |
| B-211 | 3-CH₃-2,5-Cl₂-C₆H₂ |
| B-212 | 5-CH₃-2,3-Cl₂-C₆H₂ |
| B-213 | 2-CH₃-3,6-Cl₂-C₆H₂ |
| B-214 | 3-CH₃-2,6-Cl₂-C₆H₂ |
| B-215 | 6-CH₃-2,3-Cl₂-C₆H₂ |
| B-216 | 2-CH₃-4,5-Cl₂-C₆H₂ |
| B-217 | 4-CH₃-2,5-Cl₂-C₆H₂ |
| B-218 | 5-CH₃-2,4-Cl₂-C₆H₂ |
| B-219 | 2-CH₃-4,6-Cl₂-C₆H₂ |
| B-220 | 4-CH₃-2,6-Cl₂-C₆H₂ |
| B-221 | 6-CH₃-2,4-Cl₂-C₆H₂ |
| B-222 | 3-CH₃-4,5-Cl₂-C₆H₂ |
| B-223 | 4-CH₃-3,5-Cl₂-C₆H₂ |
| B-224 | 5-CH₃-3,4-Cl₂-C₆H₂ |
| B-225 | 3-CH₃-4,6-Cl₂-C₆H₂ |
| B-226 | 4-CH₃-3,6-Cl₂-C₆H₂ |
| B-227 | 6-CH₃-3,4-Cl₂-C₆H₂ |
| B-228 | 3-CH₃-5,6-Cl₂-C₆H₂ |
| B-229 | 5-CH₃-3,6-CH₂-C₆H₂ |
| B-230 | 6-CH₃-3,5-CH₂-C₆H₂ |

Table 281

Compounds of the formula I.6 wherein X is hydrogen, p is 2, R¹ and R² are hydrogen, E′ is oxygen, q is 2 and (R^{c})_{q} for a compound corresponds in each case to a row of Table C.

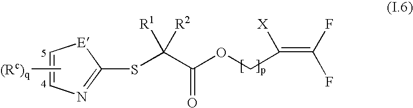

Table 282

Compounds of the formula I.6 wherein X is hydrogen, p is 2, R¹ is hydrogen and R² is methyl, E′ is oxygen, q is 2 and (R^{c})_{q} for a compound corresponds in each case to a row of Table C.

Table 283

Compounds of the formula I.6 wherein X is hydrogen, p is 2, R¹ is hydrogen and R² is ethyl, E′ is oxygen, q is 2 and (R^{c})_{q} for a compound corresponds in each case to a row of Table C.

Table 284

Compounds of the formula I.6 wherein X is-hydrogen, p is 2, R¹ is hydrogen and R² is i-propyl, E′ is oxygen, q is 2 and (R^{c})_{q} for a compound corresponds in each case to a row of Table C.

Table 285

Compounds of the formula I.6 wherein X is hydrogen, p is 2, R¹ is hydrogen and R² is n-propyl, E′ is oxygen, q is 2 and (R^{c})_{q} for a compound corresponds in each case to a row of Table C.

Table 286

Compounds of the formula I.6 wherein X is hydrogen, p is 2, R¹ is hydrogen and R² is cyclo-propyl, E′ is oxygen, q is 2 and (R^{c})_{q} for a compound corresponds in each case to a row of Table C.

Table 287

Compounds of the formula I.6 wherein X is hydrogen, p is 2, R¹ is hydrogen and R² is n-butyl, E′ is oxygen, q is 2 and (R^{c})_{q} for a compound corresponds in each case to a row of Table C.

Table 288

Compounds of the formula I.6 wherein X is hydrogen, p is 2, R¹ is hydrogen and R² is i-butyl, E′ is oxygen, q is 2 and (R^{c})_{q} for a compound corresponds in each case to a row of Table C.

Table 289

Compounds of the formula I.6 wherein X is hydrogen, p is 2, R¹ is hydrogen and R² is tert-butyl, E′ is oxygen, q is 2 and (R^{c})_{q} for a compound corresponds in each case to a row of Table C.

Table 290

Compounds of the formula I.6 wherein X is hydrogen, p is 2, R¹ is hydrogen and R² is phenyl, E′ is oxygen, q is 2 and (R^{c})_{q} for a compound corresponds in each case to a row of Table C.

Table 291

Compounds of the formula I.6 wherein X is hydrogen, p is 4, R¹ and R² are hydrogen, E′ is oxygen, q is 2 and (R^{c})_{q} for a compound corresponds in each case to a row of Table C.

Table 292

Compounds of the formula I.6 wherein X is hydrogen, p is 4, R¹ is hydrogen and R² is methyl, E′ is oxygen, q is 2 and (R^{c})_{q} for a compound corresponds in each case to a row of Table C.

Table 293

Compounds of the formula I.6 wherein X is hydrogen, p is 4, R¹ is hydrogen and R² is ethyl, E′ is oxygen, q is 2 and (R^{c})_{q} for a compound corresponds in each case to a row of Table C.

Table 294

Compounds of the formula I.6 wherein X is hydrogen, p is 4, R¹ is hydrogen and R² is i-propyl, E′ is oxygen, q is 2 and (R^{c})_{q} for a compound corresponds in each case to a row of Table C.

Table 295

Compounds of the formula I.6 wherein X is hydrogen, p is 4, R¹ is hydrogen and R² is n-propyl, E′ is oxygen, q is 2 and (R^{c})_{q} for a compound corresponds in each case to a row of Table C.

Table 296

Compounds of the formula I.6 wherein X is hydrogen, p is 4, R¹ is hydrogen and R² is cyclo-propyl, E′ is oxygen, q is 2 and (R^{c})_{q} for a compound corresponds in each case to a row of Table C.

Table 297

Compounds of the formula I.6 wherein X is hydrogen, p is 4, R¹ is hydrogen and R² is n-butyl, E′ is oxygen, q is 2 and (R^{c})_{q} for a compound corresponds in each case to a row of Table C.

Table 298

Compounds of the formula I.6 wherein X is hydrogen, p is 4, R¹ is hydrogen and R² is i-butyl, E′ is oxygen, q is 2 and (R^{c})_{q} for a compound corresponds in each case to a row of Table C.

Table 299

Compounds of the formula I.6 wherein X is hydrogen, p is 4, R¹ is hydrogen and R² is tert-butyl, E′ is oxygen, q is 2 and (R^{c})_{q} for a compound corresponds in each case to a row of Table C.

Table 300

Compounds of the formula I.6 wherein X is hydrogen, p is 4, R¹ is hydrogen and R² is phenyl, E′ is oxygen, q is 2 and (R^{c})_{q} for a compound corresponds in each case to a row of Table C.

Table 301

Compounds of the formula I.6 wherein X is fluorine, p is 2, R¹ and R² are hydrogen, E′ is oxygen, q is 2 and (R^{c})_{q} for a compound corresponds in each case to a row of Table C.

Table 302

Compounds of the formula I.6 wherein X is fluorine, p is 2, R¹ is hydrogen and R² is methyl, E′ is oxygen, q is 2 and (R^{c})_{q} for a compound corresponds in each case to a row of Table C.

Table 303

Compounds of the formula I.6 wherein X is fluorine, p is 2, R¹ is hydrogen and R² is ethyl, E′ is oxygen, q is 2 and (R^{c})_{q} for a compound corresponds in each case to a row of Table C.

Table 304

Compounds of the formula I.6 wherein X is fluorine, p is 2, R¹ is hydrogen and R² is i-propyl, E′ is oxygen, q is 2 and (R^{c})_{q} for a compound corresponds in each case to a row of Table C.

Table 305

Compounds of the formula I.6 wherein X is fluorine, p is 2, R¹ is hydrogen and R² is n-propyl, E′ is oxygen, q is 2 and (R^{c})_{q} for a compound corresponds in each case to a row of Table C.

Table 306

Compounds of the formula I.6 wherein X is fluorine, p is 2, R¹ is hydrogen and R² is cyclo-propyl, E′ is oxygen, q is 2 and (R^{c})_{q} for a compound corresponds in each case to a row of Table C.

Table 307

Compounds of the formula I.6 wherein X is fluorine, p is 2, R¹ is hydrogen and R² is n-butyl, E′ is oxygen, q is 2 and (R^{c})_{q} for a compound corresponds in each case to a row of Table C.

Table 308

Compounds of the formula I.6 wherein X is fluorine, p is 2, R¹ is hydrogen and R² is i-butyl, E′ is oxygen, q is 2 and (R^{c})_{q} for a compound corresponds in each case to a row of Table C.

Table 309

Compounds of the formula I.6 wherein X is fluorine, p is 2, R¹ is hydrogen and R² is tert-butyl, E′ is oxygen, q is 2 and (R^{c})_{q} for a compound corresponds in each case to a row of Table C.

Table 310

Compounds of the formula I.6 wherein X is fluorine, p is 2, R¹ is hydrogen and R² is phenyl, E′ is oxygen, q is 2 and (R^{c})_{q} for a compound corresponds in each case to a row of Table C.

Table 311

Compounds of the formula I.6 wherein X is fluorine, p is 4, R¹ and R² are hydrogen, E′ is oxygen, q is 2 and (R^{c})_{q} for a compound corresponds in each case to a row of Table C.

Table 312

Compounds of the formula I.6 wherein X is fluorine, p is 4, R¹ is hydrogen and R² is methyl, E′ is oxygen, q is 2 and (R^{c})_{q} for a compound corresponds in each case to a row of Table C.

Table 313

Compounds of the formula I.6 wherein X is fluorine, p is 4, R¹ is hydrogen and R² is ethyl, E′ is oxygen, q is 2 and (R^{c})_{q} for a compound corresponds in each case to a row of Table C.

Table 314

Compounds of the formula I.6 wherein X is fluorine, p is 4, R¹ is hydrogen and R² is i-propyl, E′ is oxygen, q is 2 and (R^{c})_{q} for a compound corresponds in each case to a row of Table C.

Table 315

Compounds of the formula I.6 wherein X is fluorine, p is 4, R¹ is hydrogen and R² is n-propyl, E′ is oxygen, q is 2 and (R^{c})_{q} for a compound corresponds in each case to a row of Table C.

Table 316

Compounds of the formula I.6 wherein X is fluorine, p is 4, R¹ is hydrogen and R² is cyclo-propyl, E′ is oxygen, q is 2 and (R^{c})_{q} for a compound corresponds in each case to a row of Table C.

Table 317

Compounds of the formula I.6 wherein X is fluorine, p is 4, R¹ is hydrogen and R² is n-butyl, E′ is oxygen, q is 2 and (R^{c})_{q} for a compound corresponds in each case to a row of Table C.

Table 318

Compounds of the formula I.6 wherein X is fluorine, p is 4, R¹ is hydrogen and R² is i-butyl, E′ is oxygen, q is 2 and (R^{c})_{q} for a compound corresponds in each case to a row of Table C.

Table 319

Compounds of the formula I.6 wherein X is fluorine, p is 4, R¹ is hydrogen and R² is tert-butyl, E′ is oxygen, q is 2 and (R^{c})_{q} for a compound corresponds in each case to a row of Table C.

Table 320

Compounds of the formula I.6 wherein X is fluorine, p is 4, R¹ is hydrogen and R² is phenyl, E′ is oxygen, q is 2 and (R^{c})_{q} for a compound corresponds in each case to a row of Table C.

Table 321

Compounds of the formula I.6 wherein X is hydrogen, p is 2, R¹ and R² are hydrogen, E′ is sulfur, q is 2 and (R^{c})_{q} for a compound corresponds in each case to a row of Table C.

Table 322

Compounds of the formula I.6 wherein X is hydrogen, p is 2, R¹ is hydrogen and R² is methyl, E′ is sulfur and (R^{c})_{q} for a compound corresponds in each case to a row of Table C.

Table 323

Compounds of the formula I.6 wherein X is hydrogen, p is 2, R¹ is hydrogen and R² is ethyl, E′ is sulfur, q is 2 and (R^{c})_{q} for a compound corresponds in each case to a row of Table C.

Table 324

Compounds of the formula I.6 wherein X is hydrogen, p is 2, R¹ is hydrogen and R² is i-propyl, E′ is sulfur, q is 2 and (R^{c})_{q} for a compound corresponds in each case to a row of Table C.

Table 325

Compounds of the formula I.6 wherein X is hydrogen, p is 2, R¹ is hydrogen and R² is n-propyl, E′ is sulfur, q is 2 and (R^{c})_{q} for a compound corresponds in each case to a row of Table C.

Table 326

Compounds of the formula I.6 wherein X is hydrogen, p is 2, R¹ is hydrogen and R² is cyclo-propyl, E′ is sulfur, q is 2 and (R^{c})_{q} for a compound corresponds in each case to a row of Table C.

Table 327

Compounds of the formula I.6 wherein X is hydrogen, p is 2, R¹ is hydrogen and R² is n-butyl, E′ is sulfur, q is 2 and (R^{c})_{q} for a compound corresponds in each case to a row of Table C.

Table 328

Compounds of the formula I.6 wherein X is hydrogen, p is 2, R¹ is hydrogen and R² is i-butyl, E′ is sulfur, q is 2 and (R^{c})_{q} for a compound corresponds in each case to a row of Table C.

Table 329

Compounds of the formula I.6 wherein X is hydrogen, p is 2, R¹ is hydrogen and R² is tert-butyl, E′ is sulfur, q is 2 and (R^{c})_{q} for a compound corresponds in each case to a row of Table C.

Table 330

Compounds of the formula I.6 wherein X is hydrogen, p is 2, R¹ is hydrogen and R² is phenyl, E′ is sulfur, q is 2 and (R^{c})_{q} for a compound corresponds in each case to a row of Table C.

Table 331

Compounds of the formula I.6 wherein X is hydrogen, p is 4, R¹ and R² are hydrogen, E′ is sulfur, q is 2 and (R^{c})_{q} for a compound corresponds in each case to a row of Table C.

Table 332

Compounds of the formula I.6 wherein X is hydrogen, p is 4, R¹ is hydrogen and R² is methyl, E′ is sulfur, q is 2 and (R^{c})_{q} for a compound corresponds in each case to a row of Table C.

Table 333

Compounds of the formula I.6 wherein X is hydrogen, p is 4, R¹ is hydrogen and R² is ethyl, E′ is sulfur, q is 2 and (R^{c})_{q} for a compound corresponds in each case to a row of Table C.

Table 334

Compounds of the formula I.6 wherein X is hydrogen, p is 4, R¹ is hydrogen and R² is i-propyl, E′ is sulfur, q is 2 and (R^{c})_{q} for a compound corresponds in each case to a row of Table C.

Table 335

Compounds of the formula I.6 wherein X is hydrogen, p is 4, R¹ is hydrogen and R² is n-propyl, E′ is sulfur, q is 2 and (R^{c})_{q} for a compound corresponds in each case to a row of Table C.

Table 336

Compounds of the formula I.6 wherein X is hydrogen, p is 4, R¹ is hydrogen and R² is cyclo-propyl, E′ is sulfur, q is 2 and (R^{c})_{q} for a compound corresponds in each case to a row of Table C.

Table 337

Compounds of the formula I.6 wherein X is hydrogen, p is 4, R¹ is hydrogen and R² is n-butyl, E′ is sulfur, q is 2 and (R^{c})_{q} for a compound corresponds in each case to a row of Table C.

Table 338

Compounds of the formula I.6 wherein X is hydrogen, p is 4, R¹ is hydrogen and R² is i-butyl, E′ is sulfur, q is 2 and (R^{c})_{q} for a compound corresponds in each case to a row of Table C.

Table 339

Compounds of the formula I.6 wherein X is hydrogen, p is 4, R¹ is hydrogen and R² is tert-butyl, E′ is sulfur, q is 2 and (R^{c})_{q} for a compound corresponds in each case to a row of Table C.

Table 340

Compounds of the formula I.6 wherein X is hydrogen, p is 4, R¹ is hydrogen and R² is phenyl, E′ is sulfur, q is 2 and (R^{c})_{q} for a compound corresponds in each case to a row of Table C.

Table 341

Compounds of the formula I.6 wherein X is fluorine, p is 2, R¹ and R² are hydrogen, E′ is sulfur, q is 2 and (R^{c})_{q} for a compound corresponds in each case to a row of Table C.

Table 342

Compounds of the formula I.6 wherein X is fluorine, p is 2, R¹ is hydrogen and R² is methyl, E′ is sulfur, q is 2 and (R^{c})_{q} for a compound corresponds in each case to a row of Table C.

Table 343

Compounds of the formula I.6 wherein X is fluorine, p is 2, R¹ is hydrogen and R² is ethyl, E′ is sulfur, q is 2 and (R^{c})_{q} for a compound corresponds in each case to a row of Table C.

Table 344

Compounds of the formula I.6 wherein X is fluorine, p is 2, R¹ is hydrogen and R² is i-propyl, E′ is sulfur, q is 2 and (R^{c})_{q} for a compound corresponds in each case to a row of Table C.

Table 345

Compounds of the formula I.6 wherein X is fluorine, p is 2, R¹ is hydrogen and R² is n-propyl, E′ is sulfur, q is 2 and (R^{c})_{q} for a compound corresponds in each case to a row of Table C.

Table 346

Compounds of the formula I.6 wherein X is fluorine, p is 2, R¹ is hydrogen and R² is cyclo-propyl, E′ is sulfur, q is 2 and (R^{c})_{q} for a compound corresponds in each case to a row of Table C.

Table 347

Compounds of the formula I.6 wherein X is fluorine, p is 2, R¹ is hydrogen and R² is n-butyl, E′ is sulfur, q is 2 and (R^{c})_{q} for a compound corresponds in each case to a row of Table C.

Table 348

Compounds of the formula I.6 wherein X is fluorine, p is 2, R¹ is hydrogen and R² is i-butyl, E′ is sulfur, q is 2 and (R^{c})_{q} for a compound corresponds in each case to a row of Table C.

Table 349

Compounds of the formula I.6 wherein X is fluorine, p is 2, R¹ is hydrogen and R² is tert-butyl, E′ is sulfur, q is 2 and (R^{c})_{q} for a compound corresponds in each case to a row of Table C.

Table 350

Compounds of the formula I.6 wherein X is fluorine, p is 2, R¹ is hydrogen and R² is phenyl, E′ is sulfur, q is 2 and (R^{c})_{q} for a compound corresponds in each case to a row of Table C.

Table 351

Compounds of the formula I.6 wherein X is fluorine, p is 4, R¹ and R² are hydrogen, E′ is sulfur, q is 2 and (R^{c})_{q} for a compound corresponds in each case to a row of Table C.

Table 352

Compounds of the formula I.6 wherein X is fluorine, p is 4, R¹ is hydrogen and R² is methyl, E′ is sulfur, q is 2 and (R^{c})_{q} for a compound corresponds in each case to a row of Table C.

Table 353

Compounds of the formula I.6 wherein X is fluorine, p is 4, R¹ is hydrogen and R² is ethyl, E′ is sulfur, q is 2 and (R^{c})_{q} for a compound corresponds in each case to a row of Table C.

Table 354

Compounds of the formula I.6 wherein X is fluorine, p is 4, R¹ is hydrogen and R² is i-propyl, E′ is sulfur, q is 2 and (R^{c})_{q} for a compound corresponds in each case to a row of Table C.

Table 355

Compounds of the formula I.6 wherein X is fluorine, p is 4, R¹ is hydrogen and R² is n-propyl, E′ is sulfur, q is 2 and (R^{c})_{q} for a compound corresponds in each case to a row of Table C.

Table 356

Compounds of the formula I.6 wherein X is fluorine, p is 4, R¹ is hydrogen and R² is cyclo-propyl, E′ is sulfur, q is 2 and (R^{c})_{q} for a compound corresponds in each case to a row of Table C.

Table 357

Compounds of the formula I.6 wherein X is fluorine, p is 4, R¹ is hydrogen and R² is n-butyl, E′ is sulfur, q is 2 and (R^{c})_{q} for a compound corresponds in each case to a row of Table C.

Table 358

Compounds of the formula I.6 wherein X is fluorine, p is 4, R¹ is hydrogen and R² is i-butyl, E′ is sulfur, q is 2 and (R^{c})_{q} for a compound corresponds in each case to a row of Table C.

Table 359

Compounds of the formula I.6 wherein X is fluorine, p is 4, R¹ is hydrogen and R² is tert-butyl, E′ is sulfur, q is 2 and (R^{c})_{q} for a compound corresponds in each case to a row of Table C.

Table 360

Compounds of the formula I.6 wherein X is fluorine, p is 4, R¹ is hydrogen and R² is phenyl, E′ is sulfur, q is 2 and (R^{c})_{q} for a compound corresponds in each case to a row of Table C.

Table 361

Compounds of the formula I.6 wherein X is hydrogen, p is 2, R¹ and R² are hydrogen, E′ is NH and (R^{c})_{q} for a compound corresponds in each case to a row of Table C.

Table 362

Compounds of the formula I.6 wherein X is hydrogen, p is 2, R¹ is hydrogen and R² is methyl, E′ is NH and (R^{c})_{q} for a compound corresponds in each case to a row of Table C.

Table 363

Compounds of the formula I.6 wherein X is hydrogen, p is 2, R¹ is hydrogen and R² is ethyl, E′ is NH and (R^{c})_{q} for a compound corresponds in each case to a row of Table C.

Table 364

Compounds of the formula I.6 wherein X is hydrogen, p is 2, R¹ is hydrogen and R² is i-propyl, E′ is NH and (R^{c})_{q} for a compound corresponds in each case to a row of Table C.

Table 365

Compounds of the formula I.6 wherein X is hydrogen, p is 2, R¹ is hydrogen and R² is n-propyl, E′ is NH and (R^{c})_{q} for a compound corresponds in each case to a row of Table C.

Table 366

Compounds of the formula I.6 wherein X is hydrogen, p is 2, R¹ is hydrogen and R² is cyclo-propyl, E′ is NH and (R^{c})_{q} for a compound corresponds in each case to a row of Table C.

Table 367

Compounds of the formula I.6 wherein X is hydrogen, p is 2, R¹ is hydrogen and R² is n-butyl, E′ is NH and (R^{c})_{q} for a compound corresponds in each case to a row of Table C.

Table 368

Compounds of the formula I.6 wherein X is hydrogen, p is 2, R¹ is hydrogen and R² is i-butyl, E′ is NH and (R^{c})_{q} for a compound corresponds in each case to a row of Table C.

Table 369

Compounds of the formula I.6 wherein X is hydrogen, p is 2, R¹ is hydrogen and R² is tert-butyl, E′ is NH and (R^{c})_{q} for a compound corresponds in each case to a row of Table C.

Table 370

Compounds of the formula I.6 wherein X is hydrogen, p is 2, R¹ is hydrogen and R² is phenyl, E′ is NH and (R^{c})_{q} for a compound corresponds in each case to a row of Table C.

Table 371

Compounds of the formula I.6 wherein X is hydrogen, p is 4, R¹ and R² are hydrogen, E′ is NH and (R^{c})_{q} for a compound corresponds in each case to a row of Table C.

Table 372

Compounds of the formula I.6 wherein X is hydrogen, p is 4, R¹ is hydrogen and R² is methyl, E′ is NH and (R^{c})_{q} for a compound corresponds in each case to a row of Table C.

Table 373

Compounds of the formula I.6 wherein X is hydrogen, p is 4, R¹ is hydrogen and R² is ethyl, E′ is NH and (R^{c})_{q} for a compound corresponds in each case to a row of Table C.

Table 374

Compounds of the formula I.6 wherein X is hydrogen, p is 4, R¹ is hydrogen and R² is i-propyl, E′ is NH and (R^{c})_{q} for a compound corresponds in each case to a row of Table C.

Table 375

Compounds of the formula I.6 wherein X is hydrogen, p is 4, R¹ is hydrogen and R² is n-propyl, E′ is NH and (R^{c})_{q} for a compound corresponds in each case to a row of Table C.

Table 376

Compounds of the formula I.6 wherein X is hydrogen, p is 4, R¹ is hydrogen and R² is cyclo-propyl, E′ is NH and (R^{c})_{q} for a compound corresponds in each case to a row of Table C.

Table 377

Compounds of the formula I.6 wherein X is hydrogen, p is 4, R¹ is hydrogen and R² is n-butyl, E′ is NH and (R^{c})_{q} for a compound corresponds in each case to a row of Table C.

Table 378

Compounds of the formula I.6 wherein X is hydrogen, p is 4, R¹ is hydrogen and R² is i-butyl, E′ is NH and (R^{c})_{q} for a compound corresponds in each case to a row of Table C.

Table 379

Compounds of the formula I.6 wherein X is hydrogen, p is 4, R¹ is hydrogen and R² is tert-butyl, E′ is NH and (R^{c})_{q} for a compound corresponds in each case to a row of Table C.

Table 380

Compounds of the formula I.6 wherein X is hydrogen, p is 4, R¹ is hydrogen and R² is phenyl, E′ is NH and (R^{c})_{q} for a compound corresponds in each case to a row of Table C.

Table 381

Compounds of the formula I.6 wherein X is fluorine, p is 2, R¹ and R² are hydrogen, E′ is NH and (R^{c})_{q} for a compound corresponds in each case to a row of Table C.

Table 382

Compounds of the formula I.6 wherein X is fluorine, p is 2, R¹ is hydrogen and R² is methyl, E′ is NH and (R^{c})_{q} for a compound corresponds in each case to a row of Table C.

Table 383

Compounds of the formula I.6 wherein X is fluorine, p is 2, R¹ is hydrogen and R² is ethyl, E′ is NH and (R^{c})_{q} for a compound corresponds in each case to a row of Table C.

Table 384

Compounds of the formula I.6 wherein X is fluorine, p is 2, R¹ is hydrogen and R² is i-propyl, E′ is NH and (R^{c})_{q} for a compound corresponds in each case to a row of Table C.

Table 385

Compounds of the formula I.6 wherein X is fluorine, p is 2, R¹ is hydrogen and R² is n-propyl, E′ is NH and (R^{c})_{q} for a compound corresponds in each case to a row of Table C.

Table 386

Compounds of the formula I.6 wherein X is fluorine, p is 2, R¹ is hydrogen and R² is cyclo-propyl, E′ is NH and (R^{c})_{q} for a compound corresponds in each case to a row of Table C.

Table 387

Compounds of the formula I.6 wherein X is fluorine, p is 2, R¹ is hydrogen and R² is n-butyl, E′ is NH and (R^{c})_{q} for a compound corresponds in each case to a row of Table C.

Table 388

Compounds of the formula I.6 wherein X is fluorine, p is 2, R¹ is hydrogen and R² is i-butyl, E′ is NH and (R^{c})_{q} for a compound corresponds in each case to a row of Table C.

Table 389

Compounds of the formula I.6 wherein X is fluorine, p is 2, R¹ is hydrogen and R² is tert-butyl, E′ is NH and (R^{c})_{q} for a compound corresponds in each case to a row of Table C.

Table 390

Compounds of the formula I.6 wherein X is fluorine, p is 2, R¹ is hydrogen and R² is phenyl, E′ is NH and (R^{c})_{q} for a compound corresponds in each case to a row of Table C.

Table 391

Compounds of the formula I.6 wherein X is fluorine, p is 4, R¹ and R² are hydrogen, E′ is NH and (R^{c})_{q} for a compound corresponds in each case to a row of Table C.

Table 392

Compounds of the formula I.6 wherein X is fluorine, p is 4, R¹ is hydrogen and R² is methyl, E′ is NH and (R^{c})_{q} for a compound corresponds in each case to a row of Table C.

Table 393

Compounds of the formula I.6 wherein X is fluorine, p is 4, R¹ is hydrogen and R² is ethyl, E′ is NH and (R^{c})_{q} for a compound corresponds in each case to a row of Table C.

Table 394

Compounds of the formula I.6 wherein X is fluorine, p is 4, R¹ is hydrogen and R² is i-propyl, E′ is NH and (R^{c})_{q} for a compound corresponds in each case to a row of Table C.

Table 395

Compounds of the formula I.6 wherein X is fluorine, p is 4, R¹ is hydrogen and R² is n-propyl, E′ is NH and (R^{c})_{q} for a compound corresponds in each case to a row of Table C.

Table 396

Compounds of the formula I.6 wherein X is fluorine, p is 4, R¹ is hydrogen and R² is cyclo-propyl, E′ is NH and (R^{c})_{q} for a compound corresponds in each case to a row of Table C.

Table 397

Compounds of the formula I.6 wherein X is fluorine, p is 4, R¹ is hydrogen and R² is n-butyl, E′ is NH and (R^{c})_{q} for a compound corresponds in each case to a row of Table C.

Table 398

Compounds of the formula I.6 wherein X is fluorine, p is 4, R¹ is hydrogen and R² is i-butyl, E′ is NH and (R^{c})_{q} for a compound corresponds in each case to a row of Table C.

Table 399

Compounds of the formula I.6 wherein X is fluorine, p is 4, R¹ is hydrogen and R² is tert-butyl, E′ is NH and (R^{c})_{q} for a compound corresponds in each case to a row of Table C.

Table 400

Compounds of the formula I.6 wherein X is fluorine, p is 4, R¹ is hydrogen and R² is phenyl, E′ is NH and (R^{c})_{q} for a compound corresponds in each case to a row of Table C.

TABLE C

| | |
|---|---|
| | (I.6) |
| 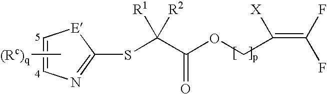 | |

| Nr. | R^{c} (4-Position) | R^{c} (5-Position) |
|---|---|---|
| C-1 | CH₃ | CH₃ |
| C-2 | CH₂CH₃ | CH₃ |
| C-3 | CH₂CH₂CH₃ | CH₃ |
| C-4 | CH(CH₃)₂ | CH₃ |
| C-5 | C(CH₃)₃ | CH₃ |
| C-6 | Cl | CH₃ |
| C-7 | Br | CH₃ |
| C-8 | CH₂OCH₃ | CH₃ |
| C-9 | COOCH₃ | CH₃ |
| C-10 | C₆H₅ | CH₃ |
| C-11 | 2-F-C₆H₄ | CH₃ |
| C-12 | 3-F-C₆H₄ | CH₃ |
| C-13 | 4-F-C₆H₄ | CH₃ |
| C-14 | 2-Cl-C₆H₄ | CH₃ |
| C-15 | 3-Cl-C₆H₄ | CH₃ |
| C-16 | 4-Cl-C₆H₄ | CH₃ |
| C-17 | 2-CH₃-C₆H₄ | CH₃ |
| C-18 | 3-CH₃-C₆H₄ | CH₃ |
| C-19 | 4-CH₃-C₆H₄ | CH₃ |
| C-20 | CH₃ | CH₂CH₃ |
| C-21 | CH₂CH₃ | CH₂CH₃ |
| C-22 | CH₂CH₂CH₃ | CH₂CH₃ |
| C-23 | CH(CH₃)₂ | CH₂CH₃ |
| C-24 | C(CH₃)₃ | CH₂CH₃ |
| C-25 | Cl | CH₂CH₃ |
| C-26 | Br | CH₂CH₃ |
| C-27 | CH₂0CH₃ | CH₂CH₃ |
| C-28 | COOCH₃ | CH₂CH₃ |
| C-29 | C₆H₅ | CH₂CH₃ |
| C-30 | 2-F-C₆H₄ | CH₂CH₃ |
| C-31 | 3-F-C₆H₄ | CH₂CH₃ |
| C-32 | 4-F-C₆H₄ | CH₂CH₃ |
| C-33 | 2-Cl-C₆H₄ | CH₂CH₃ |
| C-34 | 3-Cl-C₆H₄ | CH₂CH₃ |
| C-35 | 4-Cl-C₆H₄ | 0H2CH₃ |
| C-36 | 2-CH₃-C₆H₄ | CH₂CH₃ |
| C-37 | 3-CH₃-C₆H₄ | CH₂CH₃ |
| C-38 | 4-CH₃-C₆H₄ | CH₂CH₃ |
| C-39 | CH₃ | CH₂CH₂CH₃ |
| C-40 | CH₂CH₃ | CH₂CH₂CH₃ |
| C-41 | CH₂CH₂CH₃ | CH₂CH₂CH₃ |
| C-42 | CH(CH₃)₂ | CH₂CH₂CH₃ |
| C-43 | C(CH₃)₃ | CH₂CH₂CH₃ |
| C-44 | Cl | CH₂CH₂CH₃ |
| C-45 | Br | CH₂CH₂CH₃ |
| C-46 | CH₂OCH₃ | CH₂CH₂CH₃ |
| C-47 | COOCH₃ | CH₂CH₂CH₃ |
| C-48 | C₆H₅ | CH₂CH₂CH₃ |
| C-49 | 2-F-C₆H₄ | CH₂CH₂CH₃ |
| C-50 | 3-F-C₆H₄ | CH₂CH₂CH₃ |
| C-51 | 4-F-C₆H₄ | CH₂CH₂CH₃ |
| C-52 | 2-Cl-C₆H₄ | CH₂CH₂CH₃ |
| C-53 | 3-Cl-C₆H₄ | CH₂CH₂CH₃ |
| C-54 | 4-Cl-C₆H₄ | CH₂CH₂CH₃ |
| C-55 | 2-CH₃-C₆H₄ | |
| C-56 | 3-CH₃-C₆H₄ | |
| C-57 | 4-CH₃-C₆H₄ | |
| C-58 | CH₃ | |
| C-59 | CH₂CH₃ | |
| C-60 | CH₂CH₂CH₃ | |
| C-61 | CH(CH₃)₂ | CH(CH₃)₂ |
| C-62 | C(CH₃)₃ | CH(CH₃)₂ |
| C-63 | Cl | CH (CH₃)₂ |
| C-64 | Br | CH (CH₃)₂ |
| C-65 | CH₂OCH₃ | CH (CH₃)₂ |
| C-66 | COOCH₃ | CH (CH₃)₂ |
| C-67 | C₆H₅ | CH(CH₃)₂ |
| C-68 | 2-F-C₆H₄ | CH(CH₃)₂ |
| C-69 | 3-F-C₆H₄ | CH(CH₃)₂ |
| C-70 | 4-F-C₆H₄ | CH(CH₃)₂ |
| C-71 | 2-Cl-C₆H₄ | CH(CH₃)₂ |
| C-72 | 3-Cl-C₆H₄ | CH(CH₃)₂ |
| C-73 | 4-Cl-C₆H₄ | CH(CH₃)₂ |
| C-74 | 2-CH₃-C₆H₄ | CH(CH₃)₂ |
| C-75 | 3-CH₃-C₆H₄ | CH(CH₃)₂ |
| C-76 | 4-CH₃-C₆H₄ | CH(CH₃)₂ |
| C-77 | CH₃ | C(CH₃)₃ |
| C-78 | CH₂CH₃ | C(CH₃)₃ |
| C-79 | CH₂CH₂CH₃ | C(CH₃)₃ |
| C-80 | CH(CH₃)₂ | C(CH₃)₃ |
| C-81 | C(CH₃)₃ | C(CH₃)₃ |
| C-82 | Cl | C(Cl13)₃ |
| C-83 | Br | C(CH₃)₃ |
| C-84 | CH₂OCH₃ | C(CH₃)₃ |
| C-85 | COOCH₃ | C(CH₃)₃ |
| C-86 | C₆H₅ | C(CH₃)₃ |
| C-87 | 2-F-C₆H₄ | C(CH₃)₃ |
| C-88 | 3-F-C₆H₄ | C(CH₃)₃ |
| C-89 | 4-F-C₆H₄ | C(CH₃)₃ |
| C-90 | 2-Cl-C₆H₄ | C(CH₃)₃ |
| C-91 | 3-Cl-C₆H₄ | C(CH₃)₃ |
| C-92 | 4-Cl-C₆H₄ | C(CH₃)₃ |
| C-93 | 2-CH₃-C₆H₄ | C(CH₃)₃ |
| C-94 | 3-CH₃-C₆H₄ | C(CH₃)₃ |
| C-95 | 4-CH₃-C₆H₄ | C(CH₃)₃ |
| C-96 | CH₃ | Cl |
| C-97 | CH₂CH₃ | Cl |
| C-98 | CH₂CH₂CH₃ | Cl |
| C-99 | CH(CH₃)₂ | Cl |
| C-100 | C(CH₃)₃ | Cl |
| C-101 | Cl | Cl |
| C-102 | Br | Cl |
| C-103 | CH₂OCH₃ | Cl |
| C-104 | COOCH₃ | Cl |
| C-105 | C₆H₅ | Cl |
| C-106 | 2-F-C₆H₄ | Cl |
| C-107 | 3-F-C₆H₄ | Cl |
| C-108 | 4-F-C₆H₄ | Cl |
| C-109 | 2-Cl-C₆H₄ | Cl |
| C-110 | 3-Cl-C₆H₄ | Cl |
| C-111 | 4-Cl-C₆H₄ | Cl |
| C-112 | 2-CH₃-C₆H₄ | Cl |
| C-113 | 3-CH₃-C₆H₄ | Cl |
| C-114 | 4-CH₃-C₆H₄ | Cl |
| C-115 | CH₃ | Br |
| C-116 | CH₂CH₃ | Br |
| C-117 | CH₂CH₂CH₃ | Br |
| C-118 | CH(CH₃)₂ | Br |
| C-119 | C(CH₃)₃ | Br |
| C-120 | Cl | Br |
| C-121 | Br | Br |
| C-122 | CH₂OCH₃ | Br |
| C-123 | COOCH₃ | Br |
| C-124 | C₆H₅ | Br |
| C-125 | 2-F-C₆H₄ | Br |
| C-126 | 3-F-C₆H₄ | Br |
| C-127 | 4-F-C₆H₄ | Br |
| C-128 | 2-Cl-C₆H₄ | Br |
| C-129 | 3-Cl-C₆H₄ | Br |
| C-130 | 4-Cl-C₆H₄ | Br |
| C-131 | 2-CH₃-C₆H₄ | Br |
| C-132 | 3-CH₃-C₆H₄ | Br |
| C-133 | 4-CH₃-C₆H₄ | Br |
| C-134 | CH₃ | CH₂OCH₃ |
| C-135 | CH₂CH₃ | CH₂OCH₃ |
| C-136 | CH₂CH₂CH₃ | CH₂OCH₃ |
| C-137 | CH(CH₃)₂ | CH₂OCH₃ |
| C-138 | C(CH₃)₃ | CH₂OCH₃ |
| C-139 | Cl | CH₂OCH₃ |
| C-140 | Br | CH₂OCH₃ |
| C-141 | CH₂OCH₃ | CH₂OCH₃ |
| C-142 | COOCH₃ | CH₂OCH₃ |
| C-143 | C₆H₅ | CH₂OCH₃ |
| C-144 | 2-F-C₆H₄ | CH₂OCH₃ |
| C-145 | 3-F-C₆H₄ | CH₂OCH₃ |
| C-146 | 4-F-C₆H₄ | CH₂OCH₃ |
| C-147 | 2-Cl-C₆H₄ | CH₂OCH₃ |
| C-148 | 3-Cl-C₆H₄ | CH₂OCH₃ |
| C-149 | 4-Cl-C₆H₄ | CH₂OCH₃ |
| C-150 | 2-CH₃-C₆H₄ | CH₂OCH₃ |
| C-151 | 3-CH₃-C₆H₄ | CH₂OCH₃ |
| C-152 | 4-CH₃-C₆H₄ | CH₂OCH₃ |
| C-153 | CH₃ | COOCH₃ |
| C-154 | CH₂CH₃ | COOCH₃ |
| C-155 | CH₂CH₂CH₃ | COOCH₃ |
| C-156 | CH(CH₃)₂ | COOCH₃ |
| C-157 | C(CH₃)₃ | COOCH₃ |
| C-158 | Cl | COOCH₃ |
| C-159 | Br | COOCH₃ |
| C-160 | CH₂OCH₃ | COOCH₃ |
| C-161 | COOCH₃ | COOCH₃ |
| C-162 | C₆H₅ | COOCH₃ |
| C-163 | 2-F-C₆H₄ | COOCH₃ |
| C-164 | 3-F-C₆H₄ | C0OCH₃ |
| C-165 | 4-F-C₆H₄ | COOCH₃ |
| C-166 | 2-Cl-C₆H₄ | COOCH₃ |
| C-167 | 3-Cl-C₆H₄ | COOCH₃ |
| C-168 | 4-Cl-C₆H₄ | COOCH₃ |
| C-169 | 2-CH₃-C₆H₄ | COOCH₃ |
| C-170 | 3-CH₃-C₆H₄ | COOCH₃ |
| C-171 | 4-CH₃-C₆H₄ | COOCH₃ |
| C-172 | CH₃ | C₆H₅ |
| C-173 | CH₂CH₃ | C₆H₅ |
| C-174 | CH₂CH₂CH₃ | C₆H₅ |
| C-175 | CH(CH₃)₂ | C₆H₅ |
| C-176 | C(CH₃)₃ | C₆H₅ |
| C-177 | Cl | C₆H₅ |
| C-178 | Br | C₆H₅ |
| C-179 | CH₂OCH₃ | C₆H₅ |
| C-180 | COOCH₃ | C₆H₅ |
| C-181 | C₆H₅ | C₆H₅ |
| C-182 | 2-F-C₆H₄ | |
| C-183 | 3-F-C₆H₄ | C₆H₅ |
| C-184 | 4-F-C₆H₄ | C₆H₅ |
| C-185 | 2-Cl-C₆H₄ | C₆H₅ |
| C-186 | 3-Cl-C₆H₄ | C₆H₅ |
| C-187 | 4-Cl-C₆H₄ | C₆H₅ |
| C-188 | 2-CH₃-C₆H₄ | C₆H₅ |
| C-189 | 3-CH₃-C₆H₄ | C₆H₅ |
| C-190 | 4-CH₃-C₆H₄ | C₆H₅ |
| C-191 | CH₃ | 2-F-C₆H₄ |
| C-192 | CH₂CH₃ | 2-F-C₆H₄ |
| C-193 | CH₂CH₂CH₃ | 2-F-C₆H₄ |
| C-194 | CH(CH₃)₂ | 2-F-C₆H₄ |
| C-195 | C(CH₃)₃ | 2-F-C₆H₄ |
| C-196 | Cl | 2-F-C₆H₄ |
| C-197 | Br | 2-F-C₆H₄ |
| C-198 | CH₂OCH₃ | 2-F-C₆H₄ |
| C-199 | COOCH₃ | 2-F-C₆H₄ |
| C-200 | C₆H₅ | 2-F-C₆H₄ |
| C-201 | 2-F-C₆H₄ | 2-F-C₆H₄ |
| C-202 | 3-F-C₆H₄ | 2-F-C₆H₄ |
| C-203 | 4-F-C₆H₄ | 2-F-C₆H₄ |
| C-204 | 2-Cl-C₆H₄ | 2-F-C₆H₄ |
| C-205 | 3-Cl-C₆H₄ | 2-F-C₆H₄ |
| C-206 | 4-Cl-C₆H₄ | 2-F-C₆H₄ |
| C-207 | 2-CH₃-C₆H₄ | 2-F-C₆H₄ |
| C-208 | 3-CH₃-C₆H₄ | 2-F-C₆H₄ |
| C-209 | 4-CH₃-C₆H₄ | 2-F-C₆H₄ |
| C-210 | CH₃ | 3-F-C₆H₄ |
| C-211 | CH₂CH₃ | 3-F-C₆H₄ |
| C-212 | CH₂CH₂CH₃ | 3-F-C₆H₄ |
| C-213 | CH(CH₃)₂ | 3-F-C₆H₄ |
| C-214 | C(CH₃)₃ | 3-F-C₆H₄ |
| C-215 | Cl | 3-F-C₆H₄ |
| C-216 | Br | 3-F-C₆H₄ |
| C-217 | CH₂OCH₃ | 3-F-C₆H₄ |
| C-218 | COOCH₃ | 3-F-C₆H₄ |
| C-219 | C₆H₅ | 3-F-C₆H₄ |
| C-220 | 2-F-C₆H₄ | 3-F-C₆H₄ |
| C-221 | 3-F-C₆H₄ | 3-F-C₆H₄ |
| C-222 | 4-F-C₆H₄ | 3-F-C₆H₄ |
| C-223 | 2-Cl-C₆H₄ | 3-F-C₆H₄ |
| C-224 | 3-Cl-C₆H₄ | 3-F-C₆H₄ |
| C-225 | 4-Cl-C₆H₄ | 3-F-C₆H₄ |
| C-226 | 2-CH₃-C₆H₄ | 3-F-C₆H₄ |
| C-227 | 3-CH₃-C₆H₄ | 3-F-C₆H₄ |
| C-228 | 4-CH₃-C₆H₄ | 3-F-C₆H₄ |
| C-229 | CH₃ | 4-F-C₆H₄ |
| C-230 | CH₂CH₃ | 4-F-C₆H₄ |
| C-231 | CH₂CH₂CH₃ | 4-F-C₆H₄ |
| C-232 | CH(CH₃)₂ | 4-F-C₆H₄ |
| C-233 | C(CH₃)₃ | 4-F-C₆H₄ |
| C-234 | Cl | 4-F-C₆H₄ |
| C-235 | Br | 4-F-C₆H₄ |
| C-236 | CH₂OCH₃ | 4-F-C₆H₄ |
| C-237 | COOCH₃ | 4-F-C₆H₄ |
| C-238 | C₆H₅ | 4-F-C₆H₄ |
| C-239 | 2-F-C₆H₄ | 4-F-C₆H₄ |
| C-240 | 3-F-C₆H₄ | 4-F-C₆H₄ |
| C-241 | 4-F-C₆H₄ | 4-F-C₆H₄ |
| C-242 | 2-Cl-C₆H₄ | 4-F-C₆H₄ |
| C-243 | 3-Cl-C₆H₄ | 4-F-C₆H₄ |
| C-244 | 4-Cl-C₆H₄ | 4-F-C₆H₄ |
| C-245 | 2-CH₃-C₆H₄ | 4-F-C₆H₄ |
| C-246 | 3-CH₃-C₆H₄ | 4-F-C₆H₄ |
| C-247 | 4-CH₃-C₆H₄ | 4-F-C₆H₄ |
| C-248 | CH₃ | 2-Cl-C₆H₄ |
| C-249 | CH₂CH₃ | 2-Cl-C₆H₄ |
| C-250 | CH₂CH₂CH₃ | 2-Cl-C₆H₄ |
| C-251 | CH(CH₃)₂ | 2-Cl-C₆H₄ |
| C-252 | C(CH₃)₃ | 2-Cl-C₆H₄ |
| C-253 | Cl | 2-Cl-C₆H₄ |
| C-254 | Br | 2-Cl-C₆H₄ |
| C-255 | CH₂OCH₃ | 2-Cl-C₆H₄ |
| C-256 | COOCH₃ | 2-Cl-C₆H₄ |
| C-257 | C₆H₅ | 2-Cl-C₆H₄ |
| C-258 | 2-F-C₆H₄ | 2-Cl-C₆H₄ |
| C-259 | 3-F-C₆H₄ | 2-Cl-C₆H₄ |
| C-260 | 4-F-C₆H₄ | 2-Cl-C₆H₄ |
| C-261 | 2-Cl-C₆H₄ | 2-Cl-C₆H₄ |
| C-262 | 3-Cl-C₆H₄ | 2-Cl-C₆H₄ |
| C-263 | 4-Cl-C₆H₄ | 2-Cl-C₆H₄ |
| C-264 | 2-CH₃-C₆H₄ | 2-Cl-C₆H₄ |
| C-265 | 3-CH₃-C₆H₄ | 2-Cl-C₆H₄ |
| C-266 | 4-CH₃-C₆H₄ | 2-Cl-C₆H₄ |
| C-267 | CH₃ | 3-Cl-C₆H₄ |
| C-268 | CH₂CH₃ | 3-Cl-C₆H₄ |
| C-269 | CH₂CH₂CH₃ | 3-Cl-C₆H₄ |
| C-270 | CH(CH₃)₂ | 3-Cl-C₆H₄ |
| C-271 | C(CH₃)₃ | |
| C-272 | Cl | |
| C-273 | Br | 3-Cl-C₆H₄ |
| C-274 | CH₂OCH₃ | 3-Cl-C₆H₄ |
| C-275 | COOCH₃ | 3-Cl-C₆H₄ |
| C-276 | C₆H₅ | 3-Cl-C₆H₄ |
| C-277 | 2-F-C₆H₄ | 3-Cl-C₆H₄ |
| C-278 | 3-F-C₆H₄ | 3-Cl-C₆H₄ |
| C-279 | 4-F-C₆H₄ | 3-Cl-C₆H₄ |
| C-280 | 2-Cl-C₆H₄ | 3-Cl-C₆H₄ |
| C-281 | 3-Cl-C₆H₄ | 3-Cl-C₆H₄ |
| C-282 | 4-Cl-C₆H₄ | 3-Cl-C₆H₄ |
| C-283 | 2-CH₃-C₆H₄ | 3-Cl-C₆H₄ |
| C-284 | 3-CH₃-C₆H₄ | 3-Cl-C₆H₄ |
| C-285 | 4-CH₃-C₆H₄ | 3-Cl-C₅H₄ |
| C-286 | CH₃ | 4-Cl-C₆H₄ |
| C-287 | CH₂CH₃ | 4-Cl-C₆H₄ |
| C-288 | CH₂CH₂CH₃ | 4-Cl-C₆H₄ |
| C-289 | CH(CH₃)₂ | 4-Cl-C₆H₄ |
| C-290 | C(CH₃)₃ | 4-Cl-C₆H₄ |
| C-291 | Cl | 4-Cl-C₆H₄ |
| C-292 | Br | 4-Cl-C₆H₄ |
| C-293 | CH₂OCH₃ | 4-Cl-C₆H₄ |
| C-294 | COOCH₃ | 4-Cl-C₆H₄ |
| C-295 | C₆H₅ | 4-Cl-C₆H₄ |
| C-296 | 2-F-C₆H₄ | 4-Cl-C₆H₄ |
| C-297 | 3-F-C₆H₄ | 4-Cl-C₆H₄ |
| C-298 | 4-F-C₆H₄ | 4-Cl-C₆H₄ |
| C-299 | 2-Cl-C₆H₄ | 4-Cl-C₆H₄ |
| C-300 | 3-Cl-C₆H₄ | 4-Cl-C₆H₄ |
| C-301 | 4-Cl-C₆H₄ | 4-Cl-C₆H₄ |
| C-302 | 2-CH₃-C₆H₄ | 4-Cl-C₆H₄ |
| C-303 | 3-CH₃-C₆H₄ | 4-Cl-C₆H₄ |
| C-304 | 4-CH₃-C₆H₄ | 4-Cl-C₆H₄ |
| C-305 | CH₃ | |
| C-306 | CH₂CH₃ | 2-CH₃-C₆H₄ |
| C-307 | CH₂CH₂CH₃ | 2-CH₃-C₆H₄ |
| C-308 | CH(CH₃)₂ | 2-CH₃-C₆H₄ |
| C-309 | C(CH₃)₃ | 2-CH₃-C₆H₄ |
| C-311 | Cl | 2-CH₃-C₆H₄ |
| C-312 | Br | 2-CH₃-C₆H₄ |
| C-313 | CH₂OCH₃ | 2-CH₃-C₆H₄ |
| C-314 | COOCH₃ | 2-CH₃-C₆H₄ |
| C-315 | 2-F-C₆H₄ | 2-CH₃-C₆H₄ |
| C-316 | 3-F-C₆H₄ | 2-CH₃-C₆H₄ |
| C-317 | 4-F-C₆H₄ | 2-CH₃-C₆H₄ |
| C-318 | 2-Cl-C₆H₄ | 2-CH₃-C₆H₄ |
| C-319 | 3-Cl-C₆H₄ | 2-CH₃-C₆H₄ |
| C-320 | 4-Cl-C₆H₄ | 2-CH₃-C₆H₄ |
| C-321 | 2-CH₃-C₆H₄ | 2-CH₃-C₆H₄ |
| C-322 | 3-CH₃-C₆H₄ | 2-CH₃ |
| C-323 | 4-CH₃-C₆H₄ | 2-CH₃-C₆H₄ |
| C-324 | CH₃ | 3-CH₃-C₆H₄ |
| C-325 | CH₂CH₃ | 3-CH₃-C₆H₄ |
| C-326 | CH₂CH₂CH₃ | 3-CH₃-C₆H₄ |
| C-327 | CH(CH₃)₂ | 3-CH₃-C₆H₄ |
| C-328 | C(CH₃)₃ | 3-CH₃-C₆H₄ |
| C-329 | Cl | 3-CH₃-C₆H₄ |
| C-330 | Br | 3-CH₃-C₆H₄ |
| C-331 | CH₂OCH₃ | 3-CH₃-C₆H₄ |
| C-332 | COOCH₃ | 3-CH₃-C₆H₄ |
| C-333 | C₆H₅ | 3-CH₃-C₆H₄ |
| C-334 | 2-F-C₆H₄ | 3-CH₃-C₆H₄ |
| C-335 | 3-F-C₆H₄ | 3-CH₃-C₆H₄ |
| C-336 | 4-F-C₆H₄ | 3-CH₃-C₆H₄ |
| C-337 | 2-Cl-C₆H₄ | 3-CH₃-C₆H₄ |
| C-338 | 3-Cl-C₆H₄ | 3-CH₃-C₆H₄ |
| C-339 | 4-Cl-C₆H₄ | 3-CH₃-C₆H₄ |
| C-340 | 2-CH₃-C₆H₄ | 3-CH₃-C₆H₄ |
| C-341 | 3-CH₃-C₆H₄ | 3-CH₃-C₆H₄ |
| C-342 | 4-CH₃-C₆H₄ | 3-CH₃-C₆H₄ |
| C-343 | CH₃ | 4-CH₃-C₆H₄ |
| C-344 | CH₂CH₃ | 4-CH₃-C₆H₄ |
| C-345 | CH₂CH₂CH₃ | 4-CH₃-C₆H₄ |
| C-346 | CH(CH₃)₂ | 4-CH₃-C₆H₄ |
| C-347 | C(CH₃)₃ | 4-CH₃-C₆H₄ |
| C-348 | Cl | 4-CH₃-C₆H₄ |
| C-349 | Br | 4-CH₃-C₆H₄ |
| C-350 | CH₂OCH₃ | 4-CH₃-C₆H₄ |
| C-351 | COOCH₃ | 4-CH₃-C₆H₄ |
| C-352 | C₆H₅ | 4-CH₃-C₆H₄ |
| C-353 | 2-F-C₆H₄ | 4-CH₃-C₆H₄ |
| C-354 | 3-F-C₆H₄ | 4-CH₃-C₆H₄ |
| C-355 | 4-F-C₆H₄ | 4-CH₃-C₆H₄ |
| C-356 | 2-Cl-C₆H₄ | 4-CH₃-C₆H₄ |
| C-357 | 3-Cl-C₆H₄ | 4-CH₃-C₆H₄ |
| C-358 | 4-Cl-C₆H₄ | 4-CH₃-C₆H₄ |
| C-359 | 2-CH₃-C₆H₄ | 4-CH₃-C₆H₄ |
| C-360 | 3-CH₃-C₆H₄ | 4-CH₃-C₆H₄ |
| C-361 | 4-CH₃-C₆H₄ | 4-CH₃-C₆H₄ |

Table 401

Compounds of the formula I.7 wherein X is hydrogen, p is 2, R¹ and R² are hydrogen and the combination of E and R^{c} for a compound corresponds in each case to a row of Table D.

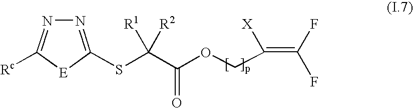

Table 402

Compounds of the formula I.7 wherein X is hydrogen, p is 2, R¹ is hydrogen and R² is methyl and the combination of E and R^{c} for a compound corresponds in each case to a row of Table D.

Table 403

Compounds of the formula I.7 wherein X is hydrogen, p is 2, R¹ is hydrogen and R² is ethyl and the combination of E and R^{c} for a compound corresponds in each case to a row of Table D.

Table 404

Compounds of the formula I.7 wherein X is hydrogen, p is 2, R¹ is hydrogen and R² is i-propyl and the combination of E and R^{c} for a compound corresponds in each case to a row of Table D.

Table 405

Compounds of the formula I.7 wherein X is hydrogen, p is 2, R¹ is hydrogen and R² is n-propyl and the combination of E and R^{c} for a compound corresponds in each case to a row of Table D.

Table 406

Compounds of the formula I.7 wherein X is hydrogen, p is 2, R¹ is hydrogen and R² is cyclo-propyl and the combination of E and R^{c} for a compound corresponds in each case to a row of Table D.

Table 407

Compounds of the formula I.7 wherein X is hydrogen, p is 2, R¹ is hydrogen and R² is n-butyl and the combination of E and R^{c} for a compound corresponds in each case to a row of Table D.

Table 408

Compounds of the formula I.7 wherein X is hydrogen, p is 2, R¹ is hydrogen and R² is i-butyl and the combination of E and R^{c} for a compound corresponds in each case to a row of Table D.

Table 409

Compounds of the formula I.7 wherein X is hydrogen, p is 2, R¹ is hydrogen and R² is tert-butyl and the combination of E and R^{b} for a compound corresponds in each case to a row of Table D.

Table 410

Compounds of the formula I.7 wherein X is hydrogen, p is 2, R¹ is hydrogen and R² is phenyl and the combination of E and R^{c} for a compound corresponds in each case to a row of Table D.

Table 411

Compounds of the formula I.7 wherein X is hydrogen, p is 4, R¹ and R² are hydrogen and the combination of E and R^{c} for a compound corresponds in each case to a row of Table D.

Table 412

Compounds of the formula I.7 wherein X is hydrogen, p is 4, R¹ is hydrogen and R² is methyl and the combination of E and R^{c} for a compound corresponds in each case to a row of Table D.

Table 413

Compounds of the formula I.7 wherein X is hydrogen, p is 4, R¹ is hydrogen and R² is ethyl and the combination of E and R^{c} for a compound corresponds in each case to a row of Table D.

Table 414

Compounds of the formula I.7 wherein X is hydrogen, p is 4, R¹ is hydrogen and R² is i-propyl and the combination of E and R^{c} for a compound corresponds in each case to a row of Table D.

Table 415

Compounds of the formula I.7 wherein X is hydrogen, p is 4, R¹ is hydrogen and R² is n-propyl and the combination of E and R^{c} for a compound corresponds in each case to a row of Table D.

Table 416

Compounds of the formula I.7 wherein X is hydrogen, p is 4, R¹ is hydrogen and R² is cyclo-propyl and the combination of E and R^{c} for a compound corresponds in each case to a row of Table D.

Table 417

Compounds of the formula I.7 wherein X is hydrogen, p is 4, R¹ is hydrogen and R² is n-butyl and the combination of E and R^{c} for a compound corresponds in each case to a row of Table D.

Table 418

Compounds of the formula I.7 wherein X is hydrogen, p is 4, R¹ is hydrogen and R² is i-butyl and the combination of E and R^{c} for a compound corresponds in each case to a row of Table D.

Table 419

Compounds of the formula I.7 wherein X is hydrogen, p is 4, R¹ is hydrogen and R² is tert-butyl and the combination of E and R^{c} for a compound corresponds in each case to a row of Table D.

Table 420

Compounds of the formula I.7 wherein X is hydrogen, p is 4, R¹ is hydrogen and R² is phenyl and the combination of E and R^{c} for a compound corresponds in each case to a row of Table D.

Table 421

Compounds of the formula I.7 wherein X is fluorine, p is 2, R¹ and R² are hydrogen and the combination of E and R^{c} for a compound corresponds in each case to a row of Table D.

Table 422

Compounds of the formula I.7 wherein X is fluorine, p is 2, R¹ is hydrogen and R² is methyl and the combination of E and R^{c} for a compound corresponds in each case to a row of Table D.

Table 423

Compounds of the formula I.7 wherein X is fluorine, p is 2, R¹ is hydrogen and R² is ethyl and the combination of E and R^{c} for a compound corresponds in each case to a row of Table D.

Table 424

Compounds of the formula I.7 wherein X is fluorine, p is 2, R¹ is hydrogen and R² is i-propyl and the combination of E and R^{c} for a compound corresponds in each case to a row of Table D.

Table 425

Compounds of the formula I.7 wherein X is fluorine, p is 2, R¹ is hydrogen and R² is n-propyl and the combination of E and R^{c} for a compound corresponds in each case to a row of Table D.

Table 426

Compounds of the formula I.7 wherein X is fluorine, p is 2, R¹ is hydrogen and R² is cyclo-propyl and the combination of E and R^{c} for a compound corresponds in each case to a row of Table D.

Table 427

Compounds of the formula I.7 wherein X is fluorine, p is 2, R¹ is hydrogen and R² is n-butyl and the combination of E and R^{c} for a compound corresponds in each case to a row of Table D.

Table 428

Compounds of the formula I.7 wherein X is fluorine, p is 2, R¹ is hydrogen and R² is i-butyl and the combination of E and R^{c} for a compound corresponds in each case to a row of Table D.

Table 429

Compounds of the formula I.7 wherein X is fluorine, p is 2, R¹ is hydrogen and R² is tert-butyl and the combination of E and R^{c} for a compound corresponds in each case to a row of Table D.

Table 430

Compounds of the formula I.7 wherein X is fluorine, p is 2, R¹ is hydrogen and R² is phenyl and the combination of E and R^{c} for a compound corresponds in each case to a row of Table D.

Table 431

Compounds of the formula I.7 wherein X is fluorine, p is 4, R¹ and R² are hydrogen and the combination of E and R^{c} for a compound corresponds in each case to a row of Table D.

Table 432

Compounds of the formula I.7 wherein X is fluorine, p is 4, R¹ is hydrogen and R² is methyl and the combination of E and R^{c} for a compound corresponds in each case to a row of Table D.

Table 433

Compounds of the formula I.7 wherein X is fluorine, p is 4, R¹ is hydrogen and R² is ethyl and the combination of E and R^{c} for a compound corresponds in each case to a row of Table D.

Table 434

Compounds of the formula I.7 wherein X is fluorine, p is 4, R¹ is hydrogen and R² is i-propyl and the combination of E and R^{c} for a compound corresponds in each case to a row of Table D.

Table 435

Compounds of the formula I.7 wherein X is fluorine, p is 4, R¹ is hydrogen and R² is n-propyl and the combination of E and R^{c} for a compound corresponds in each case to a row of Table D.

Table 436

Compounds of the formula I.7 wherein X is fluorine, p is 4, R¹ is hydrogen and R² is cyclo-propyl and the combination of E and R^{c} for a compound corresponds in each case to a row of Table D.

Table 437

Compounds of the formula I.7 wherein X is fluorine, p is 4, R¹ is hydrogen and R² is n-butyl and the combination of E and R^{c} for a compound corresponds in each case to a row of Table D.

Table 438

Compounds of the formula I.7 wherein X is fluorine, p is 4, R¹ is hydrogen and R² is i-butyl and the combination of E and R^{c} for a compound corresponds in each case to a row of Table D.

Table 439

Compounds of the formula I.7 wherein X is fluorine, p is 4, R¹ is hydrogen and R² is tert-butyl and the combination of E and R^{c} for a compound corresponds in each case to a row of Table D.

Table 440

Compounds of the formula I.7 wherein X is fluorine, p is 4, R¹ is hydrogen and R² is phenyl and the combination of E and R^{c} for a compound corresponds in each case to a row of Table D.

TABLE D

| | |
|---|---|
| | (1.7) |
| 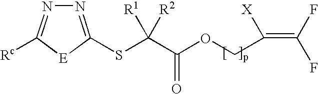 | |

| Nr. | E | R^{c} |
|---|---|---|
| D-1 | O | — |
| D-2 | O | CH₃ |
| D-3 | O | CH₂CH₃ |
| D-4 | O | CH₂CH₂CH₃ |
| D-5 | O | CH(CH₃)₂ |
| D-6 | O | CH₂CH₂CH₂CH₃ |
| D-7 | O | CH₂CH(CH₃)₂ |
| D-8 | O | C(CH₃)₃ |
| D-9 | O | F |
| D-10 | O | Cl |
| D-11 | O | Br |
| D-12 | O | I |
| D-13 | O | CF₃ |
| D-14 | O | OCF₃ |
| D-15 | O | OCH₃ |
| D-16 | O | OCH₂CH₃ |
| D-17 | O | OCH₂CH₂CH₃ |
| D-18 | O | OCH(CH₃)₂ |
| D-19 | O | NO₂ |
| D-2O | O | NH₂ |
| D-21 | O | NH(C}O)CH₃ |
| D-22 | S | — |
| D-23 | S | CH₃ |
| D-24 | S | CH₂CH₃ |
| D-25 | S | CH₂CH₂CH₃ |
| D-26 | S | CH(CH₃)₂ |
| D-27 | S | CH₂CH₂CH₂CH₃ |
| D-28 | S | CH₂CH(CH₃)₂ |
| D-29 | S | C(CH₃)₃ |
| D-30 | S | F |
| D-31 | S | Cl |
| D-32 | S | Br |
| D-33 | S | I |
| D-34 | S | CF₃ |
| D-35 | S | OCF₃ |
| D-36 | S | OCH₃ |
| D-37 | S | OCH₂CH₃ |
| D-38 | S | OCH₂CH₂CH₃ |
| D-39 | S | OCH(CH₃)₂ |
| D-40 | S | NO₂ |
| D-41 | S | NH₂ |
| D-42 | S | NH(C}O)CH₃ |

The compounds of the formula I are suitable for efficiently controlling nematodes, insects, and arachnids in crop protection. In particular, they are suitable for controlling the following animal pests:

insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,

beetles (Coleoptera), for example Agrilus sinuatus, Agriotes lineatus, Agriotes obscurus, Amphimallus solstitialis, Anisandrus dispar, Anthonomus grandis, Anthonomus pomorum, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus, Crioceris asparagi, Diabrotica longicornis, Diabrotica 12-punctata, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllotreta chrysocephala, Phyllophaga sp., Phyllopertha horticola, Phyllotreta nemorum, Phyllotreta striolata, Popillia japonica, Sitona lineatus and Sitophilus granaria,

dipterans (Diptera), for example Aedes aegypti, Aedes vexans, Anastrepha ludens, Anopheles maculipennis, Ceratitis capitata, Chrysomya bezziana, Chrysomya hominivorax, Chrysomya macellaria, Contarinia sorghicola, Cordylobia anthropophaga, Culex pipiens, Dacus cucurbitae, Dacus oleae, Dasineura brassicae, Fannia canicularis, Gasterophilus intestinalis, Glossina morsitans, Haematobia irritans, Haplodiplosis equestris, Hylemyia platura, Hypoderma lineata, Liriomyza sativae, Liriomyza trifolii, Lucilia caprina, Lucilia cuprina, Lucilia sericata, Lycoria pectoralis, Mayetiola destructor, Musca domestica, Muscina stabulans, Oestrus ovis, Oscinella frit, Pegomya hysocyami, Phorbia antiqua, Phorbia brassicae, Phorbia coarctata, Rhagoletis cerasi, Rhagoletis pomonella, Tabanus bovinus, Tipula oleracea and Tipula paludosa,

thrips (Thysanoptera), e.g. Frankliniella fusca, Frankliniella occidentalis, Frankliniella tritici, Scirtothrips citri, Thrips oryzae, Thrips palmi and Thrips tabaci,

hymenopterans (Hymenoptera), e.g. Athalia rosae, Atta cephalotes, Atta sexdens, Atta texana, Hoplocampa minuta, Hoplocampa testudinea, Monomorium pharaonis, Solenopsis geminata and Solenopsis invicta,

heteropterans (Heteroptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis and Thyanta perditor,

homopterans (Homoptera), e.g. Acyrthosiphon onobrychis, Adelges laricis, Aphidula nasturtii, Aphis fabae, Aphis pomi, Aphis sambuci, Brachycaudus cardui, Brevicoryne brassicae, Cerosipha gossypii, Dreyfusia nordmannianae, Dreyfusia piceae, Dysaphis radicola, Dysaulacorthum pseudosolani, Empoasca fabae, Macrosiphum avenae, Macrosiphum euphorbiae, Macrosiphon rosae, Megoura viciae, Metopolophium dirhodum, Myzodes persicae, Myzus cerasi, Nilaparvata lugens, Pemphigus bursarius, Perkinsiella saccharicida, Phorodon humuli, Psylla mali, Psylla piri, Rhopalomyzus ascalonicus, Rhopalosiphum maidis, Sappaphis mala, Sappaphis mali, Schizaphis graminum, Schizoneura lanuginosa, Trialeurodes vaporariorum and Viteus vitifolii,

termites (Isoptera), e.g. Calotermes flavicollis, Leucotermes flavipes, Reticulitermes lucifugus und Termes natalensis,

orthopterans (Orthoptera), e.g. Acheta domestica, Blatta orientalis, Blattella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus,

Arachnoidea, such as arachnids (Acarina), e.g. Amblyomma americanum, Amblyomma variegatum, Argas persicus, Boophilus annulatus, Boophilus decoloratus, Boophilus microplus, Brevipalpus phoenicis, Bryobia praetiosa, Dermacentor silvarum, Eotetranychus carpini, Eriophyes sheldoni, Hyalomma truncatum, Ixodes ricinus, Ixodes rubicundus, Ornithodorus moubata, Otobius megnini, Paratetranychus pilosus, Dermanyssus gallinae, Phyllocoptruta oleivora, Polyphagotarsonemus latus, Psoroptes ovis, Rhipicephalus appendiculatus, Rhipicephalus evertsi, Sarcoptes scabiei, Tetranychus cinnabarinus, Tetranychus kanzawai, Tetranychus pacificus, Tetranychus telarius and Tetranychus urticae,

Nematodes, especially plant parasitic nematodes such as root knot nematodes, Meloidogyne hapla, Meloidogyne incognita, Meloidogyne javanica, and other Meloidogyne species; cyst-forming nematodes, Globodera rostochiensis and other Globodera species; Heterodera avenae, Heterodera glycines, Heterodera schachtii, Heterodera trifolii, and other Heterodera species; Seed gall nematodes, Anguina species; Stem and foliar nematodes, Aphelenchoides species; Sting nematodes, Belonolaimus longicaudatus and other Belonolaimus species; Pine nematodes, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false root-knot nematodes, Nacobbus species; Needle nematodes, Longidorus elongatus and other Longidorus species; Pin nematodes, Paratylenchus species; Lesion nematodes, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species; Dagger nematodes, Xiphinema species; and other plant parasitic nematode species.

The compounds of formula I are especially useful for the control of nematodes.

The compounds I also are suitable for use as fungicides. They exhibit activity against a broad spectrum of phytopathogenic fungi, in particular from the classes of the Ascomycetes, Deuteromycetes, Phycomycetes and Basidiomycetes. Some of them act systemically, and they can be employed in crop protection as foliar- and soil-acting fungicides.

They are especially important for controlling a large number of fungi on a variety of crop plants such as wheat, rye, barley, oats, rice, maize, grass, bananas, cotton, soya, coffee, sugar cane, grapevines, fruit species, ornamentals and vegetables such as cucumbers, beans, tomatoes, potatoes and cucurbits, and on the seeds of these plants. Specifically, they are suitable for controlling the following plant diseases:

Alternaria species on vegetables and fruit, Botrytis cinerea (gray mold) on strawberries, vegetables, ornamentals and grapevines, Cercospora arachidicola on peanuts, Erysiphe cichoracearum and Sphaerotheca fuliginea on cucurbits, Ezysiphe graminis (powdery mildew) on cereals, Fusarium and Verticillium species on various plants, Helminthosporium species on cereals, Mycosphaerella species on bananas and peanuts, Phytophthora infestans on potatoes and tomatoes, Plasmopara viticola on grapevines, Podosphaera leucotricha on apples, Pseudocercosporella herpotrichoides on wheat and barley, Pseudoperonospora species on hops and cucumbers, Puccinia species on cereals, Pyricularia oryzae on rice, Rhizoctonia species on cotton, rice and lawns, Septoria nodorum on wheat, Uncinula necator on grapevines, Ustilago species on cereals and sugar cane, and Venturia species (scab) on apples and pears.

Moreover, the compounds I are suitable for controlling harmful fungi such as Paecilomyces variotii in the protection of materials (e.g. wood, paper, paint dispersions, fibers and fabrics) and in the protection of stored products.

The compounds I are applied by treating the fungi, or the plants, seeds, materials or the soil to be protected against fungal attack, with a fungicidally effective amount of the active ingredients. Application can be effected both before and after infection of the materials, plants or seeds by the fungi.

Compounds of formula I are suitable for use as herbicides. Depending upon the application method, compounds I and herbicidal compositions comprising them may be used in crops for the control of unwanted plants. Exemplary are the following crops:

Allium cepa, Ananas comosus, Arachis hypogaea, Asparagus officinalis, Beta vulgaris spp. altissima, Beta vulgaris spp. rapa, Brassica napus var. napus, Brassica napus var. napobrassica, Brassica rapa var. silvestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spp., Manihot esculenta, Medicago sativa, Musa spp., Nicotiana tabacum (N. rustica), Olea europaea, Oxyza sativa, Phaseolus lunatus, Phaseolus vulgaris, Picea abies, Pinus spp., Pisum sativum, Prunus avium, Prunus persica, Pyrus communis, Ribes sylvestre, Ricinus communis, Saccharum officinarum, Secale cereale, Solanum tuberosum, Sorghum bicolor (s. vulgare), Theobroma cacao, Trifolium pratense, Triticum aestivum, Triticum durum, Vicia faba, Vitis vinifera und Zea mays.

Compounds of formula I may also be used in crops that have acquired resistance against other herbicides.

For controlling animal pests, pesticidally active amounts of compounds of formula I are typically applied to the pests or to their food supply, habitat or breeding ground. For the protection of growing plants from attack or infestation by the pests, pesticidally active amounts of the compounds of formula I are typically applied to the foliage, stem or roots of the plants or to the soil or water in which they are growing.

The rate of application of active ingredient for controlling animal pests is from 0.01 to 100, preferably 0.1 to 3 kg/ha under field conditions.

The compounds I can be converted into the customary formulations, e.g. solutions, emulsions, suspensions, dusts, powders, pastes and granules. The use form depends on the particular purpose; in any case, it should guarantee a fine and uniform distribution of the compound according to the invention.

The formulations are prepared in a known manner, e.g. by extending the active ingredient with solvents and/or carriers, if desired using emulsifiers and dispersants, it also being possible to use other organic solvents as auxiliary solvents if water is used as the diluent. Auxiliaries which are suitable are essentially: solvents such as aromatics (e.g. xylene), chlorinated aromatics (e.g. chlorobenzenes), paraffins (e.g. mineral oil fractions), alcohols (e.g. methanol, butanol), ketones (e.g. cyclohexanone), amines (e.g. ethanolamine, dimethylformamide) and water; carriers such as ground natural minerals (e.g. kaolins, clays, talc, chalk) and ground synthetic minerals (e.g. highly-disperse silica, silicates); emulsifiers such as non-ionic and anionic emulsifiers (e.g. polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates and fatty acids and their alkali metal and alkaline earth metal salts, salts of sulfated fatty alcohol glycol ether, condensates of sulfonated naphthalene and naphthalene derivatives with formaldehyde, condensates of naphthalene or of napthalenesulfonic acid with phenol or formaldehyde, polyoxyethylene octylphenyl ether, ethoxylated isooctylphenol, octylphenol, nonylphenol, alkylphenol polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, e.g. benzene, toluene, xylene, paraffin, tetrahydronaphthalene, alkylated naphthalenes or their derivatives, methanol, ethanol, propanol, butanol, chloroform, carbon tetrachloride, cyclohexanol, cyclohexanone, chlorobenzene, isophorone, strongly polar solvents, e.g. dimethylformamide, dimethyl sulfoxide, N-methylpyrrolidone and water.

Powders, materials for scattering and dusts can be prepared by mixing or concomitantly grinding the active substances with a solid carrier.

Granules, e.g. coated granules, impregnated granules and homogeneous granules, can be prepared by binding the active ingredients to solid carriers. Examples of solid carriers are mineral earths, such as silicas, silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, e.g. ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise of from 0.01 to 95% by weight, preferably from 0.1 to 90% by weight, of the active ingredient. The active ingredients are employed in a purity of from 90% to 100%, preferably 95% to 100% (according to NMR spectrum).

The following are exemplary formulations:
I. 5 parts by weight of a compound according to the invention are mixed intimately with 95 parts by weight of finely divided kaolin. This gives a dust which comprises 5% by weight of the active ingredient.
II. 30 parts by weight of a compound according to the invention are mixed intimately with a mixture of 92 parts by weight of pulverulent silica gel and 8 parts by weight of paraffin oil which had been sprayed onto the surface of this silica gel. This gives a formulation of the active ingredient with good adhesion properties (comprises 23% by weight of active ingredient).
III. 10 parts by weight of a compound according to the invention are dissolved in a mixture composed of 90 parts by weight of xylene, 6 parts by weight of the adduct of 8 to 10 mol of ethylene oxide and 1 mol of oleic acid N-monoethanolamide, 2 parts by weight of calcium dodecylbenzenesulfonate and 2 parts by weight of the adduct of 40 mol of ethylene oxide and 1 mol of castor oil (comprises 9% by weight of active ingredient).
IV. 20 parts by weight of a compound according to the invention are dissolved in a mixture composed of 60 parts by weight of cyclohexanone, 30 parts by weight of isobutanol, 5 parts by weight of the adduct of 7 mol of ethylene oxide and 1 mol of isooctylphenol and 5 parts by weight of the adduct of 40 mol of ethylene oxide and 1 mol of castor oil (comprises 16% by weight of active ingredient).
V. 80 parts by weight of a compound according to the invention are mixed thoroughly with 3 parts by weight of sodium diisobutylnaphthalene-alpha-sulfonate, parts by weight of the sodium salt of a lignosulfonic acid from a sulfite waste liquor and 7 parts by weight of pulverulent silica gel, and the mixture is ground in a hammer mill (comprises 80% by weight of active ingredient).
VI. 90 parts by weight of a compound according to the invention are mixed with 10 parts by weight of N-methyl-α-pyrrolidone, which gives a solution which is suitable for use in the form of microdrops (comprises 90% by weight of active ingredient).
VII. 20 parts by weight of a compound according to the invention are dissolved in a mixture composed of 40 parts by weight of cyclohexanone, 30 parts by weight of isobutanol, 20 parts by weight of the adduct of 7 mol of ethylene oxide and 1 mol of isooctylphenol and 10 parts by weight of the adduct of 40 mol of ethylene oxide and I mol of castor oil. Pouring the solution into 100,000 parts by weight of water and finely distributing it therein gives an aqueous dispersion which comprises 0.02% by weight of the active ingredient.
VIII. 20 parts by weight of a compound according to the invention are mixed thoroughly with 3 parts by weight of sodium diisobutylnaphthalene-α-sulfonate, 17 parts by weight of the sodium salt of a lignosulfonic acid from a sulfite waste liquor and 60 parts by weight of pulverulent silica gel, and the mixture is ground in a hammer mill. Finely distributing the mixture in 20,000 parts by weight of water gives a spray mixture which comprises 0.1% by weight of the active ingredient.

The active ingredients can be used as such, in the form of their formulations or the use forms prepared therefrom, e.g. in the form of directly sprayable solutions, powders, suspensions or dispersions, emulsions, oil dispersions, pastes, dusts, materials for spreading, or granules, by means of spraying, atomizing, dusting, scattering or pouring. The use forms depend entirely on the intended purposes; in any case, this is intended to guarantee the finest possible distribution of the active ingredients according to the invention.

Aqueous use forms can be prepared from emulsion concentrates, pastes or wettable powders (sprayable powders, oil dispersions) by adding water. To prepare emulsions, pastes or oil dispersions, the substances as such or dissolved in an oil or solvent, can be homogenized in water by means of wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active ingredient concentrations in the ready-to-use products can be varied within substantial ranges. In general, they are from 0.0001 to 10%, preferably from 0.01 to 1%.

The active ingredients may also be used successfully in the ultra-low-volume process (ULV), it being possible to apply formulations comprising over 95% by weight of active ingredient, or even the active ingredient without additives.

Various types of oils, herbicides, fungicides, other pesticides, or bactericides may be added to the active ingredients, if appropriate also only immediately prior to use (tank mix). These agents can be admixed with the agents according to the invention in a weight ratio of 1:10 to 10:1.

In the use form as pesticides in crop protection, the compositions according to the invention can also be present together with other active ingredients, e.g. with herbicides, insecticides, growth regulators, fungicides or else with fertilizers. Mixing the compounds I or the compositions comprising them in the use form as pesticides with other pesticides frequently results in a broader pesticidal spectrum of action.

The following list of pesticides together with which the compounds according to the invention can be used, is intended to illustrate the possible combinations.

Organophosphates: Acephate, Azinphos-methyl, Chlorpyrifos, Chlorfenvinphos, Diazinon, Dichlorvos, Dicrotophos, Dimethoate, Disulfoton, Ethion, Fenitrothion, Fenthion, Isoxathion, Malathion, Methamidophos, Methidathion, Methyl-Parathion, Mevinphos, Monocrotophos, Oxydemeton-methyl, Paraoxon, Parathion, Phenthoate, Phosalone, Phosmet, Phosphamidon, Phorate, Phoxim, Pirimiphos-methyl, Profenofos, Prothiofos, Sulprophos, Triazophos, Trichlorfon;

Carbamates: Alanycarb, Benfuracarb, Carbaryl, Carbosulfan, Fenoxycarb, Furathiocarb, Indoxacarb, Methiocarb, Methomyl, Oxamyl, Pirimicarb, Propoxur, Thiodicarb, Triazamate;

Pyrethroids: Bifenthrin, Cyfluthrin, Cypermethrin, Deltamethrin, Esfenvalerate, Ethofenprox, Fenpropathrin, Fenvalerate, Cyhalothrin, Lambda-Cyhalothrin, Permethrin, Silafluofen, Tau-Fluvalinate, Tefluthrin, Tralomethrin, Zeta-Cypermethrin;

Arthropod growth regulators: a) chitin synthesis inhibitors: benzoylureas: Chlorfluazuron, Diflubenzuron, Flucycloxuron, Flufenoxuron, Hexaflumuron, Lufenuron, Novaluron, Teflubenzuron, Triflumuron; Buprofezin, Diofenolan, Hexythiazox, Etoxazole, Clofentazine; b) ecdysone antagonists: Halofenozide, Methoxyfenozide, Tebufenozide; c) juvenoids: Pyriproxyfen, Methoprene, Fenoxycarb; d) lipid biosynthesis inhibitors: Spirodiclofen;

Various: Abamectin, Acequinocyl, Amitraz, Azadirachtin, Bifenazate, Cartap, Chlorfenapyr, Chlordimeform, Cyromazine, Diafenthiuron, Dinetofuran, Diofenolan, Emamectin, Endosulfan, Fenazaquin, Fipronil, Formetanate, Formetanate, Hydrochloride, Hydramethylnon, Imidacloprid, Indoxacarb, Pyridaben, Pymetrozine, Spinosad, Sulfur, Tebufenpyrad, Thiamethoxam, and Thiocyclam.

This invention also provides a method for treating, curing, controlling, preventing and protecting warm-blooded animals, including humans, and fish against infestation and infection by helminths, acarids and arthropod endo- and ectoparasites which comprises orally, topically or parenterally administering or applying to said animals an anthelmintically, acaricidally or endo or ectoparasiticidally effective amount of compounds of formula I.

The above method is particularly useful for controlling and preventing helminth, acarid and arthropod endo- and ectoparasitic infestations and infections in warm-blooded animals such as cattle, sheep, swine, camels, deer, horses, poultry, fish, rabbits, goats, mink, fox, chinchillas, rabbits, dogs and cats as well as humans.

Compounds of formula I are especially useful in controlling helminths and nematodes. Examples for helminths are members of the class Trematoda, commonly known as flukes or flatworms, especially members of the genera Fasciola, Fascioloides, Paramphistomum, Dicrocoelium, Eurytrema, Ophisthorchis, Fasciolopsis, Echinostoma and Paragonimus. Nematodes which can be controlled by the formula I compounds include the genera Haemonchus, Ostertagia, Cooperia, Oesphagastomum, Nematodirus, Dictyocaulus, Trichuris, Direofilaria, Ancyclostoma, Ascaris and the like.

The formula I compounds of this invention also control endoparasitic arthropod infestations such as cattle grub and stomach bot. In addition, acarid and arthropod ectoparasitic infestations in warm-blooded animals and fish including biting lice, sucking lice, bot flies, biting flies, muscoid flies, myiasitic fly larvae, gnats, mosquitoes, fleas, mites, ticks, nasal bots, keds and chiggers may be controlled, prevented or eliminated by the compounds of this invention. Biting lice include members of Mallophaga such as Bovicola bovis, Trichodectes canis and Damilina ovis. Sucking lice include members of Anoplura such as Haematopinus eurysternus, Haematopinus suis, Linognathus vituli and Solenopotes capillatus. Biting flies include members of Haematobia. Ticks include Boophilus, Rhipicephalus, Ixodes, Hyalomma, Amblyomma and Dermacentor. The formula I compounds may also be used to control mites which are parasitic on warm-blooded mammals and poultry including mites of the orders Acariformes and Parasitiformes.

For oral administration to warm-blooded animals, the formula I compounds may be formulated as animal feeds, animal feed premixes, animal feed concentrates, pills, solutions, pastes, suspensions, drenches, gels, tablets, boluses and capsules. In addition, the formula I compounds may be administered to the animals in their drinking water. For oral administration, the dosage form chosen should provide the animal with about 0.01 mg/kg to 100 mg/kg of animal body weight per day of the formula I compound.

Alternatively, the formula I compounds may be administered to animals parenterally, for example, by intraruminal, intramuscular, intravenous or subcutaneous injection. The formula I compounds may be dispersed or dissolved in a physiologically acceptable carrier for subcutaneous injection. Alternatively, the formula I compounds may be formulated into an implant for subcutaneous administration. In addition the formula I compound may be transdermally administered to animals. For parenteral administration, the dosage form chosen should provide the animal with about 0.01 mg/kg to 100 mg/kg of animal body weight per day of the formula I compound.

The formula I compounds may also be applied topically to the animals in the form of dips, dusts, powders, collars, medallions, sprays and pour-on formulations. For topical application, dips and sprays usually contain about 0.5 ppm to 5,000 ppm and preferably about 1 ppm to 3,000 ppm of the formula I compound. In addition, the formula I compounds may be formulated as ear tags for animals, particularly quadrupeds such as cattle and sheep.

The formula I compounds of this invention may also be used in combination or conjunction with one or more other parasiticidal compounds including anthelmintics, such as benzimidazoles, piperazine, levamisole, pyrantel, and praziquantel; endectocides such as avermectins, and milbemycins; ectoparasiticides such as arylpyrroles, organophosphates, and carbamates, gamabutyric acid inhibitors including fipronil, pyrethroids, spinosads and imidacloprid; insect growth regulators such as pyriproxyfen, and cyromazine; and chitin synthase inhibitors such as benzoylureas including flufenoxuron.

The formula I compounds may also be used in combination or conjunction with one or more compounds selected from piperonyl butoxide, N-octyl bicycloheptene dicarboximide, dipropyl pyridine-2,5-dicarboxylate and 1,5a,6,9,9a,9b-hexahydro-4a(4H)-dibenzo-furancarboxaldehyde to broaden the spectrum of activity.

The parasiticidal compositions of the present invention include a parasiticidally effective amount of a formula I compound of this invention or combinations thereof admixed with one or more physiologically tolerable inert, solid or liquid carriers known from veterinary medicinal practice for oral, percutaneous and topical administration. Such compositions may comprise further additives, such as stabilizers, anifoams, viscosity regulators, binders and tackifiers. Whereas commercial products will preferably be formulated as concentrates, the end user will normally employ dilute formulations.

### SYNTHESIS EXAMPLES

With due modification of the starting compounds, the protocols shown in the synthesis examples below were used for obtaining further compounds I. The resulting compounds, together with physical data, are listed in Table I which follows.

### Example 1

### Preparation of 2-(5-Chloro-benzothiazol-2-yl-sulfanyl)-propionic Acid Ethyl Ester

A solution of 5-chloro-benzothiazol-2-thiol (1,4 g) in 50 ml acetonitrile was treated with potassium carbonate (1.0 g) and 2-bromo-propionic acid ethyl ester (1.25 g) for 3 hours at room temperature. The solvent was removed in vacuo and the residue redissolved in ethyl acetate and washed with water. The organic extract was dried over anhydrous sodium sulfate. Removal of solvent gave 2.1 g of the title compound as a light-brown oil. ¹H—NMR (δ [CDCl₃])=1.3 (m_{c},3H), 1.7 (m_{c},3H), 4.2 (m_{c}, 2H), 4.7 (m_{c},1H), 7.25 (d,1H), 7.65 (d,1H), 7.85 (s,1H).

### Example 2

### Preparation of 2-(5-Chloro-benzothiazol-2-yl-sulfanyl)-butyric Acid

A solution of 2-(5-chloro-benzothiazol-2-yl-sulfanyl)-butyric acid ethyl ester (1.62 g) in 40 ml of ethanol was treated with 40 ml of water and an aqueous solution of potassium hydroxide in water (85%, 0.36 g) for 14 hours at 25° C. Ethanol was removed in vacuo, the ressidue acidified with diluted hydrochloric acid and extracted with ethyl acetate. The organic extract was dried over anhydrous sodium sulfate. Removal of solvent gave 1.5 g of the title compound as a light-brown oil.

¹H-NMR (δ [d⁶-DMSO])=1.00 (t,3H), 2.00 (m_{c}, 2H), 4.55 (t, 1H), 7.45 (d,1H), 7.95 (s,1H), 8.1 (d,1H).

### Example 3

### Preparation of 2-[4-(4-chlorophenyl)-thiazol-2-yl-sulfanyl]-hexanoic Acid 3,4,4-trifluoro-but-3-enyl Ester

A mixture of 2-[4-(4-chlorophenyl)-thiazol-2-yl-sulfanyl]-hexanoic acid (0.3 g), potassium carbonate (0.16 g) and 4-bromo-1,2,2-trifluorobut-1-ene (0.21 g) in 20 ml N,N-dimethylformamide was stirred at 40-45° C. for 4 hours. The reation mixture was poured into ice water and extracted with ethyl acetate. The organic extract was dried over anhydrous sodium sulfate and concentrated in vacuo to give 0.37 g of the title compound as a light-brown oil.

¹H-NMR (δ [CDCl₃])=0.9 (t,3H), 1.15-2.1 (m,6H), 2.6 (m_{c}, 2H), 4.25-4.4 (m,3H), 7.35 (m_{c}, 3H), 7.8 (d,2H).

TABLE I

| | |
|---|---|
| | (I.2) |
| 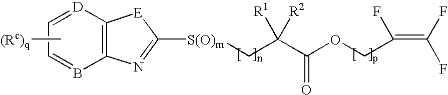 | |

| No | B | D | E | (R^{c})_{q} | q | R¹ | R² | m | n | p | Physical data: ¹H-NMR (δ [ppm]) |
|---|---|---|---|---|---|---|---|---|---|---|---|
| I.2-1 | CH | CH | O | 6-Cl | 1 | H | H | 0 | 0 | 4 | |
| I.2-2 | CH | CH | S | — | O | H | H | 0 | 0 | 4 | |
| I.2-3 | CH | CH | S | 6-CF₃ | 1 | H | H | 0 | 0 | 4 | |
| I.2-4 | N | CH | S | 6-CH₃ | 1 | H | H | 0 | 0 | 2 | |
| I.2-5 | CH | CH | O | 6-Cl | 1 | CH(CH₃)₂ | H | 0 | 0 | 2 | |
| I.2-6 | CH | CH | S | — | O | H | H | 0 | 0 | 2 | |
| I.2-7 | CH | CH | O | — | O | H | H | 0 | 0 | 2 | |
| I.2-8 | CH | CH | S | — | O | CH₃ | H | 0 | 0 | 2 | |
| I.2-9 | CH | CH | O | 6-Cl | 1 | H | H | 0 | 0 | 2 | |
| I.2-10 | CH | CH | S | 6-OCH₂CH₃ | 1 | H | H | 0 | 0 | 2 | |
| I.2-11 | CH | CH | S | — | O | OCH₂CH₃ | H | 0 | 0 | 2 | 1.0(t), 2.10(m_{c}), 2.65(m_{c}), 4.30 |
| | | | | | | | | | | | (t), 4.65(t), 7.25(t), 7.40(t), |
| | | | | | | | | | | | 7.75(d), 7.85(d) |
| I.2-12 | CH | CH | S | — | O | C₆H₅ | H | 0 | 0 | 2 | |
| I.2-13 | CH | CH | S | — | O | OCH(CH₃)₂ | H | 0 | 0 | 2 | |
| I.2-14 | CH | CH | O | 6-Cl | 1 | CH₃ | H | 0 | 0 | 2 | |
| I.2-15 | CH | CH | S | 5-Cl | 1 | H | H | 0 | 0 | 2 | |
| I.2-16 | CH | CH | NH | — | — | 0 | H | H | 0 | 0 | 2 |
| I.2-17 | CH | N | S | — | — | 0 | H | H | 0 | 0 | 2 |
| I.2-18 | N | CH | S | 6-CH₃ | 1 | CH₂CH₃ | H | 0 | 0 | 2 | |
| I.2-19 | N | CH | S | 6-CH₃ | 1 | CH(CH₃)₂ | H | 0 | 0 | 2 | |
| I.2-20 | N | CH | O | — | H | H | 0 | 0 | 2 | | |
| I.2-21 | N | CH | S | — | 0 | CH₃ | H | 0 | 0 | 2 | |
| I.2-22 | N | CH | S | 6-Br | 1 | H | H | 0 | 0 | 2 | |
| I.2-23 | CH | CH | S | 6-OCH₂CH₃ | 1 | CH₃ | H | 0 | 0 | 2 | |
| I.2-24 | N | CH | S | — | 0 | H | H | 0 | 0 | 2 | |
| I.2-25 | N | CH | S | — | 0 | CH(CH₃)₂ | H | 0 | 0 | 2 | |
| I.2-26 | N | CH | S | — | 0 | F | H | 0 | 0 | 2 | |
| I.2-27 | CH | CH | S | — | 0 | CH₃ | CH₃ | 0 | 0 | 2 | 1.75(s), 2.65(m_{c}), 4.30(t), |
| | | | | | | | | | | | 7.35(t), 7.45(t), 7.75(d), |
| | | | | | | | | | | | 7.90(d) |
| I.2-28 | CH | CH | S | — | 0 | (CH₂)₃CH₃ | H | 0 | 0 | 2 | 0.95(t), 1.30-1.55(m), 1.90-2.15 |
| | | | | | | | | | | | (m), 2.60(m_{c}), 4.30(t), 4.65(t), |
| | | | | | | | | | | | 7.30(t), 7.45(t), 7,75(d), |
| | | | | | | | | | | | 7.85(d) |
| I.2-29 | CH | CH | S | 6-OCH₂CH₃ | 1 | (CH₂)₃CH₃ | H | 0 | 0 | 2 | 0.90(t), 1.30-1.50(m), 1.85-2.10 |
| | | | | | | | | | | | (m), 2.60(m_{c}), 4.05(q), 4.30(t), |
| | | | | | | | | | | | 4.50(t); 6.95(d), 7.20(s), |
| | | | | | | | | | | | 7.75(d) |
| I.2-30 | CH | CH | S | 6-OCH₂CH₃ | 1 | CH₃ | CH₃ | O | O | 2 | 1.45(t), 1.70(s), 2.60(mj, 4.05 |
| | | | | | | | | | | | (q), 4.30(t), 7.05(d), 7.25(s), |
| | | | | | | | | | | | 7.80(d) |
| I.2-31 | CH | CH | S | 6-OCH₂CH₃ | 1 | CH₂CH₃ | H | 0 | 0 | 2 | 1.15(t), 1.45(t), 1.95-2.2(m), |
| | | | | | | | | | | | 4.05(q), 4.35(t), 4.5(t), |
| | | | | | | | | | | | 7.0(d), 7.2(s), 7.75(d) |
| I.2-32 | N | CH | S | 6-CF₃ | 1 | CH₂CH₃ | H | 0 | 0 | 2 | 1.15(t), 2.0-2.25(m), 2.7(m_{c}), |
| | | | | | | | | | | | 4.35(q), 4.95(t), 8.4(s), 8.9(s) |
| I.2-33 | CH | CH | O | — | 0 | CH₃ | H | 0 | 0 | 2 | 1.75(d), 2.65(ni,~), 4.35(t), 4.65 |
| | | | | | | | | | | | (q), 7.25(m_{c}), 7.45(d), 7.6(d) |
| I.2-34 | CH | CH | O | — | 0 | CH₂CH₃ | CH₃ | 0 | 0 | 2 | 1.15(t), 2.10(m_{c}), 2,65(m_{c}), 4.3 |
| | | | | | | | | | | | (t), 4.55(t), 7.25(m_{c}), 7.45(d), |
| | | | | | | | | | | | 7.60 (d) |
| I.2-35 | CH | CH | O | — | 0 | CH₃ | CH₃ | 0 | 0 | 2 | 1.75(s), 2.65(m_{c}), 4.30(t), |
| | | | | | | | | | | | 7.25(m_{c}), 7.45(d), 7.60(d) |
| I.2-36 | CH | CH | O | — | 0 | (CH₂)₃CH₃ | H | 0 | 0 | 2 | 0.95(t), 1.30-2.15(m), 2.65(m_{c}) |
| | | | | | | | | | | | 4.35(t), 4.55(t), 7.25(m_{c}), 7.45 |
| | | | | | | | | | | | (d), 7.60(d) |
| I.2-37 | CH | CH | O | — | 0 | CH(CH₃)₂ | H | 0 | 0 | 2 | 1.15(d), 2.40(m_{c}). 2.65(m_{c}) |
| | | | | | | | | | | | 4.35(t), 4.55(d), 7.25(m_{c}), |
| | | | | | | | | | | | 7.45(d), 7.60(d) |
| I.2-38 | CH | N | S | — | 0 | CH₃ | H | 0 | 0 | 2 | 1.75(d), 2.65(m_{c}). 4.35(t), 4.75 |
| | | | | | | | | | | | (q), 7.35(m_{c}), 8.05(d), 8.45(d) |
| I.2-39 | CH | N | S | — | 0 | CH₃ | CH₃ | 0 | 0 | 2 | 1.75(s), 2.65(m_{c}), 4.30(t), 7.35 |
| | | | | | | | | | | | (m_{c}), 8.05(d), 8.50(d) |
| I.2-40 | CH | N | S | — | 0 | (CH₂)₃CH₃ | H | 0 | 0 | 2 | 0.95(t), 1.25-2.15(m), 2.65(m_{c}), |
| | | | | | | | | | | | 4.35(t), 4.75(t), 7.35(m_{c}), 8.0 |
| | | | | | | | | | | | (d), 8.5(d) |
| I.2-41 | N | CH | S | 6-Cl | 1 | (CH₂)₃CH₃ | H | 0 | 0 | 2 | 0.95(t), 1.25-2.15(m), 2.65(m_{c}), |
| | | | | | | | | | | | 4.3(m_{c}), 4.95(t), 8.1(s), |
| | | | | | | | | | | | 8.55(s) |
| I.2-42 | N | CH | S | — | 0 | CH(CH₃)₂ | H | 0 | 0 | 2 | 1.15(d), 2.4(m_{c}), 2.65(m_{c}), 4.35 |
| | | | | | | | | | | | (m_{c}), 4.75(d), 7.35(m_{c}), |
| | | | | | | | | | | | 8.05(d), 8.45(d) |
| I.2-43 | CH | CH | O | 6-Cl | 1 | CH₂CH₃ | H | 0 | 0 | 2 | 1.1(t), 2.05(m_{c}), 2.65(m_{c}), 4.35 |
| | | | | | | | | | | | (t), 4.5(t), 7.25(d), 7.55(m_{c}) |
| I.2-44 | CH | CH | O | 6-Cl | 1 | CH₃ | CH₃ | 0 | 0 | 2 | 1.80(s), 2.65(m_{c}), 4.3(t), 7.25 |
| | | | | | | | | | | | (d), 7.45(s), 7.55(d) |
| I.2-45 | CH | CH | O | 6-Cl | 1 | (CH₂)₃CH₃ | H | 0 | 0 | 2 | 0.95(t), 1.25-2.15(m), 2.65(m_{c}), |
| | | | | | | | | | | | 4.3(t), 4.5(t), 7.25(d), 7.5(m_{c}) |
| I.2-46 | CH | CH | S | 6-OCH₂CH₃ | 1 | CH(CH₃)₂ | H | 0 | 0 | 2 | 1.15(m_{c}), 1.45(t), 2.35(m_{c}), |
| | | | | | | | | | | | 2.65 (m_{c}), 4.05(q), 4.3(m_{c}), |
| | | | | | | | | | | | 4.5(d), 7.0(d), 7.2(s), 7.75(d) |
| I.2-47 | CH | CH | S | 6-CF₃ | 1 | H | H | 0 | 0 | 2 | |
| I.2-48 | CH | CH | O | 5-CH₃ | 1 | H | H | 0 | 0 | 2 | |
| I.2-49 | CH | CH | S | 6-F | 1 | H | H | 0 | 0 | 2 | |
| I.2-50 | N | CH | S | 6-CH₃ | 1 | F | H | 0 | 0 | 2 | |
| I.2-51 | N | CH | S | 6-CF₃ | 1 | CH₃ | H | 0 | 0 | 2 | |
| I.2-52 | CH | CH | S | 6-OCF₃ | 1 | H | H | 0 | 0 | 2 | |
| I.2-53 | N | CH | S | 6-Br | 1 | CH₃ | H | 0 | 0 | 2 | 1.75(d), 2.65(m_{c}), 4.35(m_{c}), |
| | | | | | | | | | | | 4.95(q), 8.25(s), 8.65(s) |
| I.2-54 | N | CH | S | 6-Br | 1 | CH₂CH₃ | H | 0 | 0 | 2 | 1.1(t), 2.10(m_{c}), 2.65(m_{c}), 4.35 |
| | | | | | | | | | | | (m_{c}), 4.90(t), 8.25(s), 8.65(s) |
| I.2-55 | N | CH | S | 6-Br | 1 | CH₃ | CH₃ | 0 | 0 | 2 | 1.85(s), 2.65(m_{c}), 4.35(t), 8.25 |
| | | | | | | | | | | | (s), 8.65(s) |
| I.2-56 | CH | CH | O | 5-CH₃ | 1 | CH₃ | H | 0 | 0 | 2 | 1.75(d), 2.45(s), 2.65 (m_{c}), 4.35 |
| | | | | | | | | | | | (t), 4.6(q), 7.05(d), 7.30(d), |
| | | | | | | | | | | | 7.4(s) |
| I.2-57 | CH | CH | O | 5-CH₃ | 1 | CH₂CH₃ | H | 0 | 0 | 2 | 1.15(t), 2.1(m_{c}), 2.45(s), 2.65 |
| | | | | | | | | | | | (m_{c}), 4.35(t), 4.55(t), 7.05(d), |
| | | | | | | | | | | | 7.3(d), 7.4(s) |
| I.2-58 | CH | CH | O | 5-CH₃ | 1 | CH₃ | CH₃ | 0 | 0 | 2 | 1.8(s), 2.45(s), 2.65(m_{c}), 4.35 |
| | | | | | | | | | | | (m_{c}), 7.1(d), 7.3(d), 7.4(s) |
| I.2-59 | CH | CH | S | 5-Cl | 1 | CH(CH₃)₂ | H | 0 | 0 | 2 | 1.15(d), 2.4(m_{c}), 2.65(m_{c}), 4.35 |
| | | | | | | | | | | | (m_{c}), 4.65(d), 7.25(d) 7.65(d), |
| | | | | | | | | | | | 7.85 (d) |
| I.2-60 | N | CH | S | — | O | CH₂CH₃ | H | 0 | 0 | 2 | 1.1(t), 2.1(m_{c}), 2.7(m_{c}), |
| | | | | | | | | | | | 4.95(t), 7.25(m_{c}), 8.1(d), |
| | | | | | | | | | | | 8.65(d) |
| I.2-61 | N | CH | S | — | O | CH₃ | CH₃ | 0 | 0 | 2 | 1.85(s), 2,65(m_{c}), 4.35(m_{c}), |
| | | | | | | | | | | | 7.25(m_{c}), 8.1(d), 8.65(d) |
| I.2-62 | N | CH | S | — | 0 | (CH₂)₃CH₃ | H | 0 | 0 | 2 | 0.95(6), 1.3-2.2(m), 2.65(m_{c}), |
| | | | | | | | | | | | 4.35(m_{c}), 4.95(t), 7.25(m_{c}), |
| | | | | | | | | | | | 8.1(d), 8.65(d) |
| I.2-63 | CH | CH | S | 5-Cl | 1 | CH₃ | H | 0 | 0 | 2 | 1.75(d), 2.65(m_{c}), 4.3(t), 4.7 |
| | | | | | | | | | | | (q), 7.25(d), 7.7(d), 7.85(s) |
| I.2-64 | CH | CH | S | 5-Cl | 1 | CH₂CH₃ | H | 0 | 0 | 2 | see example 3 |
| I.2-65 | CH | CH | S | 5-Cl | 1 | CH₃ | CH₃ | 0 | 0 | 2 | 1.75(s), 2.65(m_{c}), 4.35(t), |
| | | | | | | | | | | | 7.3(d), 7.7(d), 7.85(s) |
| I.2-66 | CH | CH | S | 5-Cl | 1 | (CH₂)₃CH₃ | H | 0 | 0 | 2 | 0.95(t), 1.3-2.1(m), 2.65(m_{c}), |
| | | | | | | | | | | | 4.35(m_{c}), 4.65(t), 7.3(d), |
| | | | | | | | | | | | 7.7(d), 7.85(s) |
| I.2-67 | CH | CH | S | 5-OCH₃ | 1 | H | H | 0 | 0 | 2 | 2.85(m_{c}), 3.55(t), 3.9(s), 6.95 |
| | | | | | | | | | | | (d), 7.4(s), 7.6(d) |
| I.2-68 | CH | CH | S | 5-OCH₃ | 1 | CH₃ | H | 0 | 0 | 2 | 1.7(d), 2.65 (m_{c}), 3.85(s), |
| | | | | | | | | | | | 4.35(m_{c}), 4.7(q), 6.95(d), |
| | | | | | | | | | | | 7.4(s), 7.6(d) |
| I.2-69 | CH | CH | S | 5-OCH₃ | 1 | CH(CH₃)₂ | H | 0 | 0 | 2 | 1.15(m_{c}), 2.4(m_{c}), 2.65(m_{c}), 3.85 |
| | | | | | | | | | | | (s), 4.35 (t), 4.6(d), 6.95(d), |
| | | | | | | | | | | | 7.4(s), 7.6(d) |
| I.2-70 | CH | N | NCH₃ | — | 0 | H | H | 0 | 0 | 2 | 2.85(m_{c}), 3.65(t), 3.75(s), |
| | | | | | | | | | | | 7.2(m_{c}), 7.85(d), 8.25(d) |
| I.2-71 | CH | CH | O | 6-Cl | 1 | H | H | 0 | 1 | 2 | 2.65(m_{c}), 3.0(t), 3.55(m_{c}), 4.35 |
| | | | | | | | | | | | (t), 7.25(d), 7.45(s), 7.5(d) |
| I.2-72 | CH | CH | S | 0 | H | H | 0 | 2 | 2 | | |
| I.2-73 | CH | CH | S | 6-OCH₂CH₃ | 1 | H | H | 0 | 2 | 2 | 1.45(t), 2.15(m_{c}), 2.5(t), 2.65 |
| | | | | | | | | | | | (m_{c}), 3.35(t), 4.05(q), 4.25(t), |
| | | | | | | | | | | | 7.0(d), 7.2(s), 7.75(d) |
| I.2-74 | CH | CH | O | — | 0 | H | H | 0 | 2 | 2 | 2.2(m_{c}), 2.5-2.7(m), 3.35(m_{c}), |
| | | | | | | | | | | | 4.25(m_{c}), 7.25(m_{c}), 7.45(d), 7.6 |
| | | | | | | | | | | | (d) |
| I.2-75 | CH | CH | O | 6-Cl | 1 | H | H | 0 | 2 | 2 | 2.2(m_{c}), 2.55(m_{c}), 2.65(m_{c}), 3.35 |
| | | | | | | | | | | | (m_{c}), 4.3(m_{c}), 7.25(d), 7.45(s), |
| | | | | | | | | | | | 7.5(d) |
| I.2-76 | CH | N | S | — | 0 | CH₃ | H | 2 | 0 | 2 | 1.8(d), 2.55(m_{c}), 4.3(m_{c}), 4.65 |
| | | | | | | | | | | | (q), 7.65(m_{c}), 8.5(d), 8.8(d) |
| I.2-77 | CH | N | S | — | 0 | CH₃ | CH₃ | 2 | 0 | 2 | 1.8(s), 2.65(m_{c}), 4.3(t), |
| | | | | | | | | | | | 7.6(dd), 8.5(d), 8.8(d) |
| I.2-78 | CH | N | S | — | 0 | CH₃ | CH₃ | 1 | 0 | 2 | 1.85(s), 2.65(m_{c}), 4.35(t), 7.55 |
| | | | | | | | | | | | (dd), 8.15(d), 8.4(d) |

TABLE II

| | |
|---|---|
| | (I.3) |
| 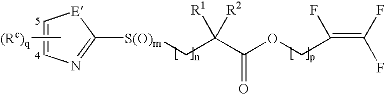 | |

| No. | E′ | (R^{c})_{q} | q | R¹ | R² | m | n | p | Physical data: ¹H-NMR (δ [ppm]) |
|---|---|---|---|---|---|---|---|---|---|
| 1.3-1 | S | 4-(p-F-C₆H₄) | 1 | CH₂CH₃ | CH₂CH₃ | 0 | 0 | 2 | 1.0(m_{c}), 2.0(m_{c}), 2.6(m_{c}), 4.3 |
| | | | | | | | | | (m_{c}), 7.1(m_{c}), 7.4(s), 7.85(m_{c}) |
| 1.3-2 | S | 4-(p-F-C₆H₄) | 1 | H | H | 0 | 0 | 2 | 2.65(m_{c}), 4.1(s), 4.35(m_{c}), |
| | | | | | | | | | 7.1(m_{c}), 7.3(s), 7.85(m_{c}) |
| 1.3-3 | S | 4-(p-F-C₆H₄) | 1 | CH₃ | H | 0 | 0 | 2 | 1.7(d), 2.6(m_{c}), 4.3(m_{c}), 4.45 |
| | | | | | | | | | (q), 7.1(m_{c}), 7.35(s), 7.85(m_{c}) |
| 1.3-4 | S | 4-(p-F-C₆H₄) | 1 | CH₃ | CH₃ | 0 | 0 | 2 | 1.7(s), 2.6(m_{c}), 4.25(t), |
| | | | | | | | | | 7.1(m_{c}), 7.4(s), 7.85(m_{c}) |
| 1.3-5 | S | 4-(p-F-C₆H₄) | 1 | CH(CH₃)₂ | H | 0 | 0 | 2 | 1.15(m_{c}), 2.3(m_{c}), 2.65(m_{c}), |
| | | | | | | | | | 4.2-4.4(m), 7.1(m_{c}), 7.3(s), |
| | | | | | | | | | 7.8 (m_{c}) |
| 1.3-6 | S | 4-(p-F-C₆H₄) | 1 | (CH₂)₃CH₃ | H | 0 | 0 | 2 | 1.95(m_{c}), 1.2-2.1(m), 2.65(m_{c}), |
| | | | | | | | | | 4.25-4.4 (m), 7.1(m_{c}), 7.35(s), |
| | | | | | | | | | 7.85 (m_{c}) |
| 1.3-7 | S | 4-(p-F-C₆H₄) | 1 | CH₂CH₃ | H | 0 | 0 | 2 | 1.15(t), 2.05(m_{c}), 2.6(m_{c}), |
| | | | | | | | | | 4.2-4.45(m), 7.1(t), 7.3(s), |
| | | | | | | | | | 7.85(m_{c}) |
| 1.3-8 | S | 4-(p-Cl-C₆H₄) | 1 | CH₃ | CH₃ | 0 | 0 | 2 | 1.7(s), 2.55(m_{c}), 4.25(t), |
| | | | | | | | | | 7.4(d), 7.5(s), 7.8(d) |
| 1.3-9 | S | 4-(p-C1-C₆H₄) | 1 | CH₃ | H | 0 | 0 | 2 | 1.7(s), 2.6(m_{c}), 4.3(m_{c}), 4.45 |
| | | | | | | | | | (q), 7.35(m_{c}), 7.8(d) |
| 1.3-10 | S | 4-(p-Cl-C₆H₄) | 1 | (CH₂)₃CH₃ | H | 0 | 0 | 2 | see example 4 |
| 1.3-11 | S | 4-(p-Cl-C₆H₄) | 1 | CH₂CH₃ | H | 0 | 0 | 2 | 1.15(t), 2.05(m_{c}), 2.65(m_{c}) |
| | | | | | | | | | 4.25-4.4(m), 7.35(m_{c}), 7.8(d) |
| 1.3-12 | S | 4-(o,p-Cl₂-C₆H₃) | 1 | CH₃ | H | 0 | 0 | 2 | 1.65(m_{c}), 2.6(m_{c}). 4.2-4.5 (m), |
| | | | | | | | | | 7.35(d), 7.5(s), 7.8(c), 7.95(d) |
| 1.3-13 | S | 4-(o,p-Cl₂-C₆H₃) | 1 | CH₃ | CH₃ | 0 | 0 | 2 | 1.7(s), 2.6(m_{c}), 4.3(m_{c}), 7.35 |
| | | | | | | | | | (d), 7.5(s), 7.9(m_{c}) |
| 1.3-14 | S | 4-(o,p-Cl₂-C₆H₃) | 1 | (CH₂)₃CH₃ | H | 0 | 0 | 2 | 0.9(t), 1.3-2.1(m), 2.6(m_{c}) |
| | | | | | | | | | 4.2-4.4(m), 7.3(d), 7.5(s), |
| | | | | | | | | | 7.8(s), 7.95(d) |
| 1.3-15 | S | 4-(o,p-Cl₂-C₆H₃) | 1 | CH(CH₃)₂ | H | 0 | 0 | 2 | 1.1(dd), 2.3(m_{c}), 2.65(m_{c}), |
| | | | | | | | | | 4.2-4.4(m), 7.3(d), 7.5(s), |
| | | | | | | | | | 7.8(s), 7.95(d) |
| 1.3-16 | S | 4-(p-Cl-C₆H₄) | 1 | CH(CH₃)₂ | H | 0 | 0 | 2 | 1.15(dd), 2.35(m_{c}), 2.65(m_{c}), |
| | | | | | | | | | 4.2-4.4(m), 7.35(m_{c}) 7.8(d) |
| 1.3-17 | S | 4-(C₆H₅) | 1 | CH₃ | CH₃ | 0 | 0 | 2 | 1.7(s), 2.6(m_{c}), 4.3(t), |
| | | | | | | | | | 7.3-7.5(m), 7.85(d) |
| 1.3-18 | S | 4-(C₆H₅) | 1 | (CH₂)₃CH₃ | H | 0 | 0 | 2 | 0.9(t), 1.3-2.1(m), 2.6(m_{c}), |
| | | | | | | | | | 4.2-4.45(m), 7.25-7.45(m), |
| | | | | | | | | | 7.85(d) |
| 1.3-19 | S | 5-(C₆H₅) | 1 | CH(CH₃)₂ | H | 0 | 0 | 2 | 1.15(dd), 2.35(m_{c}), 2.65(m_{c}), |
| | | | | | | | | | 4.2-4.4(m), 7.25-7.45(m), |
| | | | | | | | | | 7.85(d) |
| 1.3-20 | O | 4-(C₆H₅),5-(C₆H₅) | 2 | H | H | 0 | 0 | 2 | 2.65(m_{c}), 4.05(s), 4.35(t), |
| | | | | | | | | | 7.25-7.60(m) |
| 1.3-21 | O | 4-(C₆H₅),5-(C₆H₅) | 2 | CH₂CH₃ | H | 0 | 0 | 2 | 1.15(t), 2.1(m_{c}), 2.65(m_{c}), |
| | | | | | | | | | 4.3(m_{c}), 7.25-7.6(m) |
| 1.3-22 | O | 4-(C₆H₅),5-(C₆H₅) | 2 | CH₃ | H | 0 | 0 | 2 | 1.75(d), 2.65(m_{c}), 4.25-4.5 (m), |
| | | | | | | | | | 7.25-7.55(m) |
| 1.3-23 | O | 4-(C₆H₅),5-(C₆H₅) | 2 | CH₃ | CH₃ | 0 | 0 | 2 | 1.75(s), 2.65(m_{c}), 4.3(t), |
| | | | | | | | | | 7.25-7.6(m) |
| 1.3-24 | O | 4-(C₆H₅),5-(C₆H₅) | 2 | CH(CH₃)₂ | H | 0 | 0 | 2 | 1.15(dd), 2.35(m_{c}), 2.65(m_{c}), |
| | | | | | | | | | 4.25-4.45(m), 7.25-7.6(m) |
| 1.3-25 | O | 4-(C₆H₅),5-(C₆H₅) | 2 | (CH₂)₃CH₃ | H | 0 | 0 | 2 | 0.9(t), 1.3-2.1(m), 2.65(m_{c}), |
| | | | | | | | | | 4.25-4.45(m,), 7.25-7.6(m) |
| 1.3-26 | S | 4-(C₆H₅) | 1 | H | H | 0 | 0 | 2 | |
| 1.3-27 | S | 4-(C₆H₅) | 1 | CH₃ | H | 0 | 0 | 2 | |
| 1.3-28 | S | 4-(C₆H₅) | 1 | CH₂CH₃ | H | 0 | 0 | 2 | |
| 1.3-29 | S | 4-(C₆H₅) | 1 | H | H | 0 | 1 | 2 | 2.65(m_{c}), 2.95(t), 3.55(t), |
| | | | | | | | | | 4.35(t), 7.3-7.55(m), 7.85(d) |
| 1.3-30 | S | 4-(C₆H₅) | 1 | H | H | 0 | 2 | 2 | 2.15(m_{c}), 2.5-2.7(m), 3.35(t), |
| | | | | | | | | | 4.25(t), 7.25-7.45(m), 7.85(d) |
| 1.3-31 | S | 4-(p-F-C₆H₄) | 1 | H | H | 2 | 0 | 2 | 2.65(m_{c}), 4.3(t), 4.55(s), |
| | | | | | | | | | 7.15(t), 7.8(s), 7.95(m_{c}) |
| 1.3-32 | S | 4-(p-F-C₆H₄) | 1 | CH₃ | H | 2 | 0 | 2 | 1.8(d), 2.65(m_{c}). 4.3(m_{c}), 4.55 |
| | | | | | | | | | (q), 7.15(m_{c}). 7.8(s), 7.95(m_{c}) |
| 1.3-33 | S | 4-(p-F-C₆H₄) | 1 | CH₂CH₃ | H | 1 | 0 | 2 | 1.1(m_{c}). 2.15(m_{c}), 2.6(m_{c}), |
| | | | | | | | | | 3.85-4.4(m), 7.1(m_{c}), 7.75(d), |
| | | | | | | | | | 7.85 (m_{c}) |
| 1.3-34 | S | 4-(p-F-C₆H₄) | 1 | CH₃ | CH₃ | 1 | 0 | 2 | 1.2(s), 1.7(s), 2.55(m_{c}) |
| | | | | | | | | | 4.35(m_{c}), 7.1(m_{c}), 7.7(s), |
| 1.3-35 | S | 4-(p-F-C₆H₄) | 1 | (CH₂)₃CH₃ | H | 1 | 0 | 2 | 0.9(m_{c}), 1.15-2.2(m), 2.6(m_{c}) |
| | | | | | | | | | 3.9-4.4(m), 7.15(m_{c}), 7.7(d), |
| | | | | | | | | | 7.85(m_{c}) |

TABLE III

| | |
|---|---|
| | (I.4) |
| 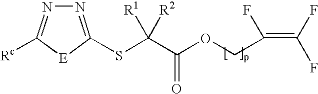 | |

| No. | E | R^{c} | R¹ | R² | p | Physical data: ¹NMR (δ [ppm]) |
|---|---|---|---|---|---|---|
| 1.4-1 | O | p-F-C₆H₄ | H | H | 2 | 2.7(m_{c}), 4.15(s), 4.4(t), 7.2(m_{c}), 8.0(m_{c}) |
| 1.4-2 | O | p-CH₃-C₆H₄ | H | H | 2 | 2.4(s), 2.65(m_{c}), 4.15(s), 4.35(t), 7.3(m_{c}), |
| | | | | | | 7.9(m_{c}) |
| 1.4-3 | O | p-F-C₆H₄ | CH₃ | H | 2 | 1.75(d), 2.65(m_{c}), 4.25-4.55(m), 7.2(m_{c}), 8.0(m_{c}) |
| 1.4-4 | O | p-F-C₆H₄ | CH(CH₃)₂ | H | 2 | 1.15(m_{c}), 2,4(m_{c}), 2.65(m_{c}). 4.3-4.45(m), |
| | | | | | | 7.2(m_{c}), 8.0(m_{c}) |
| 1.4-5 | S | CH₃ | H | H | 2 | 2.65(m_{c}), 2.75(s), 4.15(s), 4.35(t) |
| 1.4-6 | S | CH₃ | CH₃ | H | 2 | 1.7(d), 2.65(m_{c}). 2.75(s), 4.35(m_{c}), 4.55(q) |
| 1.4-7 | S | CH₃ | CH(CH₃)₂ | H | 2 | 1.15(dd), 2.35(m_{c}), 2.65(m_{c}), 2.75(s), 4.3(m_{c}), |
| | | | | | | 4.45(d) |
| 1.4-8 | O | p-F-C₆H₄ | CH₂CH₃ | H | 2 | 1.15(t), 2.15(m_{c}), 2.65(m_{c}), 4.3-4.5(m), 7.25 |
| | | | | | | (m_{c}), 8.0(m_{c}) |
| 1.4-9 | S | CH₃ | CH₂CH₃ | H | 2 | 1.1(t), 2.05(m_{c}). 2.65(m_{c}), 2.75(s), 4.25-4.5(m) |
| 1.4-10 | S | CH₃ | CH₃ | H | 2 | 1.75(d), 2.65(m_{c}). 4.35(m_{c}), 4.75(q), 9.05(s) |
| 1.4-11 | S | CH₃ | H | H | 2 | 2.65(m_{c}), 4.2(s), 4.35(m_{c}), 9.05(s) |

Examples of Action Against Animal Pests

The action of the compounds of the formula I against pests was demonstrated by the following experiments:

The active compounds were formulated
a. for testing the activity against nematodes as an about 0.05% w/v strength solution in a carrier of 5% by volume of acetone and 0.05% by volume Tween 20 (Polyoxyethylene-(20)-sorbitan monolaurate) in water, which was then diluted with 5% acetone in water and 0.05% Tween 20 in water to achieve the desired concentrations for drenching.
b. for testing the activity against insects and arachnids as a 10.000 ppm solution in a mixture of 35% acetone and water, which was diluted with water, if needed.

After the experiments were completed, in each case the lowest concentration was determined at which the compound still caused an 80 to 100% inhibition or mortality in comparison with untreated controls (limit or minimal concentration).

Activity Against Nematode Plant Diseases

Soybean cyst nematode (SCN), Heterodera glycines Tomato root knot nematode (RKN), Meloidogyne incognita

Silty loam soil in individual pots with 1-week-old tomato transplants (cultivar Bonny Best) and soybean transplants (cultivar Hutcheson) were drenched with the test solution of the active ingredient. Aqueous suspensions of J2 nematode larvae and Meloidogyne incognita in the case of tomatoes and Heterodera glycines in the case of soybeans were drenched on the soil surface. Plants were kept one day in a moist infection chamber at 26° C. then moved into the greenhouse and maintained with bottom watering until harvested for evaluation. The tests were replicated 3 times for each disease.

In the case of root knot nematode on tomatoes, plants were harvested two weeks after treatment and inoculation. Roots were washed free of soil and the number of root knot galls on each root system was visually examined and compared for treated and plants that were only treated with the acetone/Tween 20 carrier.

In the case of soybean cyst nematode on soybeans, plants were harvested four weeks after treatment and inoculation. Roots were washed free of soil and the number of cysts per root-mass was visually examined and compared for treated and plants that were only treated with the acetone/Tween 20 carrier.

In this test, tomato plants which had been treated with 0.6 kg/ha of the compounds I.2-11, I.2-29, I.2-31, I.2.-32, I.2-33, I.2-37, I.3.-2, I.3.-4, I.3-7 and I.3-11 showed a reduction in root knot galling of 100% compared to plants treated with the acetone/Tween 20 carrier.

Activity Against Insects and Arachnids

Spodoptera eridania, 2nd Instar Larvae, Southern Armyworm (SAW)

Leaves of two lima bean plants contained in pots at BBCH stage 11 were dipped in the test solution, allowed to dry and then placed in plastic bags with holes punched for ventilation. Ten 2nd instar larvae were introduced. After 4 days, mortality, reduced feeding, or any interference with normal growth was examined visually.

Diabrotica virgifera virgifera Leconte, 2nd Instar Western Corn Rootworm (WCR)

1 ml of the test solution was pipetted onto 1 ccm³ of talc in a 30 ml screw-top glass jar so as to provide 1.25 mg of active ingredient per jar (corresponding to about 50 kg/ha). The dried talc was loosened, and 1 ccm³ of millet seed as food for the insects and 25 ml of moist soil were added to each jar and the contents were mixed mechanically. 10 2nd instar rootworms were added to each jar and the jars are loosely capped to allow air exchange for the larvae. The treatments were held for 5 days when mortality counts were made. Missing larvae were presumed dead, since they decompose rapidly and cannot be found.

Tetranychus urticae (OP-Resistant Strain), 2-Spotted Spider Mite (TSM)

Sieva lima bean plants with primary leaves expanded to 7-8 cm were infested by placing on each a small piece from an infested leaf (with about 100 mites) taken from the main colony. This was done at about 2 hours before treatment to allow the mites to move over to the test plant to lay eggs. The piece of leaf used to transfer the mites was removed. The newly-infested plants were dipped in the test solution and allowed to dry. After 2 days, one leaf is removed and mortality counts are made.

Aphis gossypii, Cotton Aphid (CA)

Cotton plants at the cotyledon stage (one plant per pot) were infested by placing a heavily infested leaf from the main colony on top of each cotyledon. The aphids were allowed to transfer to the host plant overnight, and the leaf used to transfer the aphids was removed. The cotyledons were dipped in the test solution and allowed to dry. After 5 days, mortality counts were made.

Spodoptera eridania, Eggs-Southern Armyworm and Diabrotica undecimpunctata howardi, Eggs-Southern Corn Rootworm (SAW-Eggs) and (SCR-Eggs)

Wells containing artificial diet were treated with the test solutions and dried. The appropriate insect eggs were then placed in the wells which were covered with vented covers. After 7 days, mortality counts were made.

In this test, Tetranychus urticae which had been treated with 100 ppm of compound I.2-6 showed a kill rate of over 75% whereas untreated pests showed a rate of 0%.

1. Fluoroalkene derivatives of formula I 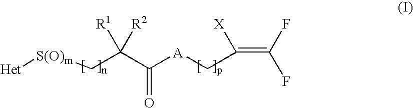
wherein the substituents and the indices have the following meanings:
A is oxygen or NR^{a};
R^{a} is hydrogen; C₁-C₆-alkyl, C₂-C₆-alkenyl, C₂-C₆-alkynyl, wherein the carbon atoms may be partially or fully halogenated;
X is hydrogen, halogen; C₁-C₆-alkyl or phenyl wherein the alkyl and phenyl groups may be partially or fully halogenated;
R¹, and R² are each independently hydrogen, halogen, hydroxyl, cyano, nitro, mercapto, amino; C₁-C₆-alkyl, C₂-C₆-alkenyl, C₂-C₆-alkynyl, C₁-C₆-alkoxy, C₂-C₆-alkenyloxy, C₁-C₆-alkylthio, C₁-C₆-alkylamino, di-C₁-C₆-alkylamino, C₁-C₆-alkoxycarbonyl, C₁-C₆-alkylcarbonyloxy, wherein the aliphatic moieties in these substituents are unsubstituted, partially or fully halogenated or substituted by 1 to 3 substituents, each independently selected from R^{b}:
R^{b} is cyano, nitro, halogen, hydroxy, mercapto, amino, carboxyl, aminocarbonyl, aminothiocarbonyl, alkyl, haloalkyl, alkenyl, alkenyloxy, alkynyl, alkoxy, haloalkoxy, alkylthio, alkylamino, dialkylamino, formyl, alkylcarbonyl, alkylsulfonyl, alkoxysulfonyl, alkylsulfonyloxy, alkoxycarbonyl, alkylcarbonyloxy, alkylaminocarbonyl, dialkylaminocarbonyl, alkylaminothiocarbonyl, dialkylaminothiocarbonyl, alkylenedioxy or cycloalkyl, wherein the alkyl groups in these radicals contain 1 to 6 carbon atoms and the abovementioned alkenyl or alkynyl groups in these radicals contain 2 to 6 carbon atoms, and wherein the carbon atoms in these groups may be partially or fully halogenated;
Het is a monocyclic or bicyclic 3- to 10-membered heteroaromatic ring system containing 1 to 5 heteroatoms selected from oxygen, sulfur and nitrogen, unsubstituted, partially or fully halogenated or substituted by 1 to 4 substituents, each independently selected from R^{c}:
R^{c} is R^{b}, C₁-C₆-alkoxy-C₁-C₆-alkyl, C₁-C₆-alkylsulfinyl, C₁-C₆-alkylaminosulfonyl, di-C₁-C₆-alkylaminosulfonyl, C₁-C₆-alkylcarbonylamino, wherein the last mentioned 5 carbon chains and those defined under R^{b} are unsubstituted, partially or fully halogenated or substituted by from 1 to 3 cyano, hydroxy, mercapto, amino, C₁-C₆-alkylthio, C₁-C₆-alkylamino, di-C₁-C₆-alkylamino, C₁-C₆-alkoxycarbonyl, C₁-C₆-alkylcarbonyloxy or nitro groups;
cycloalkyl, cycloalkoxy, saturated or partially unsaturated heterocyclyl, heterocyclyloxy, wherein the cyclic systems contain 3 to 10 ring members, and the carbon atoms in the heterocycles may be substituted by 1 to 4 heteroatoms selected from nitrogen, sulfur and oxygen,
aryl, aryloxy, arylthio, aryl-C₁-C₆-alkoxy, aryl-C₁-₆-alkyl, wherein the mono- or bicyclic ring systems contain 5 to 10 ring members,
hetaryl, hetaryloxy, hetarylthio, wherein the mono- or bicyclic ring systems contain 5 to 10 ring members wherein 1 to 3 carbon atoms may be substituted by heteroatoms selected from nitrogen, sulfur and oxygen,
and wherein the cyclic, aromatic and heteroaromatic systems may be partially or fully halogenated or may be substituted by from 1 to 3 groups selected from halogen, cyano, nitro, hydroxy; C₁-C₆-alkyl, C₁-C₆-alkoxy, C₁-C₆-alkylthio, C₁-C₆-alkylamino, C₁-C₆-alkylcarbonyl, C₁-C₆-alkoxycarbonyl, di-C₁-C₆-alkylamino, C₂-C₆-alkenyl, C₂-C₆-alkenyloxy and C₂-C₆-alkynyl, wherein the carbon atoms of these substituents may be partially or fully halogenated;
m is 0, 1, or 2;
n is 0, 1, 2, or 3; and
p is 0, 1, 2, 3, 4, 5, or 6.

2. Fluoroalkene derivatives of formula I according to claim 1 wherein the substituents and the indices have the following meanings:
A is oxygen or NH;
R¹, and R² are each independently hydrogen, halogen; C₁-C₆-alkyl or phenyl wherein the alkyl and phenyl groups are unsubstituted, partially or fully halogenated.

3. Fluoroalkene derivatives of formula I according to claim 1, wherein A is oxygen.

4. Fluoroalkene derivatives of formula I according to claim 1, wherein X is hydrogen or fluorine.

5. Fluoroalkene derivatives of formula I according to claim 1, wherein X is fluorine.

6. Fluoroalkene derivatives of formula I according to claim 1, wherein R¹ and R² are each independently hydrogen, halogen, C₁-C₆-alkyl, or phenyl, which is unsubstituted, partially or fully halogenated.

7. Fluoroalkene derivatives of formula I according to claim 1, wherein Het is
5-membered hetaryl containing besides carbon atoms 1 to 3 nitrogen atoms and/or 1 sulfur or oxygen atom, unsubstituted or substituted by 1 or 2 R^{c} groups, wherein
R^{c} is cyano, nitro, halogen, hydroxy, mercapto, amino, carboxyl, aminocarbonyl, alkyl, haloalkyl, alkoxyalky, alkenyl, alkenyloxy, alkynyl, alkoxy, haloalkoxy, alkylthio, alkylamino, dialkylamino, formyl, alkylcarbonyl, alkylsulfonyl, alkoxycarbonyl, alkylcarbonyloxy, alkylaminocarbonyl, or dialkylaminocarbonyl, wherein the alkyl groups in these radicals contain 1 to 6 carbon atoms and the abovementioned alkenyl or alkynyl groups in these radicals contain 2 to 6 carbon atoms, and wherein the carbon atoms in these groups may be partially or fully halogenated, or 5- to 10-membered mono- or bicyclic aryl, or 5- to 10-membered mono- or bicyclic hetaryl, wherein 1 to 3 carbon atoms may be substituted by heteroatoms selected from nitrogen, sulfur and oxygen, wherein the aryl or hetaryl ring systems may be partially or fully halogenated or may be substituted by 1 to 3 groups selected from halogen, cyano, nitro, hydroxy, C₁-C₆-alkyl, C₁-C₆-haloalkyl, C₁-C₆-alkoxy, or C₁-C₆-haloalkoxy; or
5-membered hetaryl containing besides carbon atoms 1 to 3 nitrogen atoms and/or 1 sulfur or oxygen atom wherein 2 adjacent ring members are bridged by a buta-1,3-dien-1,4-diyl group, wherein 1 or 2 carbon atoms may be substituted by nitrogen atoms, unsubstituted or substituted by 1 or 2 R^{c} groups, wherein
R^{c} is cyano, nitro, hydroxy, amino, alkyl, haloalkyl, alkoxyalkyl, alkenyl, alkenyloxy, alkoxy, haloalkoxy, alkylthio, alkylamino, dialkylamino, or alkylcarbonylamino, wherein the alkyl groups in these radicals contain 1 to 6 carbon atoms and the alkenyl groups in these radicals contain 2 to 6 carbon atoms and wherein the carbon atoms in these groups may be partially or fully halogenated.

8. Fluoroalkene derivatives of formula I according to claim 1, wherein m is an integer of 0 or 2, n is an integer of 0 and p is an integer of 2 or 4.

9. A process for the preparation of fluoroalkene derivatives of formula I.1, 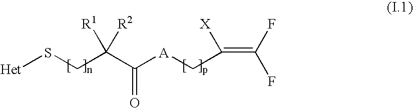
wherein A, X, R¹, R², Het, n and p are as defined below, wherein
A is oxygen or NR^{a};
R^{a} is hydrogen; C₁-C₆-alkyl, C₂-C₆-alkenyl, C₂-C₆-alkynyl, wherein the carbon atoms may be partially or fully halogenated;
X is hydrogen, halogen; C₁-₆-alkyl or phenyl wherein the alkyl and phenyl groups may be partially or fully halogenated;
R¹ and R² are each independently hydrogen, halogen, hydroxyl, cyano, nitro, mercapto, amino;
C₁-C₆-alkyl, C₂-C₆-alkenyl, C₂-C₆-alkynyl, C₁-C₆-C-alkoxy, C₂-C₆-alkenyloxy, C₁-C₆-alkylthio, C₁-C₆-alkylamino, di-C₁-₆-alkylamino, C₁-C₆-alkoxycarbonyl, C₁-C₆-alkylcarbonyloxy, wherein the aliphatic moieties in these substituents are unsubstituted, partially or fully halogenated or substituted by 1 to 3 substituents, each independently selected from R^{b};
R^{b} is cyano, nitro, halogen, hydroxy, mercapto, amino, carboxyl, aminocarbonyl, aminothiocarbonyl, alkyl, haloalkyl, alkenyl, alkenyloxy, alkynyl, alkoxy, haloalkoxy, alkylthio, alkylamino, dialkylamino, formyl, alkylcarbonyl, alkylsulfonyl, alkoxysulfonyl, alkylsulfonyloxy, alkoxycarbonyl, alkylcarbonyloxy, alkylaminocarbonyl, dialkylaminocarbonyl, alkylaminothiocarbonyl, dialkylaminothiocarbonyl, alkylenedioxy or cycloalkyl, wherein the alkyl groups in these radicals contain 1 to 6 carbon atoms and the abovementioned alkenyl or alkynyl groups in these radicals contain 2 to 6 carbon, atoms, and wherein the carbon atoms in these groups may be partially or fully halogenated:
Het is a monocyclic or bicyclic 3- to 10-membered heteroaromatic ring system containing 1 to 5 heteroatoms selected from oxygen, sulfur and nitrogen, unsubstituted, partially or fully halogenated or substituted by 1 to 4 substituents, each independently selected from R^{c};
R^{c} is R^{b}, C₁-C₆-alkoxy-C₁-C₆-alkyl, C₁-C₆-alkylsulfinyl, C₁-C₆-alkylaminosulfonyl, di-C₁-C₆-alkylaminosulfonyl, C₁-C₆-alkylcarbonylamino, wherein the last mentioned 5 carbon chains and those defined under R^{b} are unsubstituted, partially or fully halogenated or substituted by from 1 to 3 cyano, hydroxy, mercapto, amino, C₁-C₆-alkylthio, C₁-C₆-alkylamino, di-C₁C₆-alkylamino, C₁-C₆-alkoxycarbonyl, C₁-₆-alkylcarbonyloxy or nitro groups;
cycloalkyl, cycloalkoxy, saturated or partially unsaturated heterocyclyl, heterocyclyloxy, wherein the cyclic systems contain 3 to 10 ring members, and the carbon atoms in the heterocycles may be substituted by 1 to 4 heteroatoms selected from nitrogen, sulfur and oxygen,
aryl, aryloxy, arylthio, aryl-C₁-C₆-alkoxy, aryl-C₁-C₆-alkyl, wherein the mono- or bicyclic ring systems contain 5 to 10 ring members,
hetaryl hetaryloxy, hetarylthio, wherein the mono- or bicyclic ring systems contain 5 to 10 ring members wherein 1 to 3 carbon atoms may be substituted by heteroatoms selected from nitrogen, sulfur and oxygen,
and wherein the cyclic, aromatic and heteroaromatic systems may be partially or fully halogenated or may be substituted by from 1 to 3 groups selected from halogen, cyano, nitro, hydroxy C₁-₆-alkyl, C₁-C₆-alkoxy, C₁-C₆-alkylthio, C₁-C₆-alkylamino, C₁-C₆-alkylcarbonyl, C₁-₆-alkoxycarbonyl, di-C₁-C₆-alkylamino, C₂-C₆-alkenyl, C₂-C₆-alkenyloxy and C₁-C₆-alkynyl wherein the carbon atoms of these substituents may be partially or fully halogenated;
n is 0, 1, 2, or 3; and
p is 0, 1, 2, 3, 4, 5, or 6
characterized in that wherein compounds of formula II
Het-SH (II)
wherein Het is as defined above, are reacted with compounds of formula III 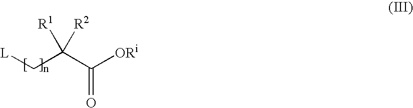
wherein R¹, R² and n are as defined above, L is a nucleophilic exchangeable leaving group, and R¹ is hydrogen, C₁-C₆-alkyl or benzyl, in the presence of a base to give compounds of formula IV, 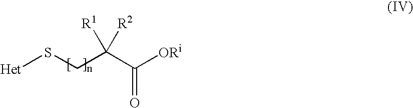
wherein, if R¹ is C₁-C₆-alkyl or benzyl, compounds IV are hydrolyzed to compounds IV wherein Rⁱ is hydrogen, and compounds of formula IV wherein Rⁱ is hydrogen are reacted with compounds of formula V, 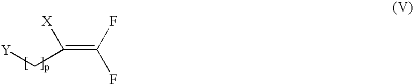
wherein X and p are as defined above and Y is a nucleophilically exchangeable leaving group or a group NHR^{a}, wherein R^{a} is as defined above, in the presence of an acid, a base, or an activating agent.

10. A method for the control of nematodes, insects or arachnids which comprises contacting said pests or their food supply, habitat or breeding ground with a pesticidally effective amount of a compound of formula I as defined in claim 1.

11. A method for the protection of plants from infestation or attack by nematodes, insects or arachnids which comprises applying to the plants or to the soil or the water in which they are growing a pesticidally effective amount of a compound of formula I as defined in claim 1.

12. A method for the control of harmful fungi which comprises treating the fungi or the materials, plants, the soil or the seed to be protected against fungal attack with an effective amount of a compound of the formula I as defined in claim 1.

13. A method for the control of unwanted plants which comprises treating these plants or their habitat with an effective amount of a compound of the formula I as defined in claim 1.

14. A method for treating, controlling, preventing or protecting warm-blooded animals or fish against infestation or infection by helminths, arachnids or arthrop endo- or ectoparasites which comprises orally, topically or parenterally administering or applying to said animal or fish a parasiticidally effective amount of a compound of formula I as defined in claim 1.

15. A method for the preparation of a composition for treating, controlling, preventing or protecting warm-blooded animals or fish against infestation or infection by helminths, arachnids or arthrop endo- or ectoparasites which comprises synthesizing a compound of formula I as defined in claim 1.

16. A composition for the control of nematodes, insects, arachnids, harmful fungi, unwanted plants, helminths, or arthrop endo- or ectoparasites which comprises an agronomically acceptable and/or physiologically tolerable carrier and a compound of formula I as defined in claim 1.
